(19) United States
(12) Patent Application Publication
(10) Pub. No.: US 2024/0368839 A1
(43) Pub. Date: Nov. 7, 2024

(54) FOLDED MULTI-LAYER EXPANDABLE SLIT-SHEET-PAPER SYSTEMS, PRODUCTS AND METHODS

(71) Applicant: David Paul Goodrich, Sedona, AZ (US)

(72) Inventor: David Paul Goodrich, Sedona, AZ (US)

(21) Appl. No.: 18/442,269

(22) Filed: Feb. 15, 2024

Related U.S. Application Data
(60) Provisional application No. 63/446,012, filed on Feb. 15, 2023.
(60) Provisional application No. 63/627,626, filed on Jan. 31, 2024.

(51) Int. Cl. D21H 27/00; B31D 1/00

(52) U.S. Cl. CPC D21H 5/24; B31D 1/0031

(57) ABSTRACT

According to some illustrative embodiments, novel and advantageous systems, products and methods are provided employing novel folded multi-layer expandable slit-sheet paper. For example, in some illustrative embodiments, systems and methods can include, e.g., providing a sheet of paper, folding the sheet of paper at a fold line such as to form two adjacent layers, and cutting slits into said elongated sheet of paper with a cutting die having blades that penetrate each of said two adjacent layers such that said elongated sheet of paper forms an expandable slit sheet.

### BACKGROUND

### Priority Claims

The present application is a non-provisional of both of the following two applications, the entire disclosures of which are both incorporated herein by reference as if recited herein in full:
1. U.S. Provisional Application Ser. No. 63/446,012, filed Feb. 15, 2023, entitled “Folded Multi-Layer Expandable Slit-Sheet-Paper Systems, Products and Methods;” and
2. U.S. Provisional Application Ser. No. 63/627,626, filed Jan. 31, 2024, entitled “Folded Multi-Layer Expandable Slit-Sheet-Paper Systems, Products and Methods;”

### INCORPORATION-BY-REFERENCES TO PRIOR-FILED APPLICATIONS OF THE PRESENT INVENTOR

The present application incorporates by reference the subject matter of each of the following prior U.S. applications and patents of the present inventor, the entire disclosures of which are all incorporated herein by reference as if recited herein in full:
1. U.S. Pat. No. 10,669,086 (based on U.S. application Ser. No. 16/018,702, filed Jun. 26, 2020), entitled “Extensible Paper and Its Use in the Production of Expanded Slit Packaging Wrap and Void Fill Products”;
2. U.S. patent application Ser. No. 16/929,836 (U.S. Publication No. 2021-0031996), entitled “Expanded Slit Sheet Cushioning Products with Novel Slit Pattern and Paper Properties”);
3. U.S. Pat. No. 10,981,712 (based on U.S. application Ser. No. 16/531,017, filed Aug. 3, 2019), entitled “Protective Products Such as Envelopes . . . ”;
4. U.S. patent application Ser. No. 17/175,148 (U.S. Publication No. 2021-0245908), entitled “Expanded Slit Sheet Void Fill Dispensing Systems and Methods”;
5. U.S. patent application Ser. No. 17/802,012 filed Aug. 24, 2022, entitled “Systems and Methods for Wrapping Pallets and the Like with Expandable Paper”;
6. U.S. patent application Ser. No. 17/071,422 (U.S. Publication No. 2021-0114791), entitled “Slit Sheet Material Dispensing Pad”.
7. U.S. Pat. No. 11,479,009, entitled “Slit Sheet Tensioning Device”;
8. U.S. patent application Ser. No. 15/428,144 (U.S. Publication No. 2018-0222665), entitled “Slit Paper Method of Expansion, Shipment, and Expansion Devices”.
9. U.S. Pat. No. 11,220,395, entitled “Slit Paper Expansion Method and Apparatus”;
10. U.S. Pat. No. 10,766,690, entitled “Shipping and Dispensing Box for Slit Sheet Material”.

Various preferred embodiments of the present invention can be implemented in the contexts of the environments of any-and-all of the above-note patents and applications of the present inventor. By way of example, as discussed herein-below, some embodiments of the present invention can be used for expandable slit sheet paper having a substantially increased width (such as, e.g., greater than 25 inches, or, greater than 30 inches, or, greater than 35 inches, or, greater than 40 inches, or other sizes as described herein-below), which expandable slit sheet paper can be implemented in any of the context of the environments of the above-noted patents, such as, for example a) as an expandable slit sheet paper wrap employed within various dispenser mechanisms described in such patents, b) as a pallet wrap, b) as a void-fill product, c) as a wrap pad product and/or within any other contexts described in such patents and applications.

### FIELD

The preferred embodiments of the present invention greatly improve upon and overcome various problems and limitations of the related art.

### SUMMARY

The preferred embodiments overcome and improve upon the foregoing and/or other related art.

1. According to a first illustrative embodiment of the invention, an expandable slit sheet paper product is provided that comprises:
an elongated sheet of expandable slit sheet paper;
said elongated sheet of expandable slit sheet paper having an array of slits, wherein said slits extend in a widthwise direction across said elongated sheet of expandable slit sheet paper;
said elongated sheet of expandable slit sheet paper having a width in said widthwise direction of greater than 20 inches, or, preferably, greater than 25 inches, or, preferably, greater than 30 inches, or, preferably, greater than 35 inches, or, preferably, greater than 40 inches, or, preferably, greater than 45 inches, or, preferably, greater than 50 inches.

2. In some embodiments, the expandable slit sheet paper product of paragraph 1 above further includes wherein said elongated sheet of expandable slit sheet paper has a width in said widthwise direction of between 25 inches to 60 inches, or, preferably, between 30 to 50 inches, or, preferably, between 35 and 45 inches.

3. In some embodiments, the expandable slit sheet paper product of any of paragraphs 1-2 above further include wherein said elongated sheet of expandable slit sheet paper is wound into a roll.

4. In some embodiments, the expandable slit sheet paper product of any of the preceding paragraphs 1-3 above further include wherein said elongated sheet of expandable slit sheet paper is a mounted within a dispenser.

5. In some embodiments, the expandable slit sheet paper product of the preceding paragraph 4 further includes wherein said dispenser is a manual dispenser.

6. In some embodiments, the expandable slit sheet paper product of any of the preceding paragraphs 1-5 further include wherein said expandable slit sheet paper is a pallet wrap.

7. In some embodiments, the expandable slit sheet paper product of any of the preceding paragraphs 1-6 further include wherein said pallet wrap is wrapped around a pallet.

8. In some embodiments, the expandable slit sheet paper product of any of the preceding paragraphs 1-3 further include wherein said elongated sheet of expandable slit sheet paper is included within a stack of elongated sheets of expandable slit sheet paper.

9. In some embodiments, the expandable slit sheet paper product of the preceding paragraph 8 further includes wherein said stack of elongated sheets of expandable slit sheet paper are formed as a pad.

10. In some embodiments, the expandable slit sheet paper product of any of the preceding paragraphs 1-9 further include wherein said elongated sheet of expandable slit sheet paper is an unfolded sheet unfolded along at least one foldline extending in a lengthwise direction.

11. According to another illustrative embodiment of the invention, an expandable slit sheet paper product is provided that comprises:
an elongated sheet of expandable slit sheet paper having multiple layers connected together at at least one foldline.

12. In some embodiments, the expandable slit sheet paper product according to the preceding paragraph 11 further includes wherein said multiple layers are substantially parallel to one another.

13. In some embodiments, the expandable slit sheet paper product according to any of the preceding paragraphs 11-12 further include wherein said elongated sheet of expandable slit sheet paper has two layers connected together at a first fold line.

14. In some embodiments, the expandable slit sheet paper product of the preceding paragraph 13 further includes wherein said first fold line separates said elongated sheet of expandable slit sheet paper into substantially symmetrical portions.

15. According to some other embodiments, a method is performed that includes:
a) providing an elongated sheet of paper;
b) folding the elongated sheet of paper along at least one fold line such as to form at least two adjacent layers;
c) cutting slits into said elongated sheet of paper with a cutting die having blades that penetrate said at least two adjacent layers such that said elongated sheet of paper forms an expandable slit sheet.

16. According to some other embodiments, a method is performed that includes:
a) providing a sheet of paper;
b) folding the sheet of paper at a fold line such as to form two adjacent layers;
c) cutting slits into said elongated sheet of paper with a cutting die having blades that penetrate each of said two adjacent layers such that said elongated sheet of paper forms an expandable slit sheet.

17. In some embodiments, the method of paragraphs 15 or 16 further include wherein said method is a method of making an expandable slit sheet paper.

18. In some embodiments, the method of any of the preceding paragraphs 15-17 further include performing said cutting slits into said elongated sheet of paper while said sheet of paper is in a folded state with said two adjacent layers in side-by-side contact.

19. In some embodiments, the method of any of the preceding paragraphs 15-18 further include wherein said step of cutting slits forms said elongated sheet of paper into an expandable slit sheet paper.

20. In some embodiments, the method of any of the preceding paragraphs 15-19 further include expanding said elongated sheet of paper by pulling said elongated sheet of paper in a lengthwise direction while said two adjacent layers are in side-by-side contact such as to concurrently form two expanded adjacent layers.

21. In some embodiments, the method of any of the preceding paragraphs 15-19 further include prior to expanding said elongated sheet of paper, unfolding said elongated sheet of paper along said fold line such as to increase the width of said elongated sheet of paper.

22. In some embodiments, the method of any of the preceding paragraphs 15-19 further include prior to expanding said elongated sheet of paper, unfolding said elongated sheet of paper along said fold line such as to increase the width of said elongated sheet of paper and to create a single layer of paper.

23. In some embodiments, the method of any of the preceding paragraphs 15-22 further include winding said elongated sheet of paper into a roll.

24. In some embodiments, the method of any of the preceding paragraphs 15-22 further include winding said elongated sheet of paper into a roll and mounting the roll on a dispenser.

25. In some embodiments, the method of any of the preceding 15-22 further includes winding said elongated sheet of paper into a roll and mounting the roll on a dispenser, and expanding said elongated sheet of paper by applying a pulling force on the paper in a lengthwise direction such that said slits create expanded cells, and wrapping the elongated sheet of paper around an object.

26. In some embodiments, the method of the preceding paragraph 25 further includes wherein said object is an item that is contained within a package for shipping.

27. In some embodiments, the method of the preceding paragraph 25 further includes wherein said object is a pallet.

28. In some embodiments, the method of any of the preceding paragraphs 25-27 further include wherein said pulling force is applied manually.

29. In some embodiments, the method of any of the preceding paragraphs 25-27 further include wherein said pulling force is applied automatedly.

30. In some embodiments, the system, product or method of any of the preceding paragraphs, wherein said paper is made of an extensible paper.

31. In some embodiments, the system, product or method of any of the preceding paragraphs 1-30, wherein said paper is made of an extensible paper having an extensibility in a pre-slit configuration of greater than 3%, or, preferably, greater than 4%, or, preferably, greater than 5%, or, preferably, greater than 6%.

32. In some embodiments, the system, product or method of any of the preceding paragraphs 1-30, wherein said paper is made of an extensible paper having an extensibility in a pre-slit configuration of between 3% to 20%, or, preferably, between 4% to 20%, or, preferably, between 5% to 20%, or, preferably, between 6% to 20%.

33. In some embodiments, a system for dispensing wide expandable slit sheet paper includes:
a roll of expandable slit sheet paper, said roll of expandable slit sheet paper being formed from an elongated sheet of expandable slit sheet paper that is in a folded state in which said expandable slit sheet paper is folded along at least one fold line into at least two adjacent layers;
a support for rotatably supporting said roll of expandable slit sheet paper;
an end region of said expandable slit sheet paper extending from a perimeter of said roll of expandable slit sheet paper, said end region of said expandable slit sheet paper transitioning from said folded state proximate said roll of expandable slit sheet paper to an unfolded state downstream from said roll of expandable slit sheet paper.

34. In some embodiments, the system for dispensing wide expandable slit sheet paper of paragraph 33 includes wherein a width of said expandable slit sheet paper in said unfolded state prior to expansion of said expandable slit sheet paper is greater than 20 inches, or, preferably, greater than 25 inches, or, preferably, greater than 30 inches, or, preferably, greater than 35 inches, or, preferably, greater than 40 inches, or, preferably, greater than 45 inches, or, preferably, greater than 50 inches.

35. In some embodiments, the system for dispensing wide expandable slit sheet paper of paragraph 34 includes wherein said width of said expandable slit sheet paper in said unfolded state prior to expansion of said expandable slit sheet paper is less than 120 inches, or, preferably, less than 100 inches, or, preferably, less than 80 inches, or, preferably, less than 60 inches.

36. In some embodiments, the system for dispensing wide expandable slit sheet paper of paragraph 33 includes wherein a width of said expandable slit sheet paper in said unfolded state prior to expansion of said expandable slit sheet paper is greater is between 25 inches to 80 inches, or, preferably, between 25 inches to 60 inches, or, preferably, between 30 to 50 inches, or, preferably, between 35 and 45 inches.

37. In some embodiments, the system of paragraph 33 includes wherein said at least two adjacent layers is two adjacent layers.

38. In some embodiments, the system of paragraph 37 includes wherein said at least one fold line is one fold line.

39. In some embodiments, the system of paragraph 37 includes wherein said at least one fold line is two fold lines.

40. In some embodiments, the expandable slit sheet product of any of paragraphs 1-14 includes wherein said elongated sheet of expandable slit sheet paper is wound into a roll, and wherein said elongated sheet of expandable slit sheet paper is folded over at least one fold line such as to have at least two layers.

41. In some embodiments, the expandable slit sheet product of paragraph 40 includes wherein said at least one fold line is two fold lines.

42. In some embodiments, the expandable slit sheet product of paragraph 40 includes wherein said at least one fold line includes between two to ten fold lines.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by a way of example, and not limitation, in the accompanying figures, in which:

FIG. 1 is a perspective view of an illustrative manual expander in the open and ready to use position.

FIG. 2 is a perspective view of the recyclable manual expander in its closed configuration ready to be shipped;

FIG. 3 is a plan view of a section of an illustrative slit paper having a slit pattern that produces an expandable paper employed in some embodiments of the present invention;

FIG. 4 is a plan view of a section of a slit paper having the slit pattern of FIG. 3 that has been expanded to produce hexagonal cells employed in some embodiments of the present invention;

FIG. 5 is an explanatory schematic diagram that illustrates a roll of extensible slit sheet paper, with a length of paper unrolled from the roll according to some illustrative embodiments;

FIGS. 6A-6B are copies of FIGS. 17 and 18, respectively, from U.S. Pat. No. 5,782,735, the entire disclosure of which is incorporated herein by reference as if recited herein in full, wherein FIG. 6A shows a schematic illustration of an illustrative slitting system and FIG. 6B shows a top view of the rotary cutter and knives thereof shown in FIG. 6A.

FIG. 7 is a copy of FIG. 1 of U.S. Application Ser. No. 63/430,499, and shows a right-side perspective view of an illustrative example of a rotary cutter employing a slit-cutting apparatus configured to cut an array of slits within a sheet of material employing a die and anvil, along with an intermediary material layer on the anvil;

FIGS. 8A-8C and 9A-9B show stages related to the fabrication of an expandable slit sheet paper according to some embodiments of the present invention;

FIG. 9C shows an illustrative embodiment in which two fold lines are used to form a folded-over three-layer sheet in some examples;

FIGS. 10A-10C show illustrative embodiments of mechanisms for forming a folded paper sheet in some examples;

FIG. 11A is a schematic diagram showing longstanding background art for the formation of expandable slit sheet paper rolls;

FIGS. 11B-11C are schematic diagrams showing additional aspects according to some embodiments of the invention;

FIGS. 12A-12R, FIGS. 13A-13H and FIG. 14 show another illustrative embodiment of the present invention;

FIG. 15 shows an illustrative brush that can be employed in some embodiments of the invention; and

FIGS. 16A-16D and 17A-17D depict additional illustrative embodiments of dispensers for dispensing wide expandable slit sheet paper.

### DETAILED DESCRIPTION OF THE PREFERRED EMBODIMENTS

While the present invention may be embodied in many different forms, the illustrative embodiments are described herein with the understanding that the present disclosure is to be considered as providing examples of the principles of the invention and that such examples are not intended to limit the invention to preferred embodiments described herein and/or illustrated herein.

### Introduction to Environment of the Present Invention:

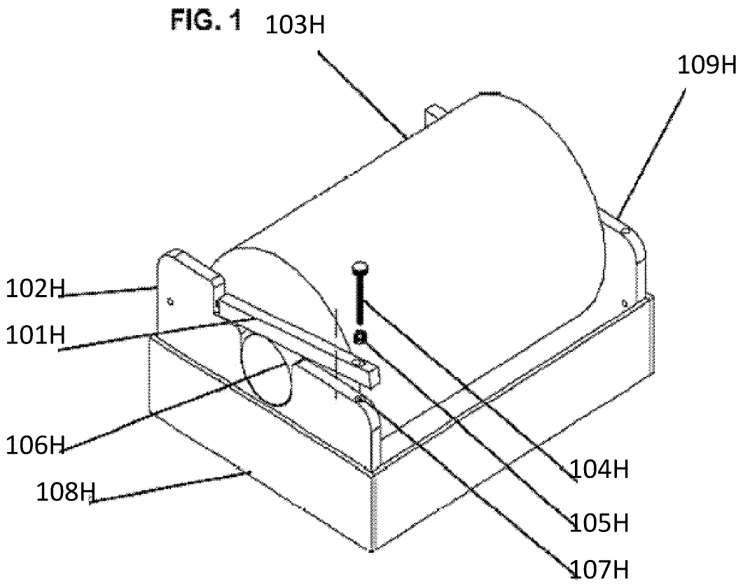

FIG. 1 is the perspective view of an illustrative expander that can be employed in some illustrative embodiments. See, e.g., U.S. Pat. No. 10,669,086, the entire disclosure of which is incorporated herein by reference as though recited herein in full. FIG. 1 is similar to FIG. 1 of said U.S. Pat. No. 10,669,086 and shows an illustrative expander that can be employed to expand an expandable slit sheet material that is wound in a roll and supported on the expander. As shown in FIG. 1, element 108H is a corrugated carton frame that houses and is adhered to corrugated yokes 102H and 109H at sides of the carton. The two yokes 102H and 109H have receiving openings that support opposite ends of a cylindrical paper core 106H that supports a roll 103H of unexpanded slit sheet paper that is wound around the core (i.e., having multiple windings or layers around the core). In some preferred embodiments, an optional roll holder 101H is mounted to one of the yokes (e.g., yoke 102H as shown) and adapted to apply a clamping force against the outer surface of the paper core 106 through the use of the setscrew 104H that passes through the spring 105H and the roll holder 101H into a threaded fixture 107H of the yoke 102H as described in co-pending non-provisional application Ser. No. 15/428,144 of the present inventor. By adjusting the setscrew 104H, the clamping force on the core 106H can be adjusted, whereby the tension force applied to the roll 103H upon pulling of the paper from the roll during operation can be adjusted.

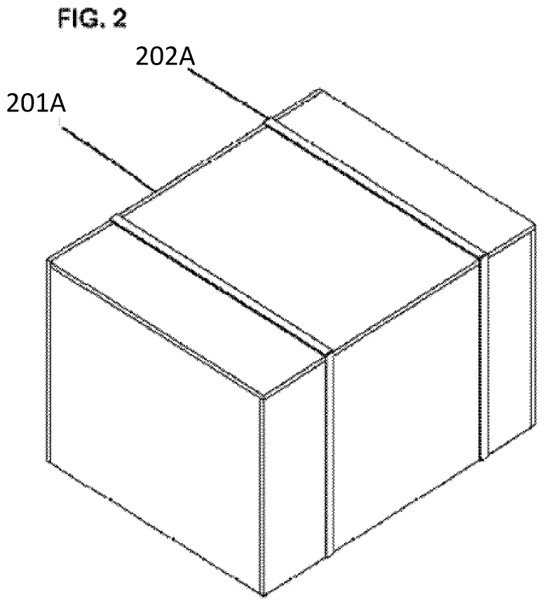

FIG. 2 is perspective view of the expander shown in FIG. 1 in a ready-to-ship configuration including upper corrugated box cover 201A fitted over and hiding the lower corrugated box 108H shown in FIG. 1 that supports the corrugated expansion device. In this illustrative example, straps 202A secure the upper corrugated box 202A to the lower corrugated box.

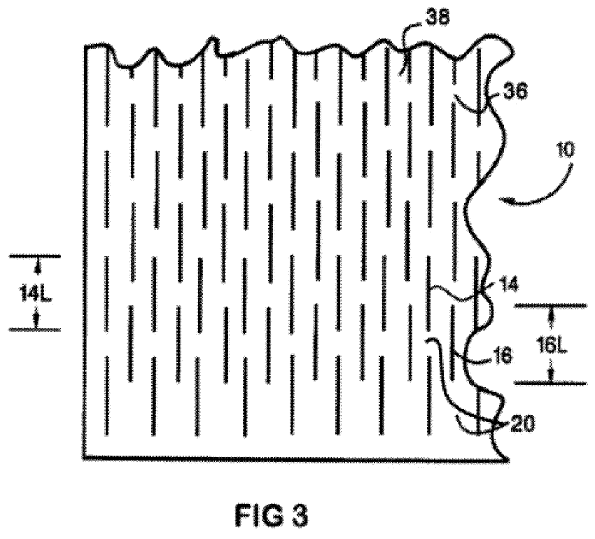

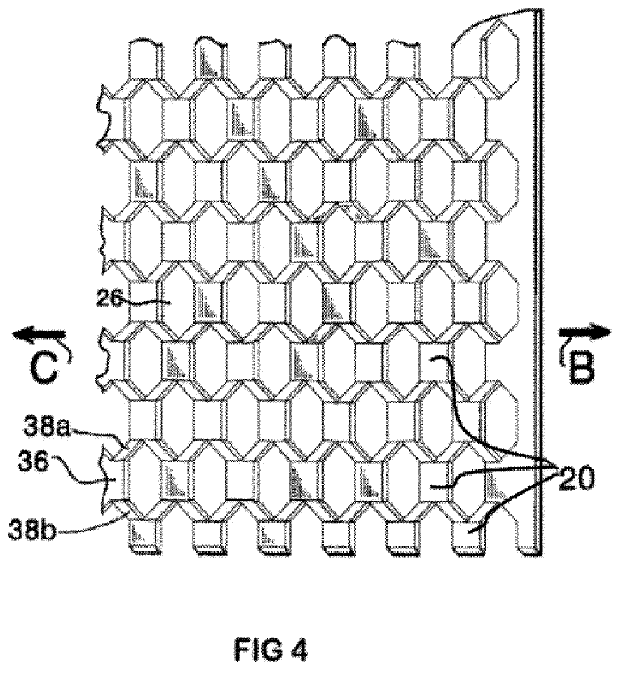

FIG. 3 is an illustration of an exemplary slit pattern in an illustrative expanded slit sheet. In some preferred embodiments, the expandable slit sheet paper includes a slit pattern similar to that shown in FIG. 3. The expandable slit sheet paper shown in FIG. 3 operates as an expandable cell-forming paper that can be expanded to an expanded state as shown in FIG. 4 (discussed below). FIG. 3 shows an illustrative section of an expandable slit sheet 10 in an unexpanded (unopened) state, with staggered rows of slits 14 and 16 that extend entirely through the width of the sheet 10, and land portions 20 extending between adjacent slits within rows 14 and 16. As shown in FIG. 3, in the preferred embodiments, the slit lengths 14L and 16L are uniform across the face of the sheet 10; similarly, the distance and area of each row spacing 38 (i.e., between adjacent rows) and each slit spacing 36 (i.e., between adjacent slits) are also uniform. Although an expandable slit sheet can be formed with a variety of slit patterns, the illustrative example shown in FIGS. 3 and 4 depicts an illustrative example to scale with illustrative lengths of slits, spacing between slits, proportional relationships of sizes of created hexagonal cells, land portions and leg portions, etc., according to some illustrative examples with such as drawings being to scale in some illustrative and non-limiting embodiments.

In FIG. 4, the sheet 10 shown in FIG. 3 has been pulled in the direction of arrows B and C and opened to its optimum cell formation. In that regard, the optimum cell formation results in a substantially hexagonal shaped cells as shown in FIG. 4. In particular, as depicted, the slits 14 and 16 are in an opened state in which the sheet 10 is oriented to have an array of three-dimensional hexagonal cells 26, with substantially rectangular land portions 20 within the slit spacings 36 situated at an inclined angle (i.e., such as to be transverse to the original plane of the sheet 10), and the leg portions 38a and 38b connecting the land portions between the row spacings having been warped to, e.g., slightly less than a 90° angle to the original plane of the sheet. The leg portions 38a and 38b are basically mirror images of one another and connect the land portions 20 such as to form the three-dimensional substantially hexagonal cells.

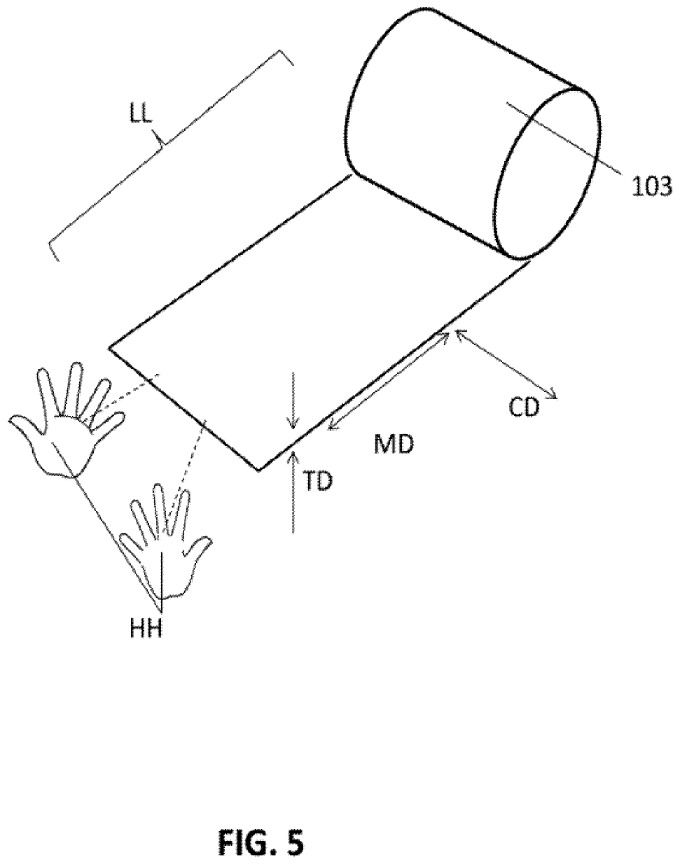

FIG. 5 is a schematic diagram that illustrates a roll 103 of the expandable slit sheet paper, with a length LL of paper unrolled from the roll 103. In this unrolled state, the expandable slit sheet paper is not in an expanded state unless an expanding force has been applied to the paper. Towards that end, in some preferred embodiments, the expanding force is applied by having an operator grasp a forward end of the length LL with the operator's hands HH and pulling the length LL along the longitudinal direction MD (also referred to herein as the machine direction) which extends parallel to the plane of the expandable slit sheet material. In this manner, in the illustrative embodiment shown in FIG. 5, a force will be applied to the sheet in the direction MD due to the opposing forces of pulling by hand and resistance of rotation at the roll 103. Notably, as indicated above, this resistance of rotation can preferably be adjusted by the operator to a desired force via the setscrew 104 discussed above. With reference to FIG. 5, the machine direction MD is perpendicular to the transverse direction CD (also referred to herein as the cross direction) which extends perpendicular to the longitudinal direction MD along the plane of the expandable slit sheet material. As also shown in FIG. 5, the machine direction MD and the cross direction CD are both perpendicular to the thickness direction TD which extends substantially vertically in the illustrated example shown in FIG. 5.

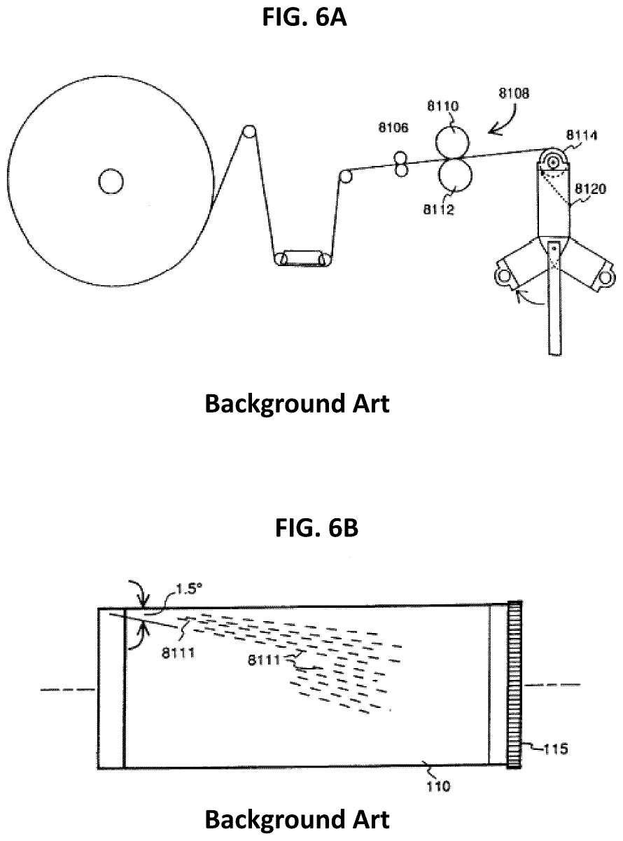

With reference to FIGS. 6A and 6B, FIGS. 6A and 6B are a copy of FIGS. 17 and 18, respectively, from U.S. Pat. No. 5,782,735, the entire disclosure of which is incorporated herein by reference as if recited herein in full.

As explained, by way of example, in U.S. Pat. No. 5,782,735, in the formation of a slit pattern within expandable slit sheet paper, a rotatory die cutter has been employed in the background art.

By way of example, column 12, line 66+ of U.S. Pat. No. 5,782,735 describes an illustrative background art implementation of a rotary die cutter for formation of expandable slit sheet paper, as follows:

“The rotary die cutting of the expanded paper is preferably performed using a hardened steel die with tolerances of 0.001 of an inch. The anvil is a round, extremely hard cylinder. It has been found that the cutting of the plurality of slits results in a vibration of the rotary die cutter and a shortening of the life of the equipment, in particular, the die. The vibration problem can, however, be eliminated by offsetting the knives about 1.5°. from the axis of the die. It appears that the vibration is due to the fact that the rows of knives are spaced ⅛ inch apart. Even though the cutting action is on a sheet of paper only 0.007 or 0.008 inch thick, the net effect is a chopping action and a resultant vibration. The skewing of the knives results in a continuous cutting action, since there is a simultaneous entry of a plurality of knives into the paper and withdrawing from the paper. The range is limited at one extreme by the necessity for the slits to be close to being perpendicular to the edges of the web, so that during the expansion step, the expansion proceeds in a controlled manner. That is, the paper expanded without skewing in one direction. At the other extreme, the skewing of the knives must be sufficient to provide a continuous cutting and prevent die vibration. Accordingly, the skewing of the knives, as illustrated in FIG. 18, must be at least about 0.5 but less than 5 degrees. Optimally, the range is within 1.0 degrees and 1.75 degrees. When the paper is fed from two rolls to an expander, by reversing the angular offset of the rolls, the line of the cells formed from the slits, are offset by an angle which is double the offset produced by the skewing of the knives, rather than being parallel. This serves to optimize the nesting effect and maximize the cushioning effect.”

“The extendible sheet material can be a single layer of flexible paper material or multiple layers wound on the same roll. Preferably, the multiplies plies are formed in-situ by using multiple rolls of single layer sheet material which are combined in the guide roll path. The advantage of using, for example, two rolls of single layer sheet material is that where a small amount of material is required to wrap an object, a single roll can be used in the system. In applications where large amounts of void fill are required, two rolls can be unwound simultaneously, to produce a two-ply void fill material.”

“Where a plurality of plies of sheet material are used, either through the preferred use of two rolls or by using a multi-ply roll, the parallel rows of individual slits preferably form an angle with the longitudinal axis (the opposing edges of the sheet) in the range from about 89.5 to 87 degrees. Consequently, the parallel rows of slits of adjacent layers form an angle in the range from about 1° to about 6° with each other. That is, the line of slits of adjacent plies cross each other at an angle in the range from about 1° to about 6°.”

“Thus, the skewing of the knives not only improves the cutting operation but also optimizes the cushioning affect.”

“The rotary die cutting equipment includes a paper supply roll and web tension guide. The web guide controls tracking of paper from side to side, thereby facilitating high speed die cutting. The roller serves to decurl the rolled paper, prior to die cutting. As shown in FIG. [6A], the paper 8104 is fed between nip rollers, to the die-cutting station indicated generally as 8108. The rotary die 8110, containing the knives 8111, shown in FIG. [6B], interacts with the hard anvil 8112 to produced the desired slit pattern. The rotary die is driven by a conventional power source, not shown, and can be belt driven or driven through gear teeth. The slit paper is then wound on a rewind roller 8114. Nip rollers can be used between the rotary die cutting and the rewind roller 8114.”

“The web tension must be less than 4.5 oz. per inch of width. For paper webs less than 20 inches in width, the problem of maintaining the rewind tension within the necessary limits is particularly severe. This problem is discussed in copending patent application, Ser. No. 119,472, filed Sep. 10, 1993. The regulation of the rewind tension can be achieved through the use of a variable tension sensor and control 8120. The variable tension sensor and control senses the amount of paper which has been rewound on the rewind roller 8114. Preferably, the speed of the paper web through the rotary die 8110 is essentially constant. As the amount of paper on the rewind roller 8114 increases along with the diameter of the rewound web, the linear speed of the web increases. To maintain a constant tension, the rotational speed of the rewind roller 8114 must be decreased.”

“A highly sensitive plasma magnetic clutch or a hydraulic clutch can be used to maintain the rewind tension within the required limits, relative to the width of the paper web. When the rewind tension exceeds the proper limit, the cells open, and the paper is wound in the form of open cells. If the rewind tension is too low, the paper web is traveling at an uneconomically slow rate. Further, at low tension the roll is not tight. A tightly wound roll provides the optimum amount of material relative to the diameter of the roll. An open cell roll represents one extreme, while a tightly wound roll represents the other extreme. A loosely wound unexpanded roll is preferable to a tightly wound expanded roll. In order to amortize the cost of the equipment over a reasonable period of time, the paper through put must be maintained at the maximum possible speed. When the tension is unnecessarily low, the rewind mechanism becomes the bottle neck in the manufacturing operation.”

“The use of a rewind turret mechanism such as disclosed in British patent 777,576 Published Jun. 26, 1957, U.S. Pat. Nos. 1,739,381 and 2,149,832, provides for a continuous operation, in that the system need not be stopped when the rewind roll has the desired footage of material, preferably about 30 pounds of paper per roll.”

Other rotary die cutters which can be employed in various embodiments of the present invention are shown in each of the following background patents, the entire disclosures of which are incorporated herein by reference: a) U.S. Pat. No. 5,538,778, b) U.S. Pat. No. 5,667,871, c) U.S. Pat. No. 5,688,578, and d) U.S. Pat. No. 10,226,907.

For example, in some embodiments, rotary die cutters can include hard or soft anvils as described in U.S. Pat. No. 10,226,907 which explains that “the slitting operation can employ blades that press almost through the paper to a hard anvil or blades that cut through the paper to a soft round anvil.” See paragraphs [0125] and [0134].

Furthermore, in some embodiments, rotary die cutters can include an intermediary material layer that is placed upon an anvil in the manner described and set forth in either of pending U.S. Application Ser. No. 63/268,696, filed Feb. 28, 2022, and 63/430,499, filed Dec. 6, 2022, the entire disclosures of which are incorporated herein by reference as if recited herein in full.

Towards that end, as discussed in said Application No. 63/430,499, at pages 11-12, “According to some of the preferred embodiments of the present invention, an intermediary material layer IM is placed upon the anvil. In the preferred embodiments, this intermediary material layer advantageously creates a hybrid of a soft anvil and a hard anvil die cutting method. In the preferred embodiments, the intermediary material layer is soft and pliable such as to be able to be bent around the periphery of the anvil. In the preferred embodiments, the intermediary material layer can be adhered to the anvil with the use of a mild adhesive. However, the intermediary material layer can be connected in a variety of ways, such as, e.g., via a mechanical connection (e.g., clamps, rivets, etc.), chemically adhered, meltedly or heatedly adhered, statically adhered, and/or otherwise mounted to or attached to the anvil. In operation, the knives of the cutting blade preferably penetrate into the intermediary material layer such as to create and provide slots within the intermediary material layer that the knives or blades enters, guaranteeing a cut through the material (e.g., paper or the like), but the knives or blades, advantageously, does not touch the anvil such as to provide a longer life of the anvil, along with a longer tooling life, along with lower die-cutting pressures, and/or along with inhibiting lateral shifting of the die (e.g., of a flexible die or the like), and/or along with other advantages and/or benefits described herein.”

As further discussed in said Application No. 63/430,499, at pages 19-21,

“According to some embodiments, the intermediary material layer IM can be made with an plastic, elastomeric material, a polymeric material, a rubber material, or with another non-rigid material (such as, e.g., for example, a paper material, fabric materials, soft wood material, cardboard material, a Styrofoam or other foam material, and/or another non-rigid material). In some embodiments, the intermediary material layer IM can be made with metals or other materials, provided that the hardness of the intermediary material layer IM is sufficiently soft such that blades can penetrate into said intermediate material layer. By way of example, in some illustrative embodiments the intermediary material layer IM can be made of aluminum. For example, in some embodiments, the intermediary material layer IM can be made from an aluminum foil layer or sheet that can be, e.g., wrapped around an anvil in accordance with embodiments described herein. In some other illustrative embodiments, other softer metals (e.g., other metals having a Mohs scale of hardness that is sufficiently low to allow the blades to penetrate therein). By way of example, in other embodiments, the intermediary material layer IM can be made with one or more of the following metals:
a) lead,
b) gold,
c) silver,
d) tin,
e) zinc,
f) aluminum,
g) thorium,
h) copper,
i) brass,
j) bronze,
k) nickel.

In some illustrative embodiments, an intermediary material layer (IM) can be made with a metal having a Mohs scale of hardness value of about 4.0 or less, or, in some embodiments, about 3.5 or less, or, in some embodiments, about 3.0 or less, or, in some embodiments, about 2.5 or less. In some illustrative embodiments, an intermediary material layer (IM) can be made with a metal having a Mohs scale of hardness value of between about 1.0 to 4.0, or, in some embodiments, between about 1.5 to 3.75, or, in some embodiments, between about 2.0 to 3.5, or, in some embodiments, between about 2.25 to 3.25, or, in some embodiments, between about 2.5 to 3.0.

As indicated herein, in preferred embodiments, the intermediary material layer IM should have a sufficient softness in comparison to the hardness of the blades such that the blades can penetrate within the intermediary material layer IM as set forth in various embodiments of the invention described herein.”

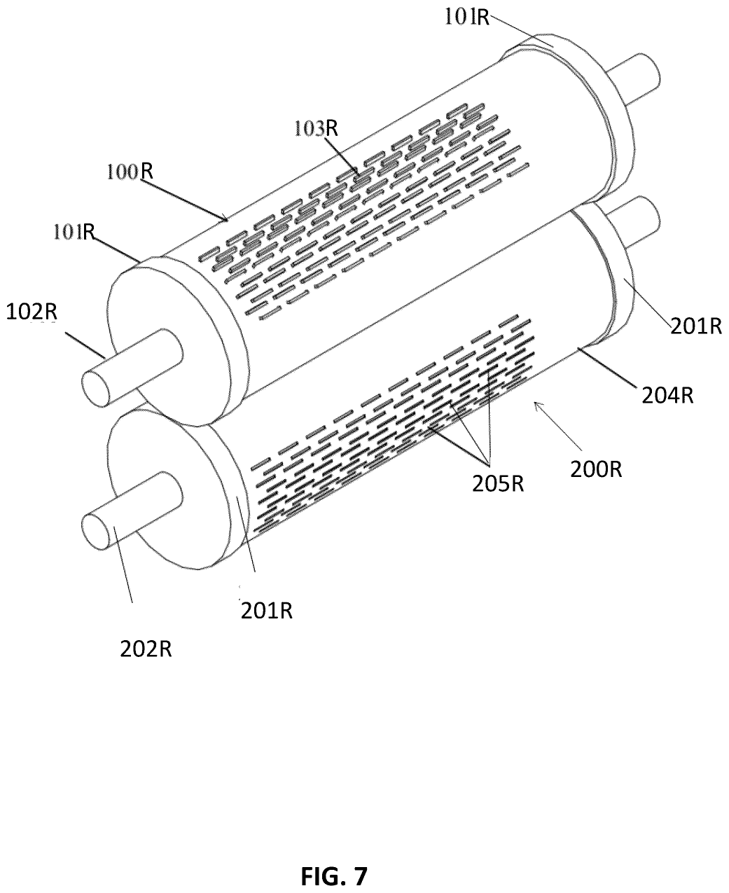

For further reference, FIG. 7 corresponds to FIG. 1 of said Application No. 63/430,499, and, as explained at pages 36-37 of said Application No. 63/430,499,

“With reference to FIG. [7], FIG. [7] shows an illustrative embodiment of the present invention. In particular, FIG. [7] shows an illustrative rotary die member 100 having an array of knives or blades [103R] extending around the perimeter circumference thereof (note: although blades [103R] are shown as over a portion of the perimeter circumference of the member [100R], in the preferred embodiments, the array of blades [103R] extends around the entire perimeter circumference of the die member [100R]). As shown, the rotary die member [100R], includes a central shaft [102R] for imparting rotational movement to the rotary die member [100R] (e.g., via gears, drive motor, controller, etc.). As also shown, the rotary die member [100R] also includes two bearer members [101R] at the ends of the rotary die member. The bearer members [101R] are arranged to press and roll against the respective bearer members [201R] of the anvil [200R] as described herein-above.

As shown in FIG. [7], the anvil [200R] includes an intermediary material layer [204R] around the perimeter circumference thereof. As shown, the outer surface of the layer [204R] is recessed slightly below the outer surface of the bearer members [201R] such that the forces between the rotary die member [100R] and the anvil [200R] are mainly distributed through the bearer members [101R] and [201R].

As shown in FIG. [7], the intermediary material layer [204R] is formed to include recesses or grooves [205R] corresponding to the blades [103R] by pressing of the die member [100R] against the anvil [200R] (e.g., via the bearer members [101R], [201R]) and rotating the die member and anvil [200R] relative to one another such that the blades [103R] extend into the intermediary material layer [204R] and create such recesses or grooves [205R] around the periphery of the anvil. Although recesses or grooves are depicted only around a portion of the periphery of the anvil, it should be appreciated that the entire periphery of the anvil would be adapted to include such recesses or grooves corresponding to the locations of the respective blades [103R] of the die member [100R].

In the illustrative embodiment shown in FIG. [7], the diameter of the die member [100R] is set to be equal to the diameter of the anvil [200R], such that each blade [103R] will correspond to a respective recess or groove [205R] formed therefrom in the anvil—i.e., such that after a full rotation, the same blade [103R] will be received within the same recess or groove [205R] originally created by that same blade [103R]. Among other things, this one-to-one relationship of the blades [103R] and the recesses or grooves [205R] can also help lead to the creation of fine tolerances and quality because, among other things, the recesses or grooves will be finely adapted to the shape or orientation of each respective blade [103R]. Similarly, in the event that any of the blades may shift or bend, the intermediary material layer [204R] can simply be removed and replaced with a new layer [204R] such as to “re-set” the relationship between the blades and the recesses or grooves [205R].

Although not shown in FIG. [7], in some preferred embodiments, the anvil [200R] is similarly caused to rotate via gearing and a driving mechanism (e.g., drive motor) that imparts rotation to the anvil [200R] via the shaft [202R].

In some embodiments, the die member [100R] and the anvil [200R] are adapted from an existing system that includes the anvil [200R] without an intermediary material layer [204R], wherein the blades [103R] are provided and arranged such as to crush cut a paper material to create an expandable slit sheet material by crush cutting the paper material between ends of the blades [103R] and a smooth outer peripheral surface of the anvil (e.g., a smooth metal perimeter of the anvil). In some such embodiments, the anvil [200R] is adapted by applying a peripheral layer forming the intermediary material layer [204R] that surrounds the anvil, such as to adapt the device from a prior crush-cutting system to a slit-cutting system in which the tips of the blades [103R] are configured to pass entirely or substantially entirely through the paper material being slit by the system.”

As further discussed in said Application No. 63/430,499, at pages 10-11, in some embodiments a die cutter can be employed that incorporates other aspects set forth in said application, including, e.g., that,

“In some illustrative embodiments, die cutting technologies employed can include some or all of the following components.

Roller (e.g., Magnetic Roller): In some examples, a roller (for example, a magnetic roller) is employed that involves a roller or cylinder to perform rotary die cutting. In some embodiments, a roller is employed that includes a plurality (e.g., an array) of cutting elements (e.g., cutting knives or blades) extending therefrom. In some embodiments, a roller can include a die surrounding the roller or wrapped around the roller. For example, in some embodiments, a flexible die is provided that is wrapped around the roller.

Anvil: In some examples, an anvil is employed that is either reciprocated (such as, e.g., for a flat or planar anvil) or rotated (such as, e.g., for a round or cylindrical anvil), and operates as a component (e.g., a platen) that receives pressure (e.g., that knives or blades press against) as the knives cut through the material that is formed with slits.

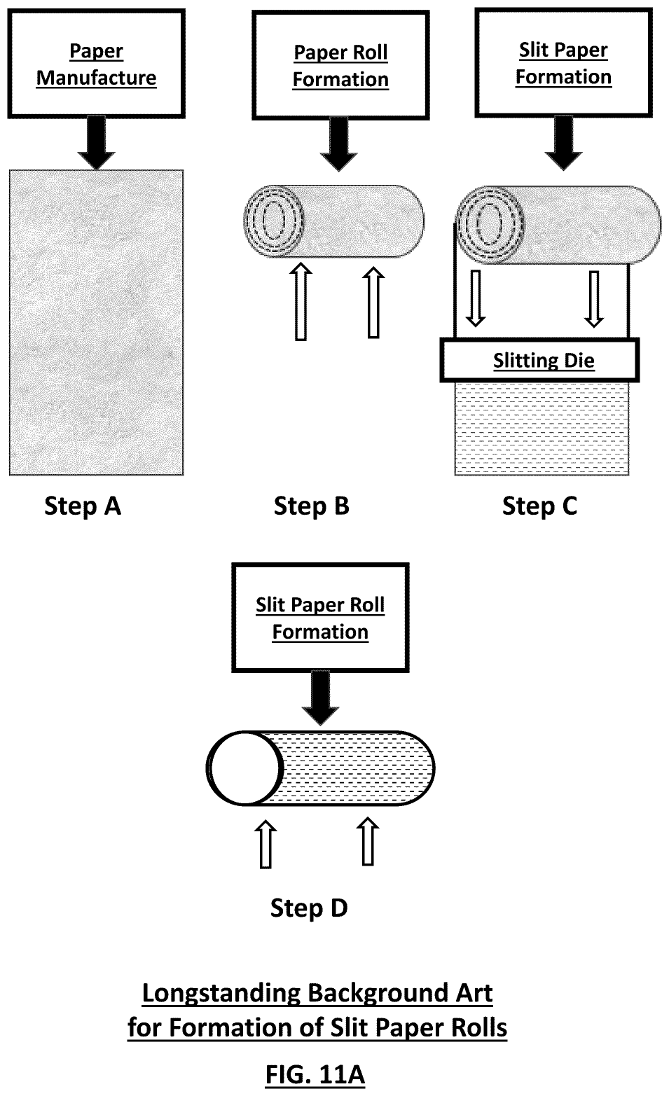

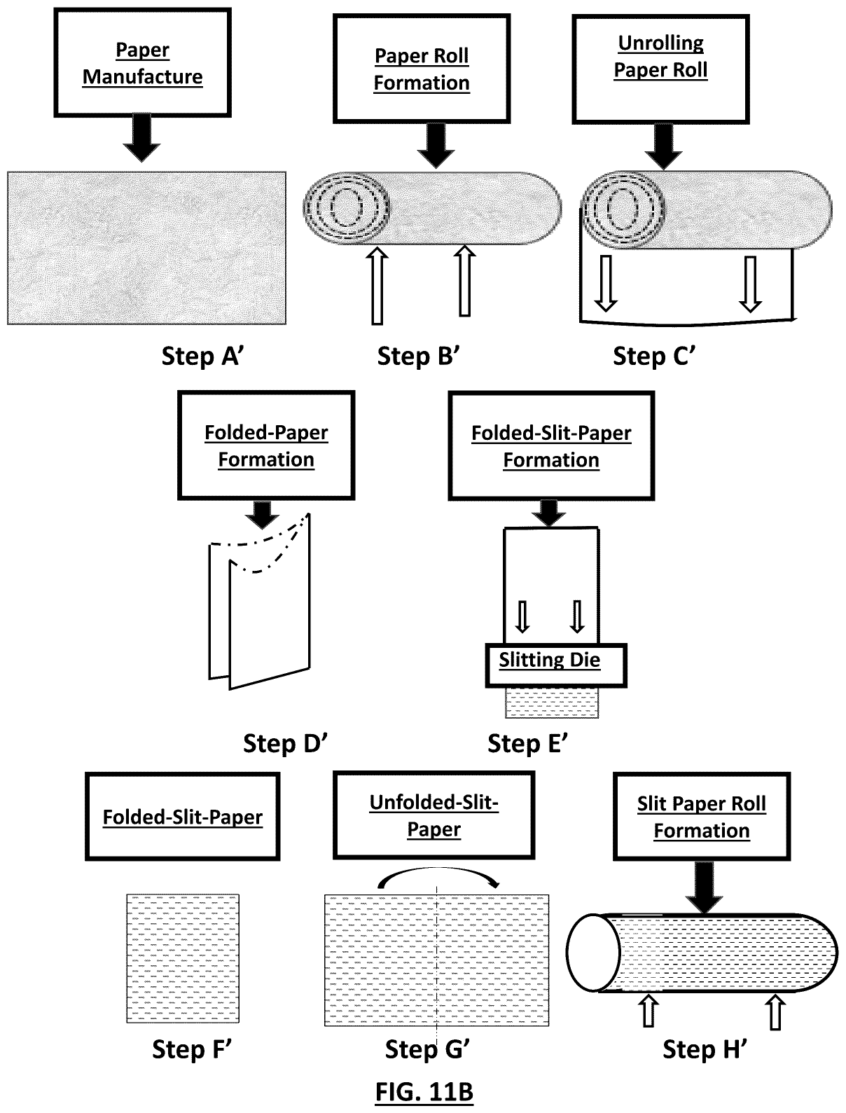

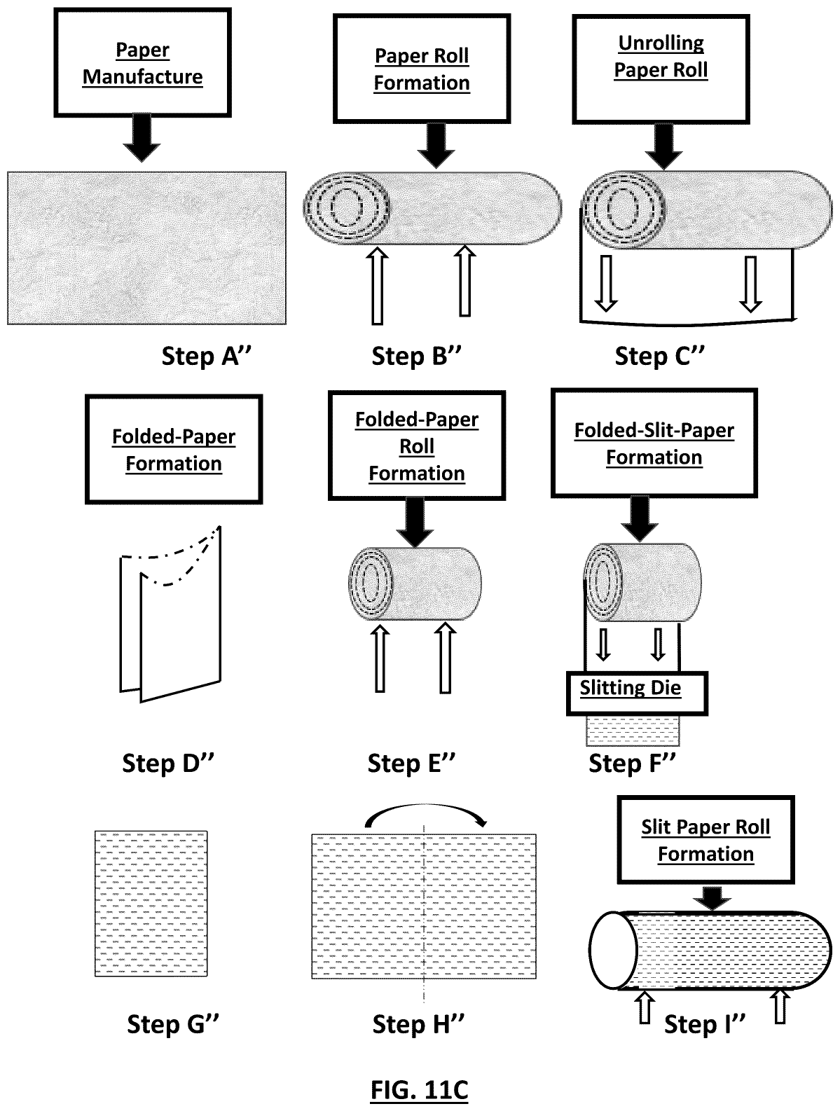

Pressure (e.g., Screw) Jacks: In some examples, in order to apply pressure required between rollers (e.g., having cutting knives or the like) and the anvil, a pressure jack, such as, e.g., a screw jack is employed. In some embodiments, threaded rods are used to apply pressure to both sides of the die cutting and unto the bearers to create the pressure needed to die cut (e.g., to cut a sheet material between the roller and the anvil). By way of illustration, FIG. 11 shows an illustrative system employing screw jacks SJ.

In some illustrative applications, a crush-cut die system is employed that includes a solid die. In some examples, a lower roller is provided that is an anvil (e.g., which is rigid and smooth) and an upper roller is provided that has a die (e.g., with cutters and/or knives thereon); in some embodiments, one or more pressure jack (see, e.g., SJ in FIG. 11; such as, e.g., a screw jack) is employed that is used to apply pressure to the bearers (see, e.g., BR in FIG. 11).

Roll Apex: In some illustrative applications, a location of contact between the roller (e.g., the cutting roll) and the anvil (e.g., the anvil roll) that provides a greatest pressure against one another is at a point of contact between a roll apex of the cutting roll and/or a roll apex of the anvil roll.”

In various embodiments, the slit pattern imparted to the expandable slit sheet paper can be similar to the patterns and/or slit dimensions as discussed in said Application No. 63/430,499, including, e.g., that,

“Although embodiments of the present invention can be applied within various expandable slit sheet papers having various patterns of slits, in some preferred embodiments, the dimensions of the expandable slit sheet paper are proportionally reduced from an expandable slit sheet paper having a 0.5″ slit length, a ⅛″ (0.125 inch) spacing between rows, and a spacing between slits within the same row (i.e., land length) of 3/16″ (0.1875 inch) as follows: a) the row spacing is proportionally reduced by a ratio SL(new)/0.5 and b) the slit spacing is set at SL(new) multiplied divided by 2.6667. For example, some preferred embodiments include dimensions as set forth below Table A:

| | Slit Length (SL) | | Slit Spacing (SS) | | Row Spacing (RS) | |
|---|---|---|---|---|---|---|
| Example A | 0.45 | inches | 0.1687 | inches | 0.1125 | inches |
| Example B | 0.425 | inches | 0.1594 | inches | 0.1063 | inches |
| Example C | 0.40 | inches | 0.1500 | inches | 0.1000 | inches |
| Example D | 0.375 | inches | 0.1406 | inches | 0.09375 | inches |
| Example E | 0.35 | inches | 0.13125 | inches | 0.0875 | inches |
| Example F | 0.325 | inches | 0.1219 | inches | 0.0813 | inches |
| Example G | 0.30 | inches | 0.1125 | inches | 0.0750 | inches |
| Example H | 0.275 | inches | 0.1031 | inches | 0.0688 | inches |
| Example I | 0.25 | inches | 0.09375 | inches | 0.0625 | inches |

In some other embodiments, the slit lengths can be greater than 0.5 inches, while in some other embodiments, the slit lengths can be smaller than 0.25 inches. Similarly, in some embodiments, the slit spacing (i.e., distance between slits within a same row of slits) can be greater than 0.1687 inches, while in some other embodiments, the slit spacing can be less than 0.09375 inches. Similarly, in some embodiments, the slit row spacing (i.e., distance between slits in adjacent rows of slits) can be greater than 0.1125 inches, while in some other embodiments, the row spacing can be less than 0.0625 inches.”

### FURTHER ASPECTS OF THE PREFERRED EMBODIMENTS

### Paper and Cutting Dies:

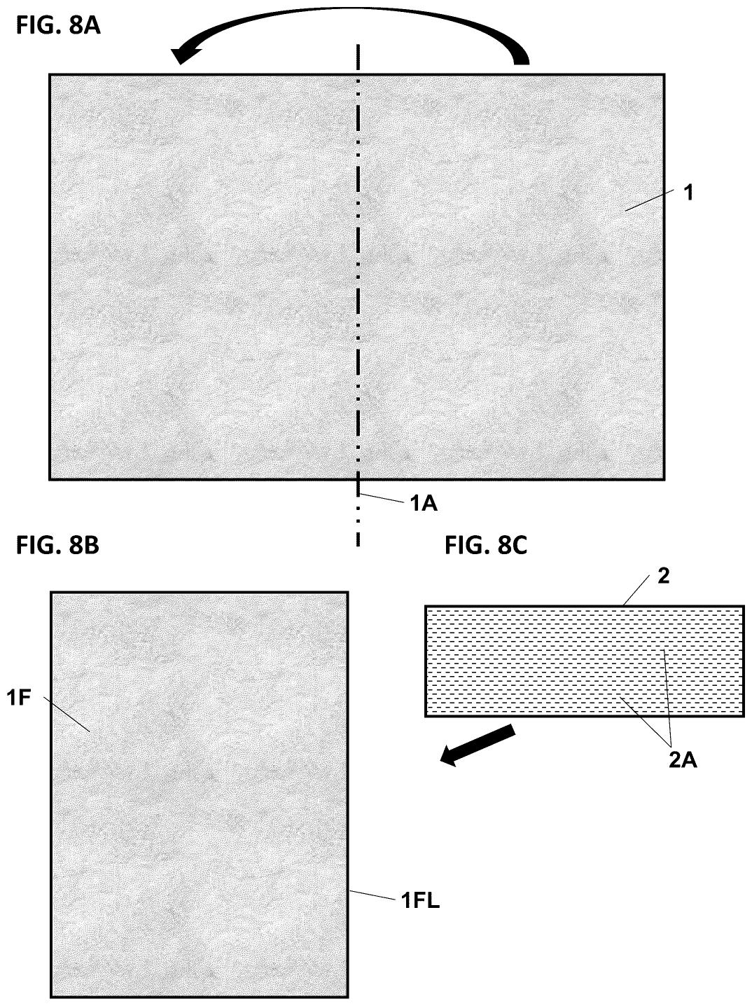

With reference to FIGS. 8A-8C, according to some of the preferred embodiments, in the fabrication of an expandable slit sheet paper according to some embodiments of the present invention, an initial sheet of paper 1 shown in FIG. 8A is initially provided, which sheet of paper 1 is folded over at least one fold line 1A (one fold line shown in the illustrative example of FIG. 8A), such as to form a folded sheet of paper as shown in FIG. 8B having two layers connected along a fold-line seam. Thereafter, a die 2 having an array of cutting blades 2A is used to create an array of slits within the folded paper sheet 1. In some preferred embodiments, the die includes any of the dies described herein, such as, e.g., a rotary cutting die having an array of cutting blades distributed around a substantially cylindrical periphery thereof, a reciprocated cutting die having an array of cutting blades distributed across a surface thereof or the like.

In some of the preferred embodiments, the initial sheet of paper 1 can be any paper sheet, such as, e.g., a paper made with fibers, such as, e.g., natural fibers, plant-based fibers, cellulose fibers, or the like. In some embodiments, the paper 1 is a Kraft paper. In some embodiments, the paper 1 is an extensible paper, such as, e.g., any of the extensible papers describe in U.S. Pat. No. 10,669,086, the entire disclosure of which is incorporated herein by reference as if recited herein in full. In the preferred embodiments, the paper 1 is made of a recyclable paper material. In some embodiments, the paper 1 can be made entirely from recycled paper. In some embodiments, the paper 1 can be made entirely from virgin, non-recycled, paper. In some embodiments, the paper 1 can be made with a combination of recycled paper and virgin paper. In some embodiments, the paper is a paper that weighs greater than 25 pounds (lbs.) per 3,000 square feet (i.e., 25 #paper). In some embodiments, the paper is a paper that weighs greater than 30 pounds per 3,000 square feet (i.e., 30 #paper). In some embodiments, the paper is a paper that weighs greater than 40 pounds per 3,000 square feet (i.e., 40 #paper). In some embodiments, the paper is a paper that weighs greater than 40 pounds per 3,000 square feet (i.e., 40 #paper). In some embodiments, the paper is a paper that weighs greater than 50 pounds per 3,000 square feet (i.e., 50 #paper). In some embodiments, the paper is a paper that weighs greater than 60 pounds per 3,000 square feet (i.e., 60 #paper). In some embodiments, the paper is a paper that weighs greater than 70 pounds per 3,000 square feet (i.e., 70 #paper). In some embodiments, the paper is a paper that weighs between about 30 pounds per 3,000 square feet to 70 pounds per 3,000 square feet. In some embodiments, the paper is a paper that weighs between about 40 pounds per 3,000 square feet to 60 pounds per 3,000 square feet. In some embodiments, the paper is a paper that weighs between about 35 pounds per 3,000 square feet to 55 pounds per 3,000 square feet. In some embodiments, the paper is a paper that weighs between about 45 pounds per 3,000 square feet to 55 pounds per 3,000 square feet. In some embodiments, the paper is a paper that weighs between about 30 pounds per 3,000 square feet to 70 pounds per 3,000 square feet. In some embodiments, the paper is a paper that weighs between about 50 pounds per 3,000 square feet to 60 pounds per 3,000 square feet.

In the background art, paper employed for formation of expandable slit sheet paper has been formed as elongated sheets of paper that are wrapped into cylindrical paper rolls. In some examples, such cylindrical paper rolls have been formed with an axial length of about 15¼ inches, such that the elongated sheets of paper have a width of about 15¼ inches.

In the existing art, formation of expandable slit sheet paper requires that the dies, such as rotary cutting dies, have high strength and precision in view of the repetitive cutting of thin, small slits into coarse paper materials. By way of example, a rotary cutting die having a length sufficient to cut an array of slits into an elongated sheet of paper having a width of about 15¼ inches may require a very heavy duty rotary cutting die. For example, such rotary cutting die may weigh greater than 50 to 100 pounds, or even 150 pounds or more. Moreover, to ensure consistent and long-term operation, the rotary cutting die requires high strength blades and die surfaces, as well as high precision bearings for smooth and accurate operation.

As a result, formation of expandable slit sheet paper from elongated sheets of paper having larger widths can be very difficult. Notably, increasing of the length of a rotary cutting die sufficient to cuts slits into an elongated sheet of paper having a width of 20 inches requires an even greater weight and precision to ensure accuracy and precision beyond that required for cutting slits into an elongated sheet of paper having a width of 15¼ inches. Moreover, increasing of the length of a rotary cutting die sufficient to cuts slits into an elongated sheet of paper having a width of 25 inches or more, as in embodiments of the present invention, would require an even much greater weight and precision to ensure accuracy and precision. Moreover, increasing of the length of a rotary cutting die sufficient to cuts slits into an elongated sheet of paper having a width of 30 inches or more, as in embodiments of the present invention, would require an even much greater weight and precision to ensure accuracy and precision. Moreover, increasing of the length of a rotary cutting die sufficient to cuts slits into an elongated sheet of paper having a width of 35 inches or more, as in embodiments of the present invention, would require an even much greater weight and precision to ensure accuracy and precision. Moreover, increasing of the length of a rotary cutting die sufficient to cuts slits into an elongated sheet of paper having a width of 40 inches or more, as in embodiments of the present invention, would require an even much greater weight and precision to ensure accuracy and precision. Moreover, increasing of the length of a rotary cutting die sufficient to cuts slits into an elongated sheet of paper having a width of 45 inches or more, as in embodiments of the present invention, would require an even much greater weight and precision to ensure accuracy and precision. Moreover, increasing of the length of a rotary cutting die sufficient to cuts slits into an elongated sheet of paper having a width of 50 inches or more, as in embodiments of the present invention, would require an even much greater weight and precision to ensure accuracy and precision. Moreover, increasing of the length of a rotary cutting die sufficient to cuts slits into an elongated sheet of paper having a width of 55 inches or more, as in embodiments of the present invention, would require an even much greater weight and precision to ensure accuracy and precision. Moreover, increasing of the length of a rotary cutting die sufficient to cuts slits into an elongated sheet of paper having a width of 60 inches or more, as in embodiments of the present invention, would require an even much greater weight and precision to ensure accuracy and precision.

For example, doubling of the width of the paper employed for making an expandable slit sheet paper may more than double the required weight of a required rotary cutting die in some embodiments, or may more than triple the required weight of a required rotary cutting die in some embodiments, or may even more than quadruple the required weight of a required rotary cutting die in some embodiments. Moreover, the diameter of the rotary cutting die would likely require to be greatly increased, and additional structural burdens and requirements would be placed on bearings and the like, resulting in substantial cost increases, along with substantial development and implementation issues.

### Die-Efficiency Enhancing Paper Handling and Folding:

According to some of the preferred embodiments of the present invention, a novel methodology and structure is provided which can greatly reduce costs and complications related to the provision of cutting dies for formation of expandable slit sheet paper.

In particular, with reference to FIG. 8A, according to some embodiments, in order to more efficiently use a smaller cutting die (e.g., die 2 shown in FIG. 8C) for the formation of larger width expandable slit sheet paper, a novel methodology and structure is provided in which an elongated paper sheet 1 is provided, which is folded over a fold line 1A (such as, e.g., a central fold line as shown in FIG. 8A to create a folded-over two layer sheet 1F as shown in FIG. 8B having two layers that are connected along a seem 1FL formed by folder over the fold-line 1A.

By way of example, in some embodiments, the initial sheet of paper 1 shown in FIG. 8A can be made with a width of greater than 20 inches, or, more preferably, equal to or greater than 25 inches, or, more preferably, equal to or greater than 30 inches, or, more preferably, equal to or greater than 35 inches, or, more preferably, equal to or greater than 35 inches, or, more preferably, equal to or greater than 40 inches, or, more preferably, equal to or greater than 45 inches, or, more preferably, equal to or greater than 50 inches, or, more preferably, equal to or greater than 55 inches, or, more preferably, equal to or greater than 60 inches, or, more preferably, equal to or greater than 70 inches, or, more preferably, equal to or greater than 80 inches, or, more preferably, equal to or greater than 90 inches, or, more preferably, equal to or greater than 100 inches.

In some preferred embodiments, the elongated paper sheet 1 has a width of between about 20 to 60 inches. In some preferred embodiments, the elongated paper sheet has a width of between about 25 to 55 inches. In some preferred embodiments, the elongated paper sheet has a width of between about 30 to 50 inches. In some preferred embodiments, the elongated paper sheet has a width of about 35 to 45 inches. In some preferred embodiments, the elongated paper sheet has a width of about 40 inches.

In the illustrative embodiment shown in FIGS. 8A to 8C, the die 2 is formed with a width dimension sufficient to impart an array of slits within the paper 1, after folding the paper to a folded-over two layer sheet 1F as shown in FIG. 8B. By way of example, in some illustrative embodiments in which the elongated paper sheet has a width of about 40 inches, the die 2 has a die cutting surface of approximately 20 inches (e.g., ½ that of the width of the elongated paper sheet) such as to impart required slits when the paper is in the state of the folded-over two-layer sheet 1F. As a result, expandable slit sheet papers can be created having a width substantially larger than that of existing expandable slit sheet papers without requiring the implementation or creation of large and complex cutting dies. Notably, cutting dies that are the same or substantially the same as existing cutting dies employed for making narrower width expandable slit sheet papers can be employed in some embodiments. More specifically, in embodiments in which the paper 1 is folded over a single central fold line 1A, the die 2 can have a width of ½ or approximately ½ of the width of the elongated paper sheet 1.

During formation of the array of slits in the folded-over two-layer sheet 1F, the knives of the die 2 penetrate and pass through all layers of the folded-over two-layer sheet 1F. In particular, rather than a single knife blade creating a single slit within a single layer of the sheet at a particular time, a single knife blade can, thus, concurrently create a plurality of slits within a plurality of layers of the sheet. Thus, the die 2 can efficiently create a greater surface area slit pattern with a smaller surface area of cutting knife blades with embodiments of the present invention.

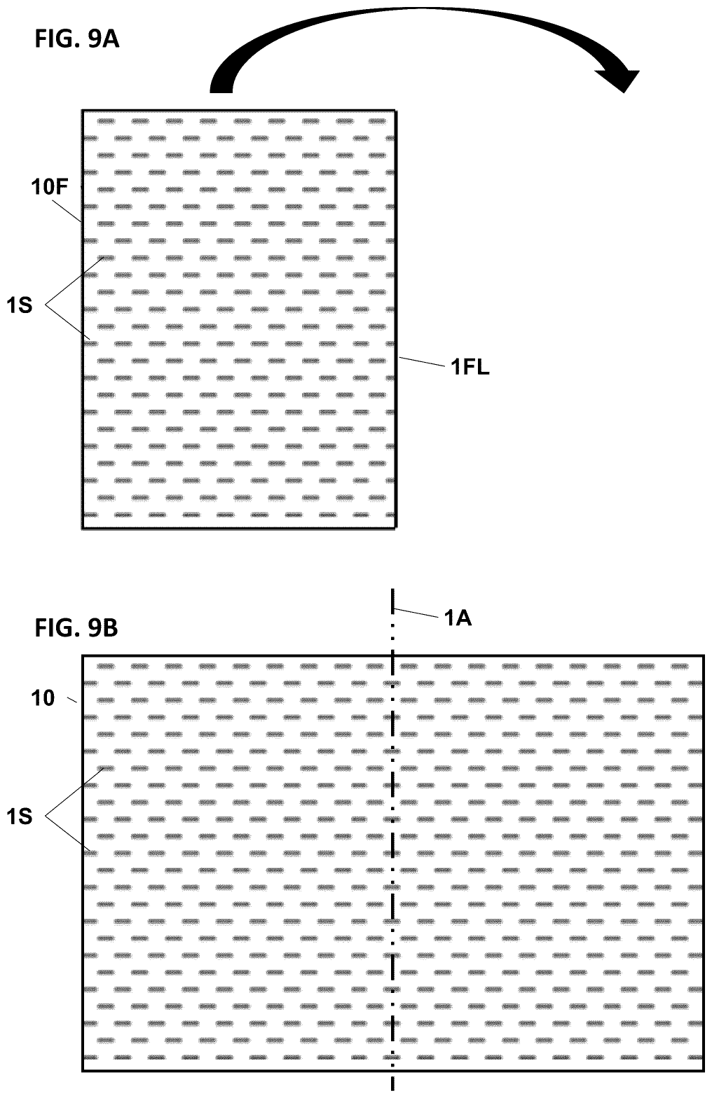

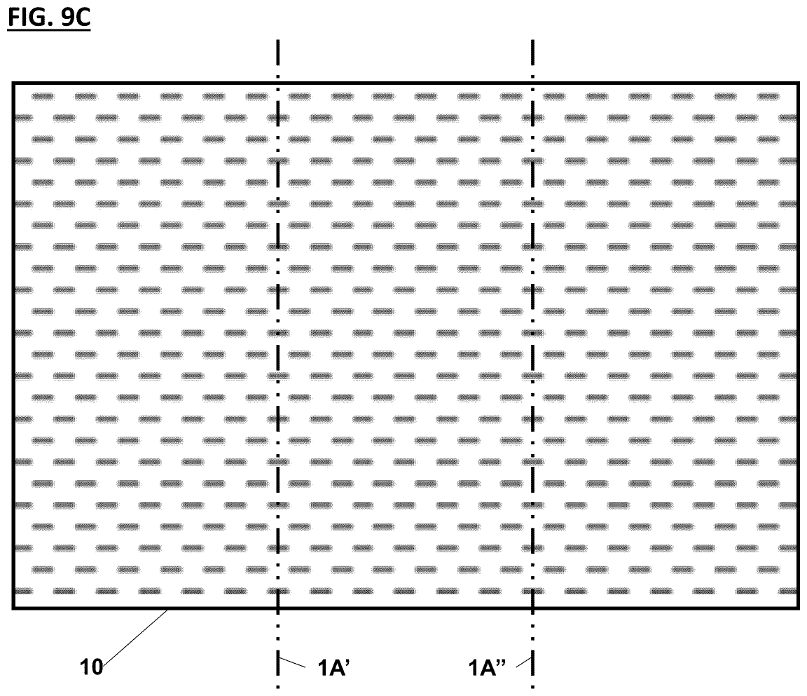

With reference to FIG. 9A, after the die 2 is used to create the slits within the folded-over two-layer sheet 1F, a folded-over two-layer slit sheet paper 10F is, thus, created which includes an array of slits 1S formed in each layer of the sheet, and with the sheet folded over at the seam line 1FL. Notably, the slits formed in the dual layers are aligned one above the other since a single blade passes through to create each individual slit.

In some embodiments, the folded-over two-layer slit sheet paper 10F can be maintained in a folded over state for later use. For example, in some embodiments, the folded-over two-layer slit sheet paper 10F can be cut into individual sheets that are stacked or otherwise arranged for later use. As another example, in some embodiments, the folded-over two-layer slit sheet paper 10F can be wound around a central cylindrical core or the like to create an expandable slit sheet paper roll having said folded-over two-layer slit sheet paper 10F in a folded state around the roll. In such illustrative embodiments, during use the folded-over two-layer slit sheet paper 10F can be expanded (e.g., by pulling the folded-over two-layer slit sheet paper 10F in a machine direction) while the layers are alongside one another, such that each layer expands concurrently. Among other things, such embodiments may create expanded slit sheet papers having some enhanced strength characteristics due to the dual layers of expandable slit sheet paper.

In some other embodiments, the folded-over two-layer slit sheet paper 10F can be unfolded by opening the folded-over two-layer slit sheet paper 10F around the seem line 1FL as shown by the curved black arrow in FIG. 9A, such that the folded-over two-layer slit sheet paper 10F is opened to an expandable slit sheet paper 10 shown in FIG. 9B in which the folded-over two-layer slit sheet paper 10F has been opened around the fold line 1A. In this manner, a wide expandable slit sheet paper sheet 10 can be efficiently, inexpensively, and effectively formed with a substantially narrower and less complicated cutting die 2.

As shown in FIG. 9B, in some preferred embodiments, the fold line 1A extends through a center of a space between two center-most slits at a top row of slits shown in the figure, and extends through a center of a center-most slit in the second row below the top row of slits, and continues in an alternating fashion through the expanded slit sheet paper 10. As a result, the center-most slits through which the fold line 1A passes are formed by slit halves from upper and lower layers of the folded-over two-layer sheet 1F shown in FIG. 9A. In this manner, the slit pattern on opposite sides of the fold line 1A are preferably substantially or entirely symmetrical on each side of the fold line 1A, and the slit pattern is substantially the same or the same across the entire unfolded expanded slit sheet paper 10.

Although FIGS. 8A, 8B and 9A, 9B show illustrative embodiments in which a folded-over two-layer sheet 1F is employed, in some alternative embodiments, a different multi-number of fold lines can be employed, such as, e.g., 2 or more fold lines such as to create a folded-over multi-layer sheet. For example, as shown in FIG. 9C, in some embodiments a folded-over three-layer sheet can be employed by folding over an initial paper sheet via two fold lines 1A′. In such embodiments, the fold lines 1A′ preferably pass centrally and symmetrically through the slits of the slit pattern similar to that describe above and as shown in FIG. 9C.

Although the more preferred embodiments shown in FIGS. 8A, 8B, 9A, 9B and 9C create folded-over multi-layer sheets in which each layer of the multi-layer sheets have the same or substantially the same width, in some alternative embodiments one or more layer can have a different width. For example, the fold lines do not need to be positioned to create layers having the same dimensions nor having the same or symmetrical slit patterns.

### Fold Formation:

In some preferred embodiments, an initially provided elongated web of paper having a substantially consistent width (such as, e.g., by way of example, a width of between about 25 to 55 inches, or, more preferably, a width of between about 35 to 45 inches, or, most preferably, a width of about 40 inches) can be folded over by the implementation of suitable paper guide plates and rollers to impart folding of the paper sheet.

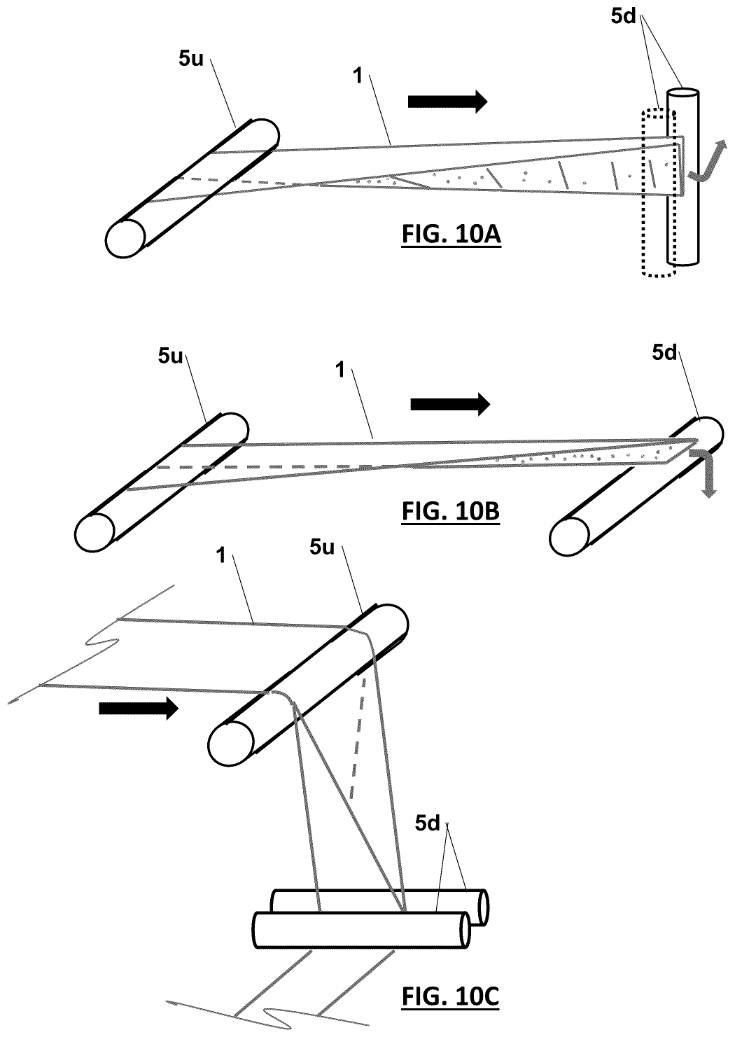

Towards that end, in some illustrative embodiments, as shown in FIG. 10A, an elongated paper web 1 can be conveyed over a first upstream roller 5u in a flat state along the periphery of the roller, folded over from both sides along a central fold line (see, e.g., dashed central line shown in FIG. 10A) to one or more downstream rollers 5d. In some embodiments, the folded paper web 1 can be directed around one downstream roller 5d so as to follow the contour of the downstream roller 5d in the direction of the arrow show at the right side of FIG. 10A.

On the other hand, in some other illustrative embodiments, as shown in FIG. 10B, an elongated paper web 1 can be conveyed over a first upstream roller 5u in a flat state along the periphery of the roller, folded over from one side along a central fold line (see, e.g., dashed central line shown in FIG. 10B) to one or more downstream rollers 5d (one shown). In some embodiments, the folded paper web 1 can be directed around the downstream roller 5d to follow the contour of the downstream roller 5d in the direction of the arrow show at the right side of FIG. 10B.

Additionally, in some illustrative embodiments, as shown in FIG. 10C, an elongated paper web 1 can be conveyed over a first upstream roller 5u in a flat state along the periphery of the roller, folded from both sides to a pair of downstream rollers 5d and redirected as shown in FIG. 10C.

Although not shown in FIGS. 10A-10C, in some embodiments, one or more guide plates can be presented along the path of the elongated paper web to facilitate directing of the paper web as shown in the figures. Towards that end, guide plates can be formed that extend parallel to top and/or bottom sides of the web along one or more portion of the web between the folded and unfolded states.

In the preferred embodiments, a sufficient distance should be provided to enable the paper to fold from a flat state to a fully folded state. As discussed in further detail below, in some of the most preferred embodiments of the present invention, an extensible paper is employed, such as, e.g., an of the extensible papers described herein below. Among other things, extensible papers can have great advantages and lead to the development of highly improved and advantageous expandable slit sheet papers.

### FURTHER DISCUSSIONS OF ILLUSTRATIVE EMBODIMENTS

As presented herein, in various embodiments of the present invention, systems and methods can be implemented that have substantial advantages over existing systems and methods.

For background reference, FIG. 11A is a schematic diagram showing longstanding background art for the formation of expandable slit sheet paper rolls. Among other things, the existing art leads to difficulties and complexities and high costs involved inhibiting the creation of expandable slit sheet papers with wider widths.

As shown in FIG. 11A, in the longstanding background art, as shown at Step A, a sheet of paper is initially formed through the original paper manufacturing process (e.g., an elongated paper web). As shown at Step B, the initial paper web is generally formed into a paper roll for handling and the like. As shown at Step C, in the longstanding background art, the paper roll is then unwound and fed to a slitting die for the formation of an expandable slit sheet paper. Then, as shown in Step D, the expandable slit sheet paper is formed into a roll of expandable slit sheet paper. As discussed above, the longstanding background art requires, among other things, a substantially larger, more costly, more complex and/or more expensive slitting die than that of embodiments of the present invention.

With reference to FIG. 11B, in some of the preferred embodiments of the present invention, as shown at Step A′, a sheet of paper is initially formed through the original paper manufacturing process (e.g., an elongated paper web). As shown at Step B′, the initial paper web is generally formed into a paper roll for handling and the like. As shown at Steps C′ and D′, in contrast to the background art, the paper roll is then unwound and folded prior to feeding to a slitting die. As a result, the paper can be fed to a substantially smaller, more economical, more efficiently and less complicated slitting die as shown in STEP E′ for the formation of an expandable slit sheet paper. Thereafter, a narrower folded-over multi-layer slit sheet paper product shown at Step F′ is achieved.

In some preferred embodiments, this novel folded-over multi-layer slit sheet paper product can be employed as a wrap or the like in its existing a folded-over state (such as, e.g., by forming the folded-over multi-layer slit sheet paper into a roll and mounting such a roll of folded-over multi-layer slit sheet paper product on a dispenser similarly to that shown in FIG. 1). Alternatively, in some embodiments, the folded-over multi-layer slit sheet paper product shown at Step F′ can be unfolded to a state similar to that shown in Step G′. Thereafter, the unfolded slit sheet paper product can be used as desired (e.g., whether separating into individual sheets or wrapping into a roll or the like). For example, as shown at Step H′, in some embodiments, the unfolded expandable slit sheet paper can be formed into a wide roll, which wide ride of expandable slit sheet paper can be used for various implementations, such as, e.g., for implementation in a wider dispenser of the type shown in, e.g., FIG. 1.

With reference to FIG. 11C, in some other preferred embodiments of the present invention which are generally similar to that shown in FIG. 11B, as shown at Step A″, a sheet of paper is initially formed through the original paper manufacturing process (e.g., an elongated paper web). As shown at Step B″, the initial paper web is generally formed into a paper roll for handling and the like. As shown at Steps C″ and D″, in contrast to the background art, the paper roll is then unwound and folded prior to feeding to a slitting die. As a result, the paper can be fed to a substantially smaller, more economical, more efficiently and less complicated slitting die for the formation of an expandable slit sheet paper. In the example shown in FIG. 11C, in some embodiments the folded-over multi-layer paper can then be wound into a roll to facilitate handling as shown at Step E″, if desired. Thereafter, as shown at Step F″ the roll can then be unwound and fed to a slitting die, as desired, to create a narrower folded-over multi-layer slit sheet paper product shown at Step G″.

In some preferred embodiments, this novel folded-over multi-layer slit sheet paper product can be employed as a wrap or the like in its existing a folded-over state (such as, e.g., by mounting such folded-over multi-layer slit sheet paper product on a dispenser similar to that shown in FIG. 1). Alternatively, in some embodiments, the folded-over multi-layer slit sheet paper product shown at Step G″ can be unfolded to a state similar to that shown in Step H″. Thereafter, the unfolded slit sheet paper product can be used as desired (e.g., whether separating into individual sheets or wrapping into a roll or the like). For example, as shown at Step I″, in some embodiments, the unfolded expandable slit sheet paper can be formed into a wide roll, which wide ride of expandable slit sheet paper can be used for various implementations, such as, e.g., for implementation in a wider dispenser of the type shown in, e.g., FIG. 1.

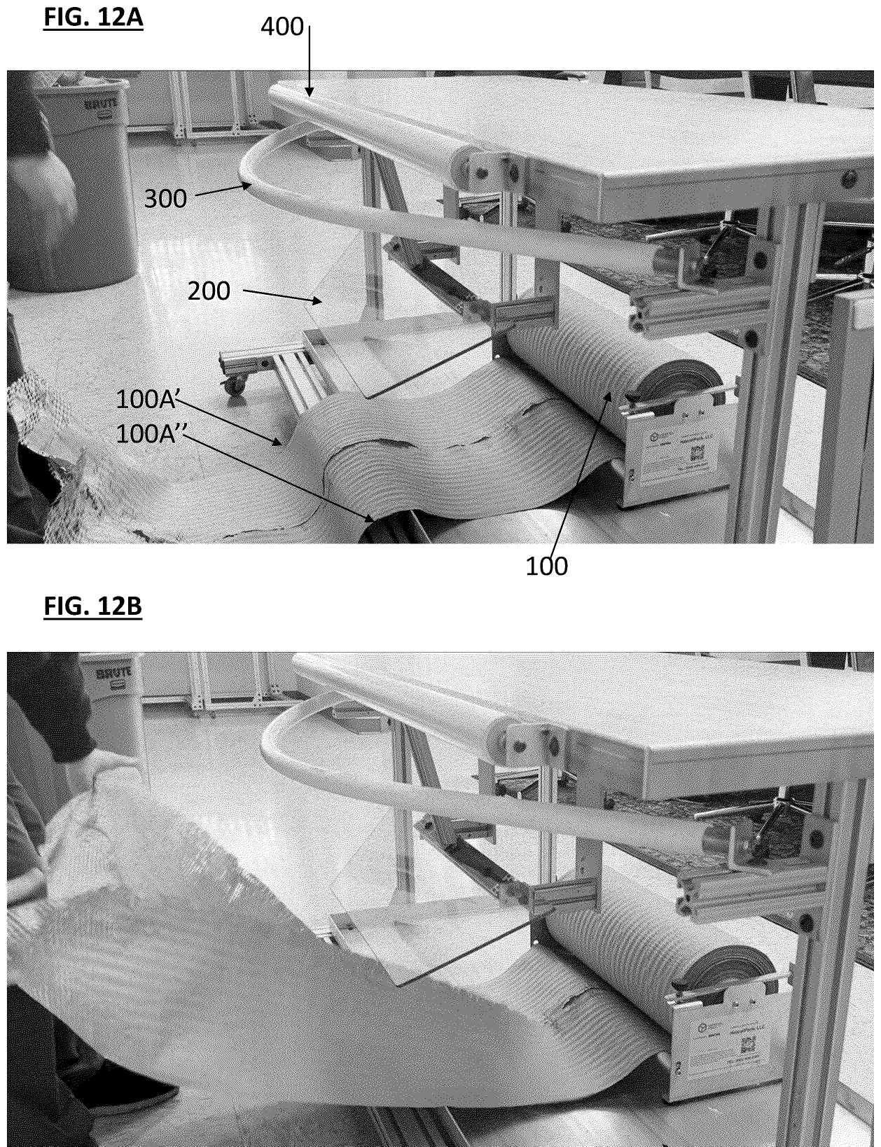

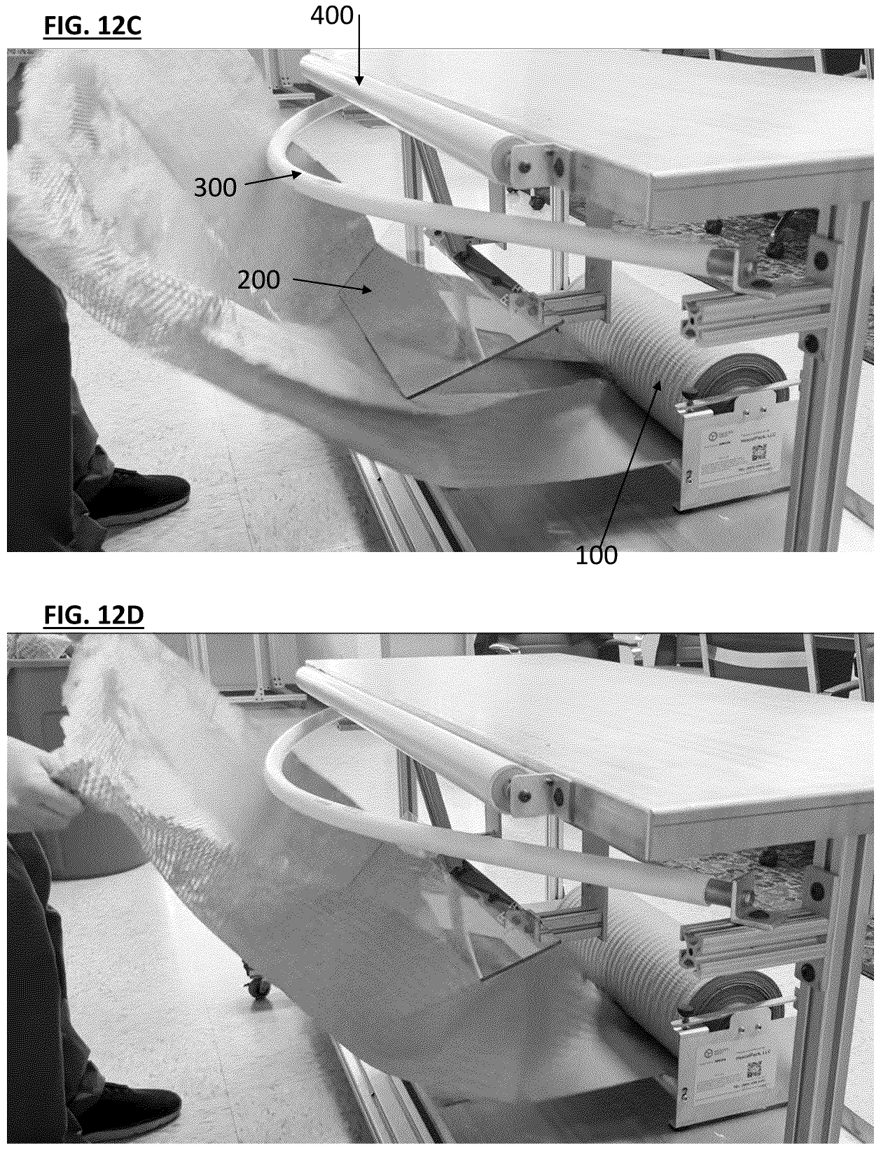

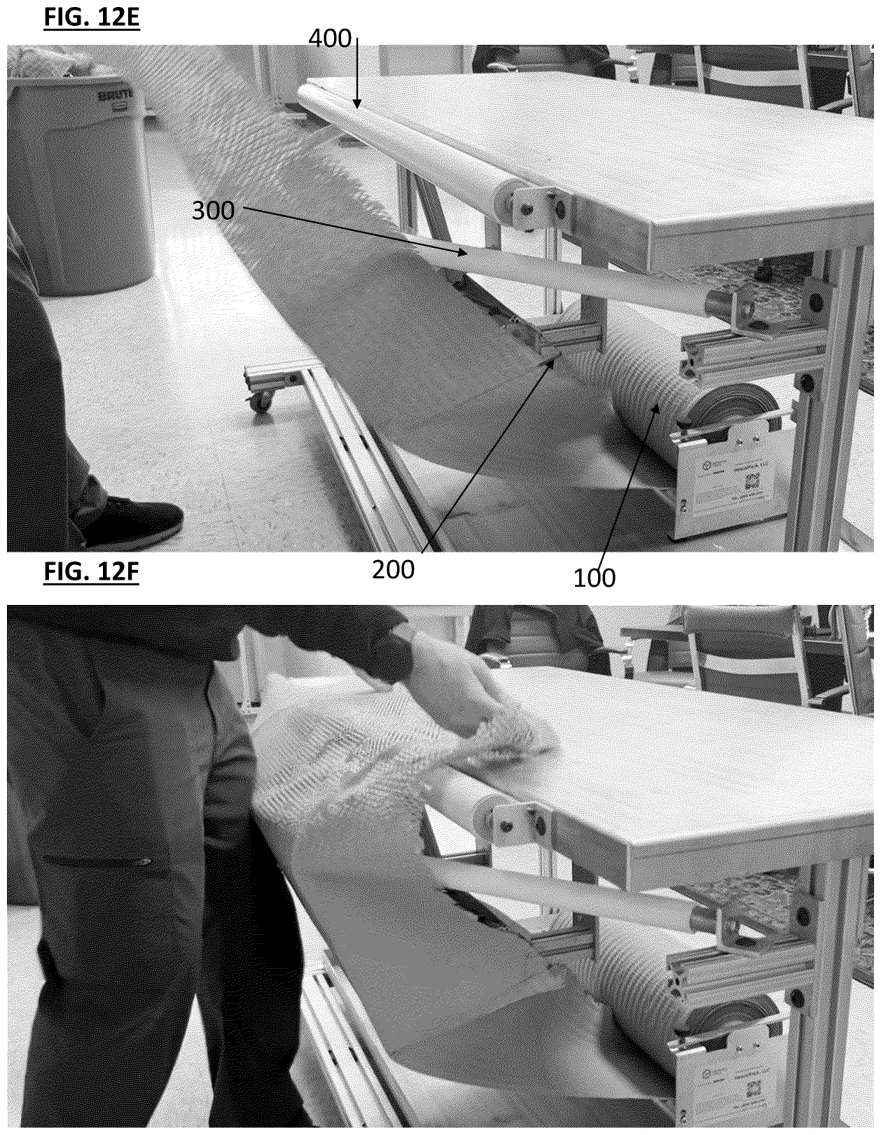

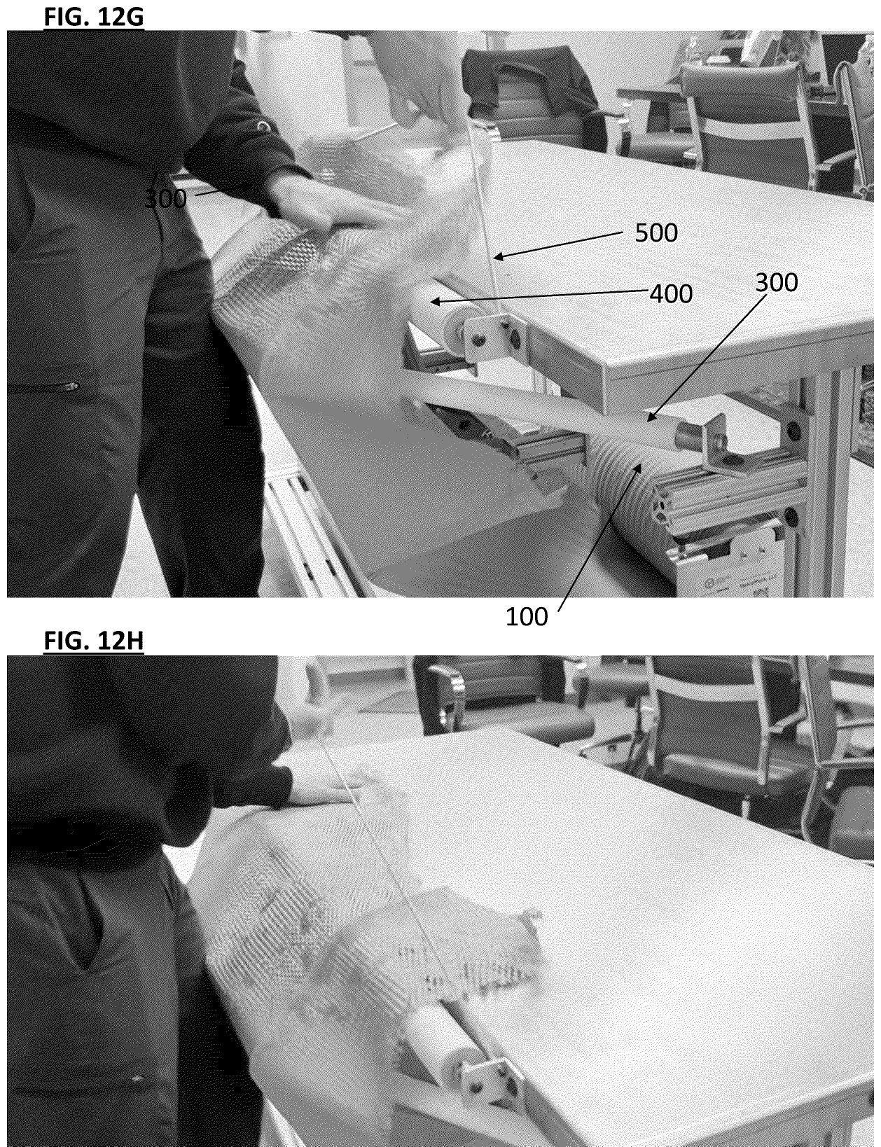

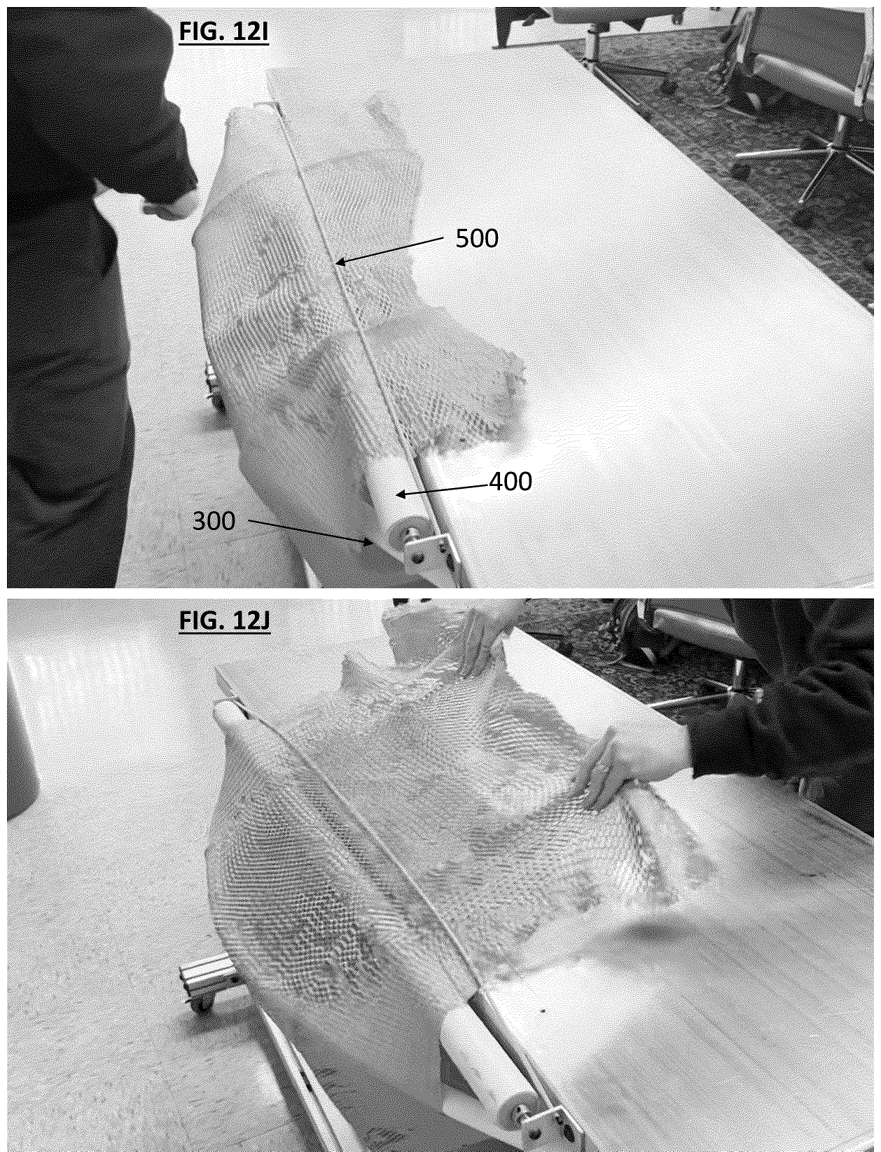

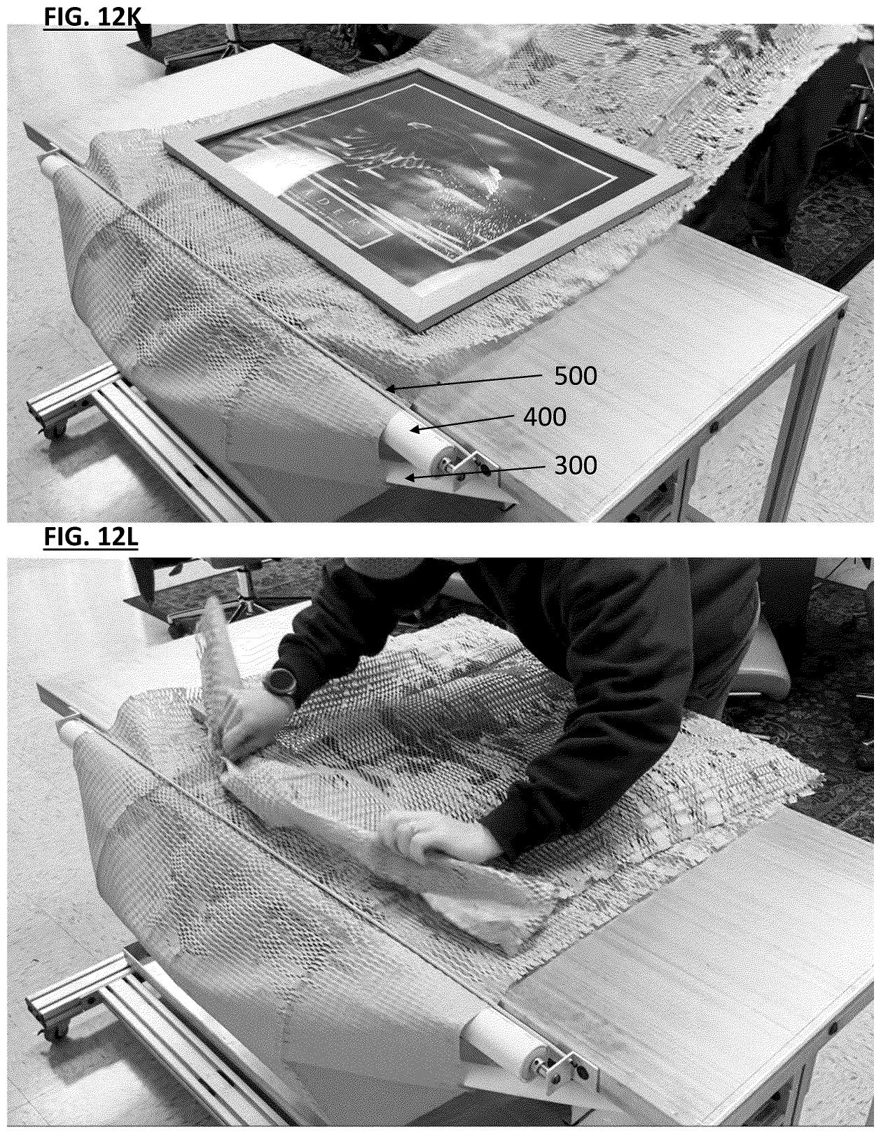

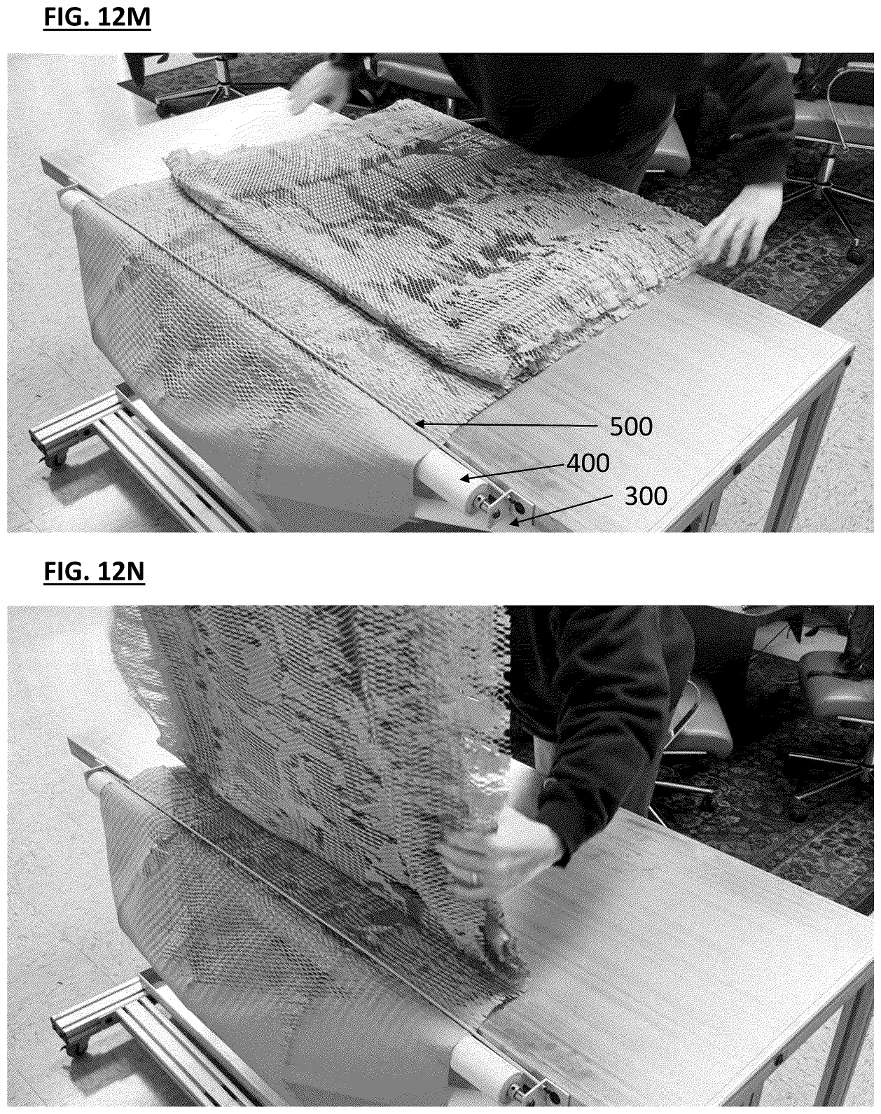

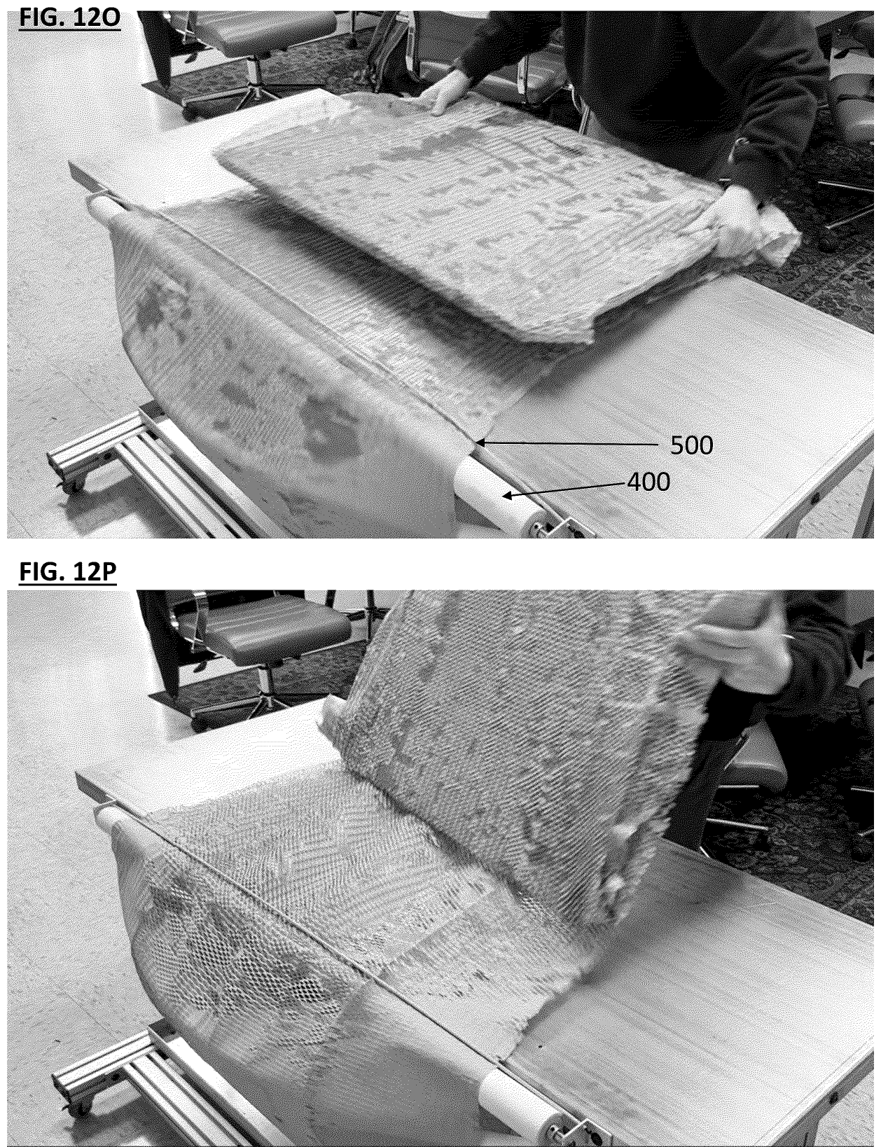

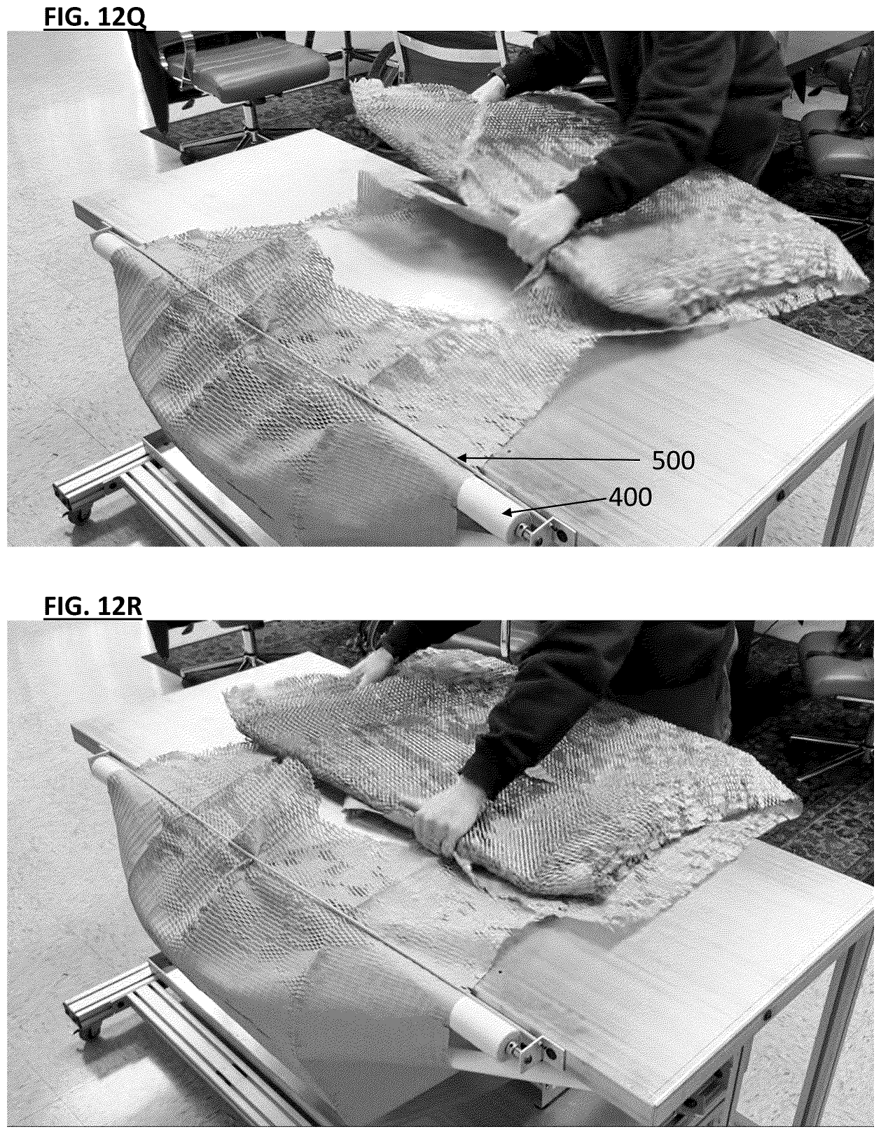

With reference to FIGS. 12A-12R, FIGS. 13A-13H and FIG. 14, these figures show another illustrative embodiment of the present invention involving dispensers for dispensing wide expandable slit sheet material. The embodiments shown in these figures are depicted to scale in some illustrative embodiments.

As shown in FIG. 12A, in the illustrated embodiment, a roll of expandable slit sheet paper 100 is rotatably supported on a holder as shown in the figure. In some embodiments, the holder can be made similarly to the holder of the dispenser shown in FIG. 1. Towards that end, in some embodiments, the holder can include a similar tensioning mechanism to that of the embodiment shown in FIG. 1. In some embodiments, the holder simply rotatably holds the roll of slit sheet paper without a tensioning mechanism like that of the embodiment shown in FIG. 1.

In the embodiment shown in FIG. 12A, the roll of slit sheet paper is folded similarly to the paper shown in FIG. 9C, such that the paper 100 is folded over at both sides 100A′ and 100A″ as shown. In the illustrated embodiment, the roll is supported on a table unit that includes a lower shelf supporting the roll of paper 100, and an upper table top as shown. In the illustrated embodiment, the system includes a guide member 200 that is arranged to help guide the paper, a curved bow member 300 that is arranged to further guide the paper, and a roller member 400 that is arranged to further guide the paper as shown in the figures and as further described below.

With respect to FIGS. 12A-12R, these figures show illustrative stepwise sequential steps in the process of using the system.

First, as shown in FIG. 12A, a roll of expandable slit sheet paper 100 is supported on the lower shelf and unwound to extend from the roll.

Next, as shown in FIGS. 12B-12D, the opposite sides of the paper are manually unfolded at the sides 100A′ and 100A″ to open the paper, and the paper is manually directed around the sides of the guide member 200.

Next, once the paper surrounds the guide member 200, as shown in FIGS. 12E-12F the user manually directs the paper around the curved bow member 300.

Next, as shown in FIGS. 12G-12I, the user manual directs the paper over the roller member 400, and under the elastic member 500. The elastic member 500 can be an elastic or flexible chord member, such as a bungee chord similar to that shown in the figures. In some implementations, the elastic member 500 can advantageously help retain the position of the expandable slit sheet paper on the device. For example, as shown in FIG. 121, the paper 100 is shown as retained without a user manually supporting the paper.

Next, as shown in FIG. 12J, a user can manually grasp the distal end of the expandable slit sheet paper such as to cause the paper to expand as shown. Towards this end, as shown, the expandable slit sheet paper is caused to begin expansion due to friction and resistance applied against the expandable slit sheet paper by the curved bow member 300.

Next, as shown in FIGS. 12K-12P, a user can wrap an item within the expanded expandable slit sheet paper as shown. In this illustrative embodiment, the item being wrapped is a picture within a picture frame. Notably, this device enables the wrapping of substantially larger items than possible in the background art. For example, in some embodiments, the width of the expandable slit sheet paper can be very large, such as, e.g., sizes described hereinabove. In some embodiments, the expandable slit sheet paper can have a width in a cross direction in an unexpanded state of 20 inches or more. In some embodiments, the expandable slit sheet paper can have a width in a cross direction in an unexpanded state of 30 inches or more. In some embodiments, the expandable slit sheet paper can have a width in a cross direction in an unexpanded state of 40 inches or more. In some embodiments, the expandable slit sheet paper can have a width in a cross direction in an unexpanded state of 50 inches or more. In some embodiments, the expandable slit sheet paper can have a width in a cross direction in an unexpanded state of 60 inches or more. In some embodiments, the expandable slit sheet paper can have a width in a cross direction in an unexpanded state of 70 inches or more. In some embodiments, the expandable slit sheet paper can have a width in a cross direction in an unexpanded state of 80 inches or more. In some embodiments, the expandable slit sheet paper can have a width in a cross direction in an unexpanded state of 100 inches or even more.

Next, as shown in FIGS. 12Q-12R, the user can separate the wrapped item as shown by ripping the paper. Thereafter, the user can place the wrapped item within a shipping package or box or otherwise place or store the wrapped item for shipping or storage.

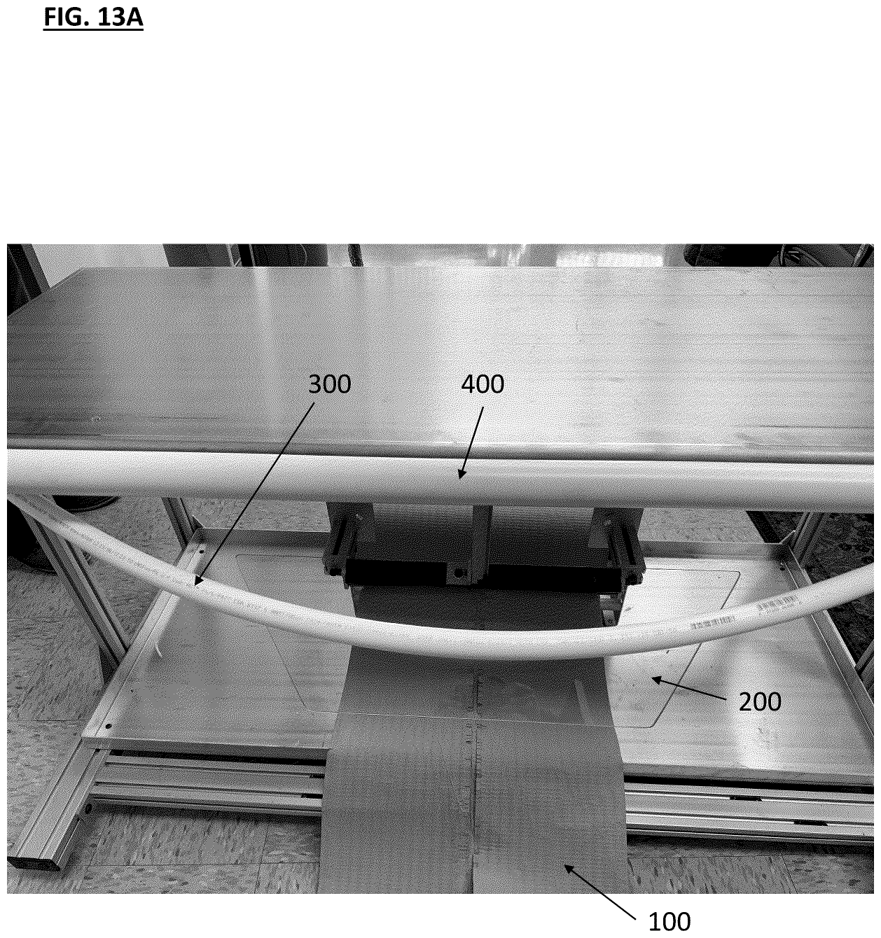

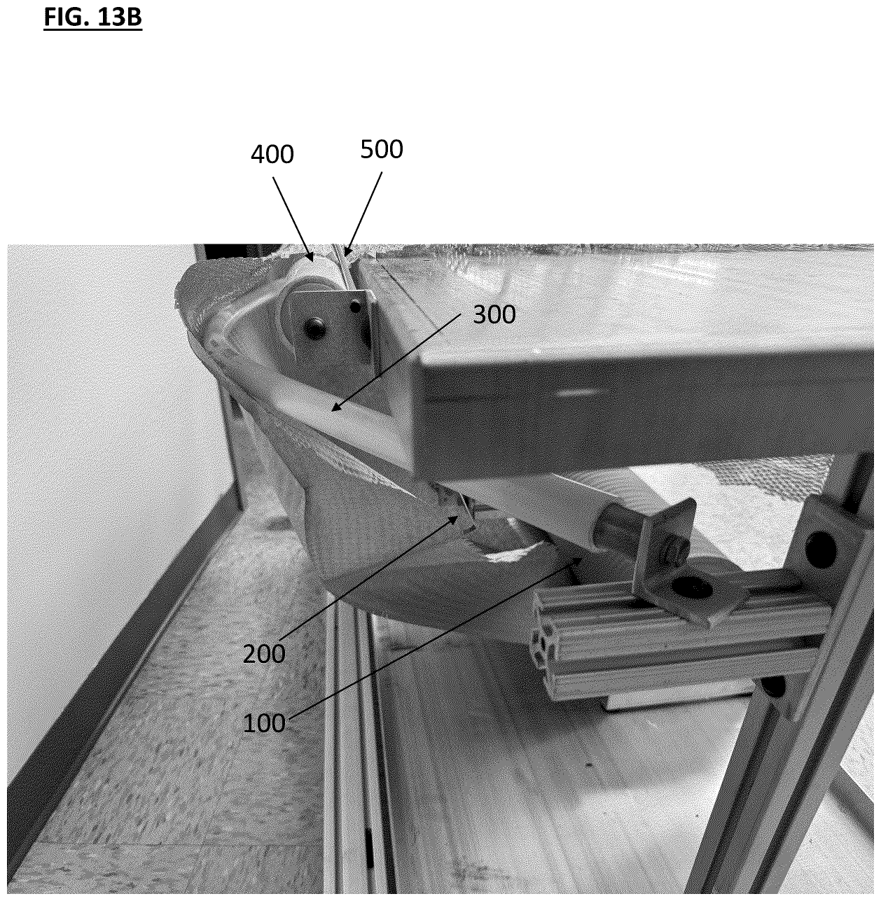

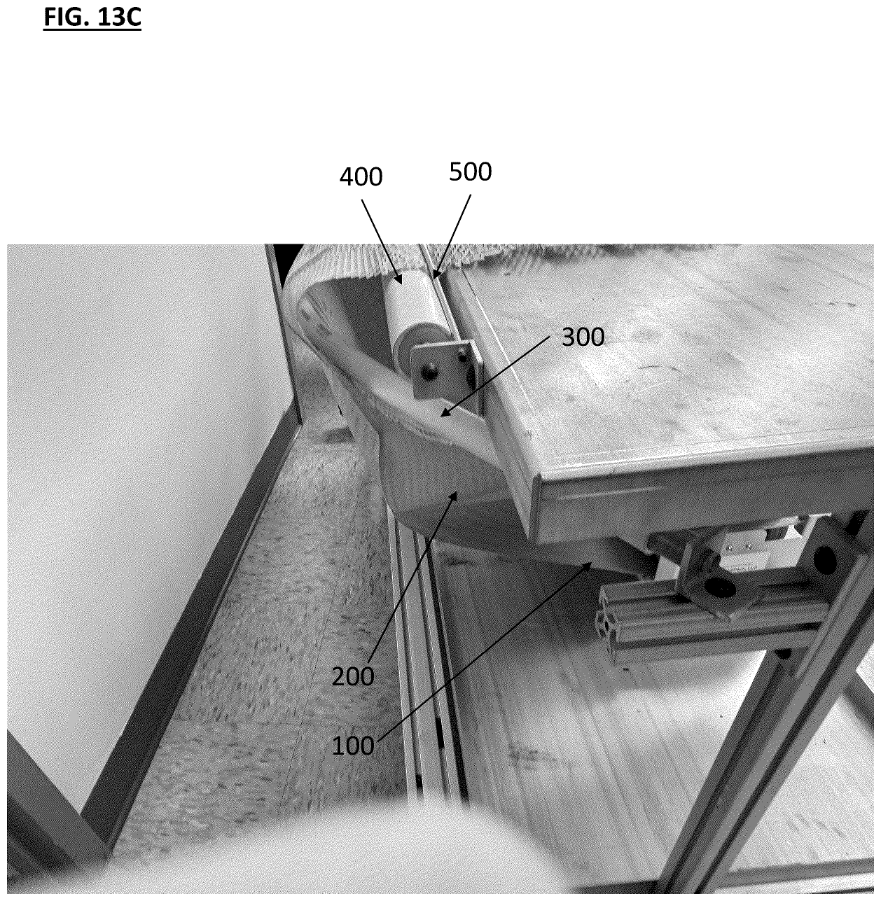

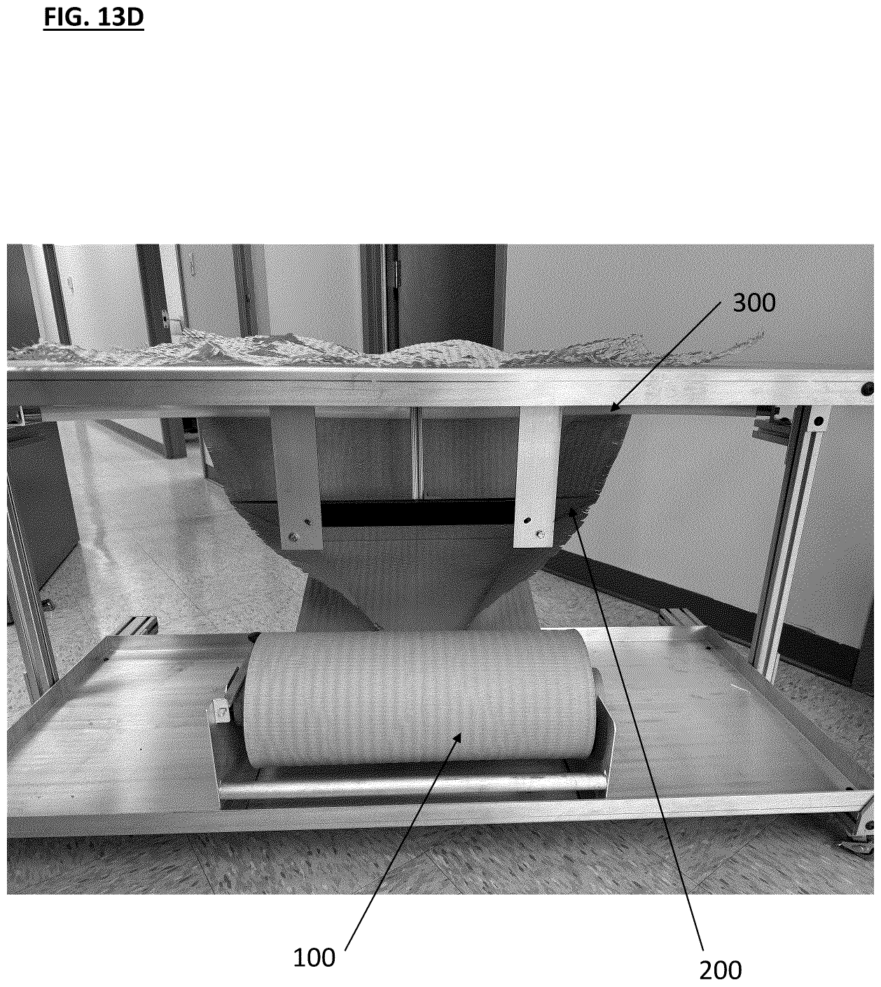

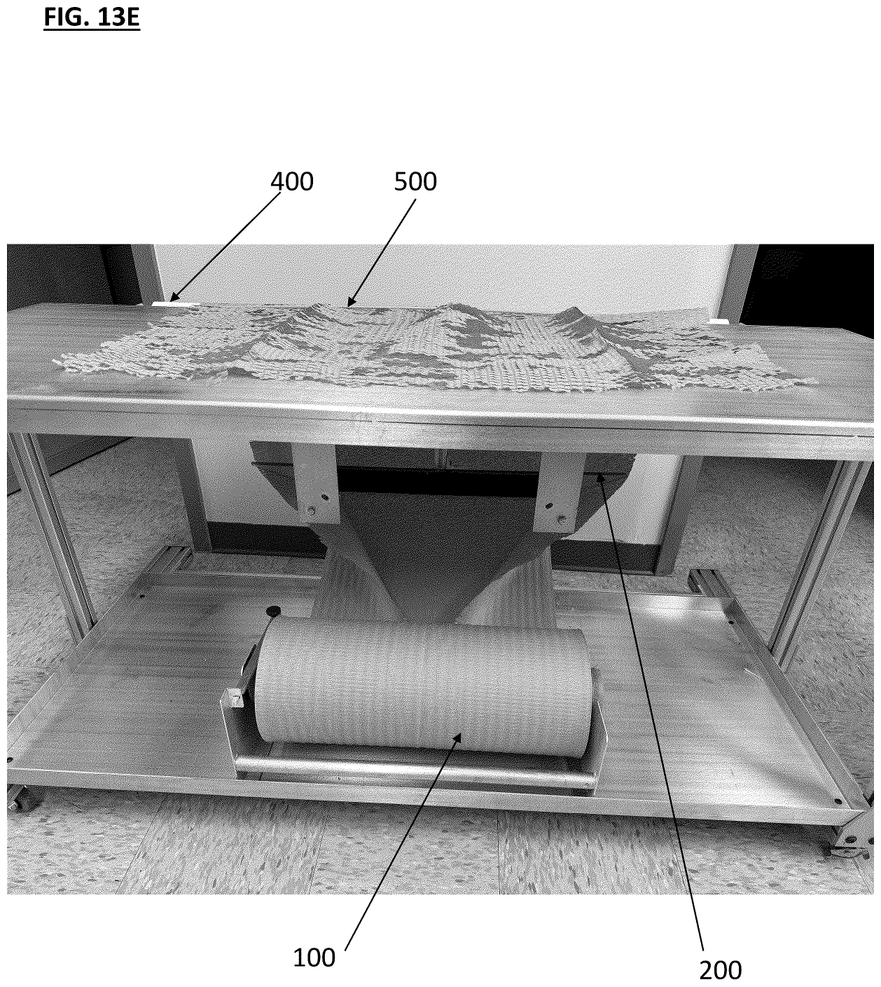

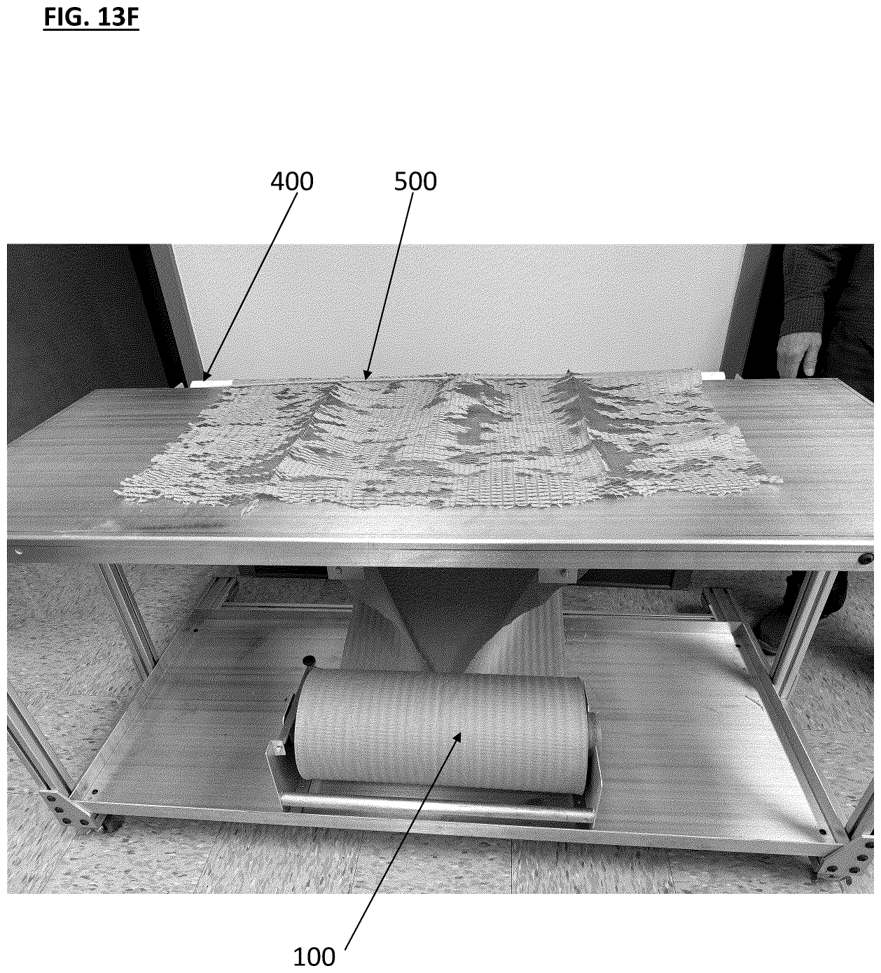

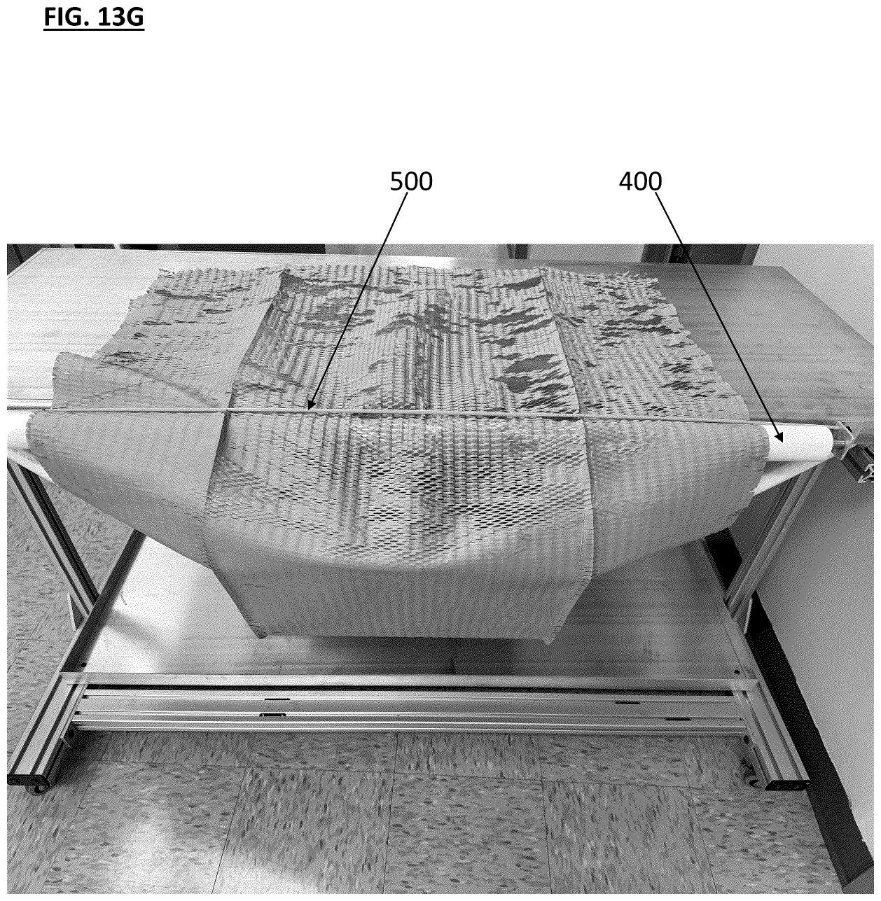

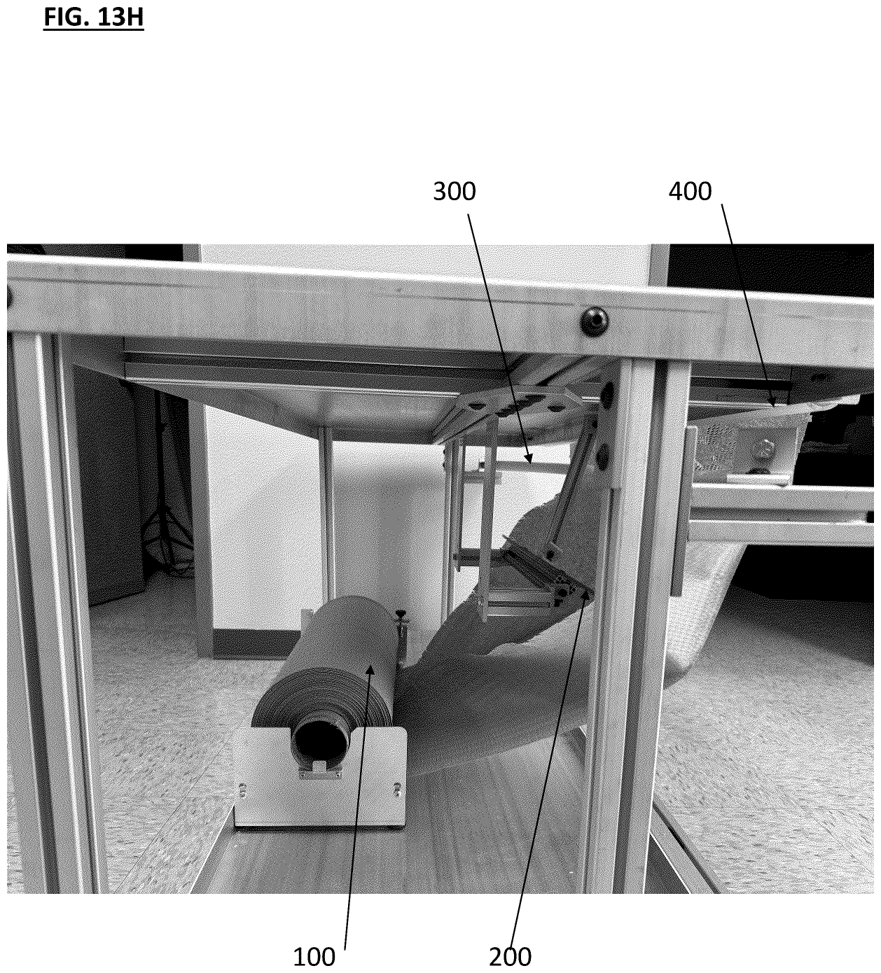

With references to FIGS. 13A-13H, these figures shown additional views of the embodiment shown in FIGS. 12A-12R for further reference.

With reference to FIG. 13A, as shown, the guide member 200 is preferably configured such as to present angled side edges arranged to facilitate opening of the folded sides of the expandable slit sheet paper once opened from the folded state shown in the figure and directed towards the guide member 200.

With reference to FIGS. 13B-13E, as shown, the paper is guided around the guide member 200 such that the angled sides help open the expandable slit sheet paper as it approaches the bow member.

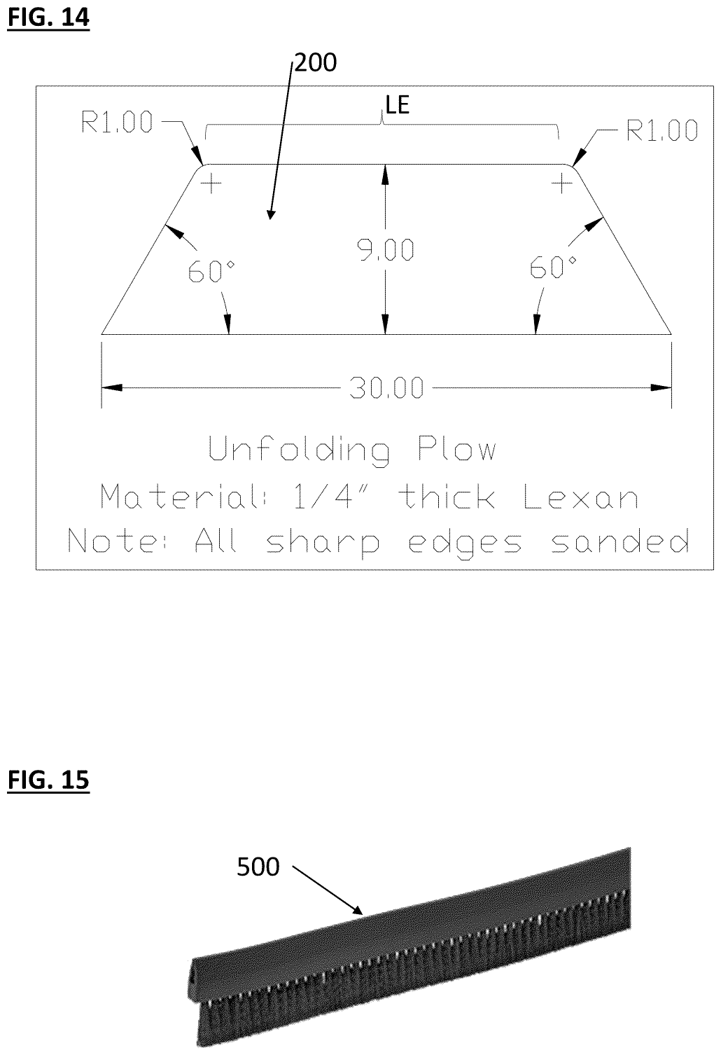

With reference to FIG. 14, this figure depicts an illustrative embodiment of the guide member 200. As shown, in this illustrative and non-limiting example, the guide member 200 is made of plastic (e.g., Lexan or other suitable material), and has a thickness of about ¼ inch. Additionally, in the illustrated embodiment, the distance across the guide member 200 is 30 inches, and the depth of the guide member is 9 inches, and the angle of each opposite edge is 60 degrees as shown. As also shown, the edges of the guide member 200 are made smooth by sanding or the like such as to allow the expandable slit sheet paper to freely slide along the surface of the guide member 200. In the illustrative and non-limiting embodiments shown in FIGS. 12A-14, the expandable slit sheet paper preferably has a width (of the expandable slit sheet paper in a non-expanded state in which the slits of the paper have not been expanded to form open cells and in a non-folded state in which the slit sheet paper has not be folded at a fold line) of about 40 inches, and the central region between the fold lines 100A′ and 100A″ is approximately 20-21 inches (i.e., slightly larger than ½ the width of 40 inches. Additionally, as shown in FIG. 14, the leading edge LE of the guide member 200 preferably has a length that is approximately equal to or smaller than the width of the central region between the fold lines 100A′ and 100A″, such that the guide member 200 readily receives the side regions as they unfold from the roll of expandable slit sheet paper.

In the illustrated embodiment, the roller member 400 can be rotatably supported on the table such that the expandable slit sheet paper freely moves over the roller member 400. In some embodiments, the roller member 400 does not rotate. In the preferred embodiments, the roller member 400 has a smooth outer surface. In some embodiments, the outer surface of the roller member 400 is made with a rubber or plastic coating that surrounds the periphery of the roller member 400. In some embodiments, the rubber or plastic coating imparts some friction to the expandable slit sheet paper.

In some embodiments, the bow member 300 has a smooth outer surface. In some embodiments, the outer surface of the bow member 300 is made with a rubber or plastic coating. In some embodiments, the rubber or plastic coating imparts some friction to the expandable slit sheet paper. In the preferred embodiments, the bow member is configured to apply frictional resistance to the expandable slit sheet paper whereby the expandable slit sheet paper expands when manually pulled relative to the bow member. In some illustrative embodiments, the bow member 300 can be made with any suitable material, such as any appropriate plastics or metal materials. In some embodiments, the bow member is made with PVC (polyvinyl chloride). In some embodiments, the bow member is made with aluminum. In the preferred embodiments, the outer perimeter surface of the bow member 300 is sufficiently hard such that the expandable slit sheet paper can readily slide over the surface of the bow shape member without tearing. Additionally, the outer perimeter surface of the bow member 300 also preferably imparts some friction to the expandable slit sheet paper to impart expansion to the expandable slit sheet paper as describe above. It should be appreciated, however, that in some embodiments, the bow member 300 only facilitates unfolding of the expandable slit sheet paper, and the expandable slit sheet paper can be expanded downstream of the bow member (such as, e.g., after the expandable slit sheet paper has been fully unfolded).

In some embodiments, the bow member 300 is made from a tubular member having a circular or substantially circular cross-sectional cross-section. In some embodiments, the cross-section has a diameter of between about ½ inch to 8 inches, or, more preferably, between about ¾ inch to 6 inches, or, more preferably, between about 1 inch to 4 inches, or, more preferably, between about 1¼ inch to 3 inches.

In some preferred embodiments, the bow member 300 has a generally constant radius of curvature. In some embodiments, the radius of curvature is substantially the same as that shown in the figures (such figures being to scale in some embodiments). In some embodiments, the radius of curvature can be plus or minus 10% or more from that shown in the figure. In some embodiments, the radius of curvature can be plus or minus 20% or more from that shown in the figure. In some embodiments, the radius of curvature can be plus or minus 30% or more from that shown in the figure. In some embodiments, the radius of curvature can be plus or minus 40% or more from that shown in the figure. In some embodiments, the radius of curvature can be plus or minus 50% or more from that shown in the figure. In some embodiments, the radius of curvature can be plus or minus 60% or more from that shown in the figure. In some embodiments, the radius of curvature can be plus or minus 80% or more from that shown in the figure. In some embodiments, the radius of curvature can be plus or minus 100% or more from that shown in the figure. In some embodiments, the radius of curvature can be plus or minus 125% or more from that shown in the figure. In some embodiments, the radius of curvature can be plus or minus 150% or more from that shown in the figure. In some embodiments, the radius of curvature can be plus or minus 200% or more from that shown in the figure. In some embodiments, the radius of curvature can be plus or minus 250% or more from that shown in the figure. In some embodiments, the radius of curvature can be plus or minus 300% or even more from that shown in the figure.

In other embodiments, the bow member can include a plurality of straight bar sections that are angled to one another. For example, in some embodiments, the bow member includes 3 bar members angled to one another. For example, in some embodiments, the bow member includes 4 bar members angled to one another. For example, in some embodiments, the bow member includes 5 bar members angled to one another. For example, in some embodiments, the bow member includes 6 bar members angled to one another. For example, in some embodiments, the bow member includes 7 bar members angled to one another. For example, in some embodiments, the bow member includes 8 or even more bar members angled to one another.

In some embodiments, the bow member does not have a substantially constant curvature along the length thereof.

In the preferred embodiments, the bow member helps to cause the expandable slit sheet paper to bias into an open or flat configuration as it is manually pulled by a user. In contrast, if the bow member 300 is made too straight or too flat, the expandable slit sheet paper may not readily achieve a wide and flat position similar to that shown in FIGS. 13E-13G (as a few examples).

As shown in FIGS. 12A-12G, in the preferred embodiments, the bow member 300 is mounted to the table in such a manner that the position of the bow member 300 in a horizontal direction relative to the surface of the table can be adjusted. For example, the ends of the bow members can include angle brackets that are movably mounted on arm members (as shown), wherein the relative positions of such angle brackets and arm members can be set by means of bolts or screws (as also shown). In this manner, in some embodiments, the position of the bow member can be adjusted, whereby adjusting friction applied to the expandable slit sheet paper due to, e.g., relative angles and positions between the guide member 200, the bow member 300, and the roller member 400.

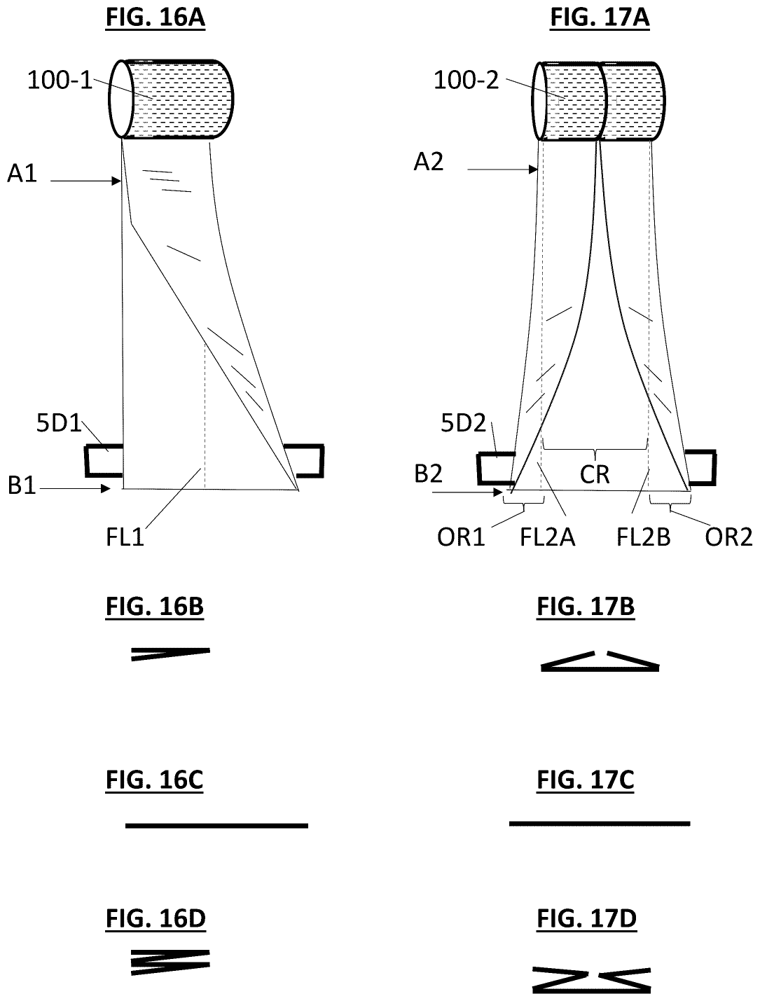

With reference to FIGS. 16A-16D and 17A-17D, these figures depict additional illustrative embodiments of dispensers for dispensing wide expandable slit sheet paper.

In the embodiment shown in FIGS. 16A-16D, a roll of expandable slit sheet material 100-1 is formed by forming a roll from a sheet of slitted paper that has been folded similarly to that shown in step F′ of FIG. 11B or step G″ of FIG. 11C.

In the embodiment shown in FIGS. 17A-17D, a roll of expandable slit sheet material 100-1 is formed by forming a roll from a sheet of slitted paper that has been folded similarly to that shown in the embodiments shown in FIGS. 12A to 14, in which opposite sides of the expandable slit sheet paper are folded over fold lines similarly to that shown in FIG. 9C (except that the total width of the two outer sides that are folded over the central region are less than or equal to the total width of the center region such that when folded over the central region the two outer sides do not overlap one another but, rather, rest upon or over the central region as described below in reference to FIG. 17B.

In the illustrative embodiment shown in FIG. 16A, the roll of expandable slit sheet paper 100-1 is mounted on a holder, such as, e.g., the holder shown in FIG. 1 or the holder shown in FIGS. 12A to 13H, which holder can be made of any suitable material such as, e.g., wood, cardboard, metal or other suitable material and is configured for rotatably supporting the roll of expandable slit sheet paper. In the embodiment shown in FIG. 16A, a user preferably manually grasps the distal end of the expandable slit sheet paper and directs the expandable slit sheet paper towards one or more downstream roller 5D1. Although not shown in FIG. 16A, in some embodiments, one or more guide member, such as, e.g., one or more guide plate can be positioned along the length of the expandable slit sheet paper after it separates from the perimeter of the roll of expandable slit sheet paper 100-1 to direct the expandable slit sheet paper from the folded state (as shown, e.g., at the position A1 in FIG. 16A) to an unfolded state (as shown at the position B1 in FIG. 16A).

Although the embodiments shown in FIGS. 16A-16D and 17A-17D can be implemented as manual dispensers in which a user manually grasps a distal end of the expandable slit sheet paper for expansion and dispensing, in various embodiments, the dispenser can be an automated dispenser that automatically dispenses the expandable slit sheet paper. By way of example, in some embodiments, one or more downstream roller (e.g., rollers 5D1 shown in FIG. 16A or rollers 5D2 shown in FIG. 17A) can be driven via a motor or the like and can include a frictional surface (such as, e.g., hooks for engaging the slit sheet paper) to facilitate automated pulling of the expandable slit sheet paper. In various embodiments, dispensers for dispensing the wide slit sheet material can include features similar to that shown in any of the following U.S. Patents and U.S. Patent Publications, the entire disclosures of which are incorporated herein by reference: (1) U.S. Pat. No. 11,220,395, (2) U.S. Pat. No. 11,608,222, (3) U.S. Pat. No. 11,479,009, (4) U.S. Pat. No. 11,691,374, and (5) U.S. Patent Publication No. 2021/0315426.

With respect to the embodiment shown in FIG. 16A, the expandable slit sheet paper extending from the roll of expandable slit sheet paper 100-1 is initially in a folded state in which the expandable slit sheet paper is folded over at a fold line FL1. FIG. 16B shows an illustrative cross-sectional view of the expandable slit sheet paper of FIG. 16A from the position of the arrow A1 shown in FIG. 16A (i.e., at an illustrative position in which the expandable slit sheet paper is in the initial state of unfolding from a layered position in which both half regions of the folded slit sheet paper rest against one another). As shown in FIG. 16B, between the position of the arrow A1 to the position of the arrow B1 shown in FIG. 16A, the expandable slit sheet paper unfolds to a fully open state at the position of the arrow B1. Towards that end, FIG. 16C shows an illustrative cross-sectional view of the expandable slit sheet paper of FIG. 16A from the position of the arrow B1 shown in FIG. 16A (i.e., at an illustrative position in which the expandable slit sheet paper is in the unfolded state of in which both half regions of the sheet paper are unfolded outwardly so as to extend substantially along the same plane).

FIG. 16D shows an alternative variation of the embodiment shown in FIGS. 16A-16C. In particular, in the embodiment shown in FIG. 16D, the expandable slit sheet paper is folded over at a single fold line FL1. In the embodiment shown in FIG. 16D, the expandable slit sheet paper is folded over at three fold lines. In various other embodiments, the expandable slit sheet paper can be folded at two fold lines. In various other embodiments, the expandable slit sheet paper can be folded at four fold lines, or at five fold lines, or at six or more fold lines.

With respect to the embodiment shown in FIG. 17A, the expandable slit sheet paper extending from the roll of expandable slit sheet paper 100-2 is initially in a folded state in which the expandable slit sheet paper is folded over at two fold lines FL2A and FL2B. FIG. 17B shows an illustrative cross-sectional view of the expandable slit sheet paper of FIG. 17A from the position of the arrow A2 shown in FIG. 17A (i.e., at an illustrative position in which the expandable slit sheet paper is in the initial state of unfolding from a layered position in which both outer side regions OR1, OR2 of the folded slit sheet paper rest against a wider central region CR). As shown in FIG. 17B, between the position of the arrow A2 to the position of the arrow B2 shown in FIG. 17A, the expandable slit sheet paper unfolds to a fully open state at the position of the arrow B2. Towards that end, FIG. 17C shows an illustrative cross-sectional view of the expandable slit sheet paper of FIG. 17A from the position of the arrow B2 shown in FIG. 17A (i.e., at an illustrative position in which the expandable slit sheet paper is in the unfolded state of in which both outer regions OR1, OR2 of the sheet paper are unfolded outwardly so as to extend substantially along the same plane as the central region CR).

FIG. 17D shows an alternative variation of the embodiment shown in FIGS. 17A-17C. In particular, in the embodiment shown in FIG. 17A, the expandable slit sheet paper is folded over at two fold lines FL2A and FL2B. In contrast, in the embodiment shown in FIG. 17D, the expandable slit sheet paper is folded over at fourfold lines. In various other embodiments, the expandable slit sheet paper can be folded at different numbers of fold lines. Additionally, in various other embodiments, the expandable slit sheet paper can be folded at different numbers of fold lines at each side of the expandable slit sheet paper (such as, by way of example, at one fold line similar to that shown at one side of FIG. 17B along one side and at two fold lines similar to that shown at one side of FIG. 17D along the other side).

In the embodiments shown in FIGS. 12A-14 and FIGS. 17A-17D, the outer side regions OR1, OR2 are substantially narrower than the central region CR. In that manner, unfolding of the outer side regions OR1, OR2 from the central region CR can be facilitated.

In some illustrative examples, the of the embodiments shown in FIGS. 12A-14 and FIGS. 17A-17D, the outer side regions OR1, OR2 can be about ½ the width or less than the width of the central region CR such that when the outer side regions OR1, OR2 are folded over to a state similar to that shown in, e.g., FIG. 12A or FIG. 17B, the outer side regions OR1, OR2 rest upon the central region CR without overlapping the other side region. In that manner, despite having two fold lines, the folded expandable slit sheet paper shown in FIGS. 12A and 17B create no more than two layers across the width of the folded expandable slit sheet paper.

As described herein-above, in some illustrative and non-limiting examples, the embodiments shown in FIGS. 12A-14 can include guide members, such as, e.g., guide plates

In some variations of the foregoing embodiments shown in, e.g., FIGS. 12A to 14, FIGS. 16A-16D, and FIGS. 17A-17D, in order to effect or facilitate expansion of the expandable slit sheet paper, one or more brush and/or other friction member can be employed. For example, in some embodiments, the brush 600 shown in FIG. 15 is mounted over the upper surface of the table such that the expandable slit sheet paper is frictionally pressed between the distal ends of the bristles of the brush 600 and an upper surface of the table, whereby when the expandable slit sheet paper is manually pulled by a user, friction imparted by the brush 600 causes the expandable slit sheet paper to expand. In various embodiments, any of the brushes described in U.S. Patent Application Ser. No. 63/448,335, filed Feb. 26, 2023, can be employed.

In some preferred embodiments, the at least one brush or friction member includes at least one flexible brush. In some of the preferred embodiments, the at least one flexible brush is a brush having a plurality of elongated flexible bristles, filaments, wires or other elongated flexible elements. In some preferred embodiments, the flexible brush includes a plurality of elongated flexible elements wherein each elongated flexible element is made of a flexible plastic or polymer, of a flexible metal, of a flexible natural fiber or element, and/or other elongated flexible elements. In some illustrative embodiments, a brush can include bristles made of one or more of aluminum, brass, bronze, copper, steel, stainless steel, plastic, PVC, nylon, synthetic or polymeric fibers, Kevlar™, foam (e.g., polypropylene foam), animal hair (e.g., horse hair, goat hair, etc.), plant fibers (e.g., Ixtle, Tampico fiber, etc.). In some embodiments, bristles can be elongated members with a substantially consistent diameter or width along a length thereof or can have a relatively varied diameter or width along a length thereof. In some embodiments, bristles can have a generally rounded peripheral surface, a generally cylindrical peripheral surface, a generally polygonal (e.g., square, hexagonal, etc.) peripheral surface, an irregular peripheral surface, etc. In some embodiments, the shapes of the bristles can be relatively consistent along lengths thereof, while in some embodiments, the shapes of the bristles can vary along the lengths thereof. In preferred embodiments, the bristles have a substantially consistent structure along the lengths thereof for consistency in qualities, such as, e.g., stiffness and flexibility.

In some illustrative embodiments, bristles can be between about ½ inch to 4 inches long, or, in some preferred embodiments, between about ¾ inch to 3½ inches long, or, in some preferred embodiments, between about 1 inch to 3 inches long, or, in some preferred embodiments, between about 1½ inches to 2½ inches long.

In some illustrative embodiments, bristles can be employed having a width or diameter of less than about 0.2 inches, or, in some preferred embodiments, less than about 0.1 inches, or, in some preferred embodiments, less than about 0.05 inches, or, in some preferred embodiments, less than about 0.04 inches, or, in some preferred embodiments, less than about 0.03 inches, or, in some preferred embodiments, less than about 0.02 inches. In some illustrative embodiments, bristles can have a diameter of between about 0.005 to 0.05 inches, or, in some preferred embodiments, between about 0.0075 to 0.025 inches, or, in some preferred embodiments, between about 0.01 to 0.02 inches.

In some other alternative embodiments, the flexible member or flexible brush can include other types of flexible members, such as, e.g., an elastomeric member, a flexible rubber member, a flexible plastic or polymeric member, a flexible metal member, a flexible sponge and/or another flexible member. In preferred embodiments, the flexible member includes a plurality of independently flexible or substantially independently flexible portions proximate a distal end (e.g., a distal end that is situated to contact the expandable slit sheet paper). In some preferred embodiments, such independently flexible or substantially independently flexible portions contact a single cell in a widthwise direction (e.g., cross direction) across the expandable slit sheet paper, such that forces imparted from a single cell during opening is substantially imparted to such independently flexible or substantially independently flexible portions. For example, in a brush containing flexible bristles or wires, each such flexible bristle or wire is independently flexible or substantially independently flexible. It should be appreciated that in a brush containing numerous bristles, such bristles would not be entirely independently flexibly movable due to their close proximity, such that bristles would necessarily press against one another during use. For example, in some embodiments, a flexible member can include a flexible member, such as, e.g., a flexible rubber member, a flexible plastic or polymeric member, a flexible metal member, or a flexible sponge member having a distal end with depending regions, such as, e.g., depending nubs, or tines, or arms, or elements. In some embodiments, the flexible member can be a flexible rake, with substantially independently movable tines.

In some illustrative and non-limiting embodiments, brushes employed can include brushes made by McMaster-Carr™ (https://www.mcmaster.com/catalog/129/1550/). By way of example, in some embodiments, as described at the above URL, brushes can include dense bristles that can be held in place by a binding wire. The larger the bristle diameter, the stiffer the bristles. Additionally, the shorter the bristle length, the less lateral flexibility at the distal ends of the bristles.

### Novel and Advantageous Uses and Methods

In some preferred implementations, embodiments of the present invention can achieve highly novel and advantageous uses and methods having substantial benefits and advantages not previously achievable nor contemplated.

For example, with the wider wrap in accordance with various embodiments described herein, larger items can be readily wrapped without the need to make multiple orbits around the periphery of the larger item to encircle the entire periphery of the larger item. For example, the large picture frame shown in FIG. 20 can be entirely wrapped with a single revolution, rather than requiring a narrower wrap to make multiple revolutions around the larger item. Accordingly, items with dimensions larger than the width of prior wraps (e.g., larger than 15 inches or larger than 20 inches) can be readily wrapped in a manner achieving greater stability of the wrap (e.g., reducing situations in which the wrap may slide relative to the item being wrapped), and greater speed (e.g., reducing the required number of revolutions or orbits around an item during wrapping can greatly increase speed for wrapping), and other advantages and benefits.

Additionally, with the wider wrap in accordance with various embodiments described herein, wrapping of pallets can be greatly enhanced, achieving benefits and advantages as described above, along with achieving substantial structural advantages and higher stability of wrapped pallets.

### Extensible Papers Employed in Some Preferred Embodiments

As discussed above, in some of the most preferred embodiments of the present invention, an extensible paper is employed, such as, e.g., an of the extensible papers described herein below. Among other things, extensible papers can have great advantages and lead to the development of highly improved and advantageous expandable slit sheet papers.

Additionally, by employing an extensible slit sheet paper, the extensible qualities of the paper can facilitate folding of an elongated paper web as described herein above. Among other things, such an extensible paper can advantageously enable the paper web to be folded within a shortened distance between flat and folded states (such as, e.g., between flat and folded states shown in the examples of FIGS. 10A-10C).

In some most preferred embodiments, extensible papers as set forth in the above-referenced U.S. Pat. No. 10,669,086 are employed. Towards that end, the following paragraphs (in quotations) under this section, quoted from the '086 patent, set forth details of extensible papers according to some preferred embodiments that can be employed in preferred embodiments of the present invention.

“For the purposes of the present invention, the term “extensible” as applied to paper sheets, means a paper sheet that is able to stretch in a longitudinal direction of the paper sheet upon applying a force in the longitudinal direction of the paper sheet. Illustrative extensible sheets are disclosed in U.S. Pat. No. 3,908,071, U.S. patent application Ser. No. 14/901,997 (U.S. Pat. No. 9,945,077), International Application No. WO 1984002936, U.S. Publication Nos. 2002/0060034, 2007/0240841 (U.S. Pat. No. 7,918,966), and U.S. Pat. Nos. 3,104,197, 3,220,116, 3,266,972, 3,269,393, 3,908,071, 6,024,832, 6,458,447, and 6,712,930, the entire disclosures of which are incorporated by reference herein, as though recited in full. It should be understood that the stretching of an extensible paper is measured in an unslit sheet of paper (i.e., the %'s of extensibility or ranges or extents of extensibility defined herein are based on unslit paper). As disclosed in U.S. Pat. No. 3,266,972, the test and characterization procedures employed in measuring elongation (extensibility) properties can be in accordance with standard TAPPI test Elongation T457. In addition, as disclosed in U.S. Pat. No. 3,266,972, the expression “extensible papers” means a paper having an increasable elongation in the machine direction as compared to standard, non-extensible Kraft paper.”

“In some preferred embodiments, extensible paper can be produced by varying the accumulation of paper fibers by essentially slowing the paper feeding process during the drying method to trap extra fibers that make the paper appear to have microscopically sized rows of paper that you would see if one were to pleat the paper. The difference is that extensible paper's microscopic rows are adhered to each other through the use of binders and other types of adhesives in conjunction with the drying process. Reference is made to patent U.S. Application No. 2007/0240841 (U.S. Pat. No. 7,918,966) where the purpose is to create a non-creped extensible paper that does not easily disconnect from itself. In addition, the surface of the extensible paper is still fairly flat.”

“In the preferred embodiments of the present invention, the extensible paper that is employed has low extensible properties as compared to other types of extensible papers. In this regard, an optimal extensible paper enables a smooth transition from an unexpanded to the expanded slit sheet by providing a small amount of stretching at the very start of expansion of the extensible slit sheet paper material.”

“In some exemplary constructions, during expansion of a slit sheet, the force required to initiate expansion is substantially higher than the force required to continue expansion. For example, once the paper initially starts to bend at the slits, the expansion continues more easily during continued bending at the slits. The force required to continue the expansion of the slit sheet during this continued bending is dramatically reduced beyond the above-noted initial expansion. In some preferred embodiments, the extensible slit sheet paper substantially reduces the force required to initiate expansion. On the other hand, in some preferred embodiments, during the above-noted continued expansion, the extensible paper does not substantially stretch simultaneously with the process of expanding the slit sheet paper; otherwise, the expanded sheet might not optimally be made into a cushioning wrap.”

“It should be noted that in this application, all theories related to functioning of the invention are provided to facilitate appreciation of concepts of the invention, rather than by way of limitation. Extensible paper, as designed, stretches as part of an increase in paper strength. In some embodiments, the functioning of the invention involves that the extensible slit sheet paper substantially utilizes the extensible property to ease the rotating the cells into the stretched shape and to resist tearing of the slit sheet during the expansion step. This means that at the initial point at which the cell rotates (i.e., initiating rotation between legs 38a and 38b on each side of the slit and land 20) the extensible slit sheet paper is substantially enhanced by the extensible paper's ability to stretch. In some embodiments, the functioning of the invention, thus, involves that extensible papers' properties are substantially utilized at this initial point and substantially finished as soon as the cell begins to rotate into its three-dimensional shape (i.e., after this initial point, the reliance on the extensible nature of the paper may be less substantial or even non-existent). After that initial point, the slit pattern properties, regardless of paper type, opens with greater ease to the point at which it forms a hexagon. Accordingly, in some embodiments, the extensible property substantially merely comes into play at the initial moment of expansion. In some other embodiments, while the extensible features of the paper comes into play most substantially at this initial point of rotation, the extensible features of the paper can have some affect during further expansion of the paper, whereby the initial point of expansion can be substantially facilitated due to extensibility and further expansion can also be, at least, somewhat facilitated due to extensibility.”

“In some of the preferred embodiments, preferable extensible papers that can be employed include extensible papers where the purpose of the extensible nature is to provide the type of stretching found for the use of multi-wall bags for heavy weight items like cement, or seed and the like. U.S. Patent Publication No. 2016/0355985 (U.S. application Ser. No. 14/901,997) and U.S. Pat. Nos. 3,104,197 and 3,266,972 teach the manufacture and properties of this form of extensible paper. Further teachings can be found in “Understanding sheet extensibility”, R. S. Seth, Pulp & Paper Canada T31, 106:2 (2005) III, pages 33-40 (T31-T38). The disclosures of the foregoing patents, patent publication, and printed publication are incorporated herein by reference, as though recited in full.”

“The prior expanded slit sheet art (See, e.g., U.S. Pat. Nos. 5,538,778, 5,667,871, 5,688,578, and 5,782,735) focused on paper strength to inhibit tearing during the expansion process and Kraft paper was satisfactory because the strength required coincided with the thickness required to make a satisfactory wrapping product. The increased strength of an expandable sheet does not contribute to or increase the value/performance of the expansion of the slit sheet material. It has now been found by the present inventor that an expandable slit sheet paper can be substantially improved by the use of an extensible sheet. In the preferred embodiments, this use of an extensible slit sheet paper advantageously provides a reduction in force required to open the slit sheet and therefore provides a faster and easier expanding process for the user of the expanded slit sheet. The unexpected benefit resulting from the reduction in force at the very start of the expansion of the slit sheet provides an unexpected improvement to the slit sheet packaging product and renders the employment of the extensible paper highly unique. Notably, the prior expanded slit sheet paper persisted in and was widely used in the marketplace for decades without the contemplation of the present invention or the potential advantages therefrom.”

“As set forth in this application, the present inventor has discovered that the force needed to expand an expandable slit sheet paper is far greater than the force required to expand an extensible slit sheet paper. By way of example, a 50 pound Kraft paper expandable slit sheet that is 15” wide prior to expansion requires approximately 4-6 pounds or 0.4 pounds per inch, whereas the force required to expand an extensible slit sheet of the same paper weight is 0.15-0.22 pounds per inch. This is a marked difference between the papers. Kraft paper has the strength to provide an acceptable expandable slit sheet. However, unexpectedly, the extensible slit sheet imparts an ease of expansion that greatly reduces the force required to expand the slit sheet, not based on the main purpose for extensible paper which is to increase its tensile strength but, rather, its capability to stretch. Since extensible paper is higher in cost and Kraft paper was strong enough, it was not previously known that extensible paper could be of benefit for making slit paper sheets of the types found in, e.g., U.S. Pat. Nos. 5,538,778, 5,667,871, 5,688,578, and 5,782,735, and U.S. Non-Provisional application Ser. No. 15/428,144. For example, it was not appreciated that an extensible slit sheet could have provided an equivalent strength to light weight, thin papers that previously had no applicability as a wrapping product. Light weight Kraft paper tears more easily than heavier weights of Kraft paper. It has now been found that the extensible paper enables the use of the lighter weight expanded slit-sheet papers that also advantageously provide gentler cushioning required by fragile items when a slit sheet is expanded, in contrast to the more rigid cushioning provided by heavier weight expanded slit-sheet papers.”

“Reference is particularly made to the graph of Table 1 on page 5 of U.S. Patent Publication No. 2016/0355985 (now U.S. Pat. No. 9,945,077) as if recited in full, that describes paper strength based on certain manufacturing techniques. Within the graph is a column describing elongation at the point of paper break (or tearing of fibers) separated into two sub columns of the machine direction (MD) and cross direction (CD), also referred to as transverse direction. The elongation percentage of Table 1 ranges from 5.3% to 7.1% in the cross direction (CD) and 3.3% to 10.6% in the machine direction (MD).”

“Reference is also made to U.S. Pat. No. 3,266,972 within Table III of column 5 which references elongation in the percentage range from 3.7% to 4.6% in the CD or cross direction and 9.7% to 11.1% in the machine direction.”

“In both '985 and '972, the variations are based on the manufacturing process that places an emphasis on tensile strength and stretch in either the cross direction or machine direction accordingly.”

“The present inventor has discovered that for the purposes of expanding an extensible slit sheet paper for use as a packaging wrap and/or void fill, machine direction extensible ranges from 1%-9% provide an adequate extensibility, with 1% to 6% preferred, and 1% to 4% most highly preferred. The lower the extensibility coincides with lower costs of the paper per square foot. As indicated above, it should be understood that extensibility is measured on unslit paper.”

“In some alternative embodiments, machine direction extensibility ranges of the extendible slit sheet paper can have ranges of:
a) from 1.5%-9%, or more preferably from 1.5% to 6% preferred, or even more preferably from 1.5% to 4%; or
b) from 2%-9%, or more preferably from 2% to 6% preferred, or even more preferably from 2% to 4%; or
c) from 3%-9%, or more preferably from 3% to 6% preferred, or even more preferably from 3% to 4%.”

“For the purposes of expanding the slit sheet paper for use as a packaging wrap and/or void fill, it has been found that cross direction extensible ranges from 1%-5% provides an adequate extensibility with 1% to 4% preferred, and 1% to 3% most highly preferred.”

“In some alternative embodiments, cross direction extensibility ranges of the extendible slit sheet paper can have ranges of: a) from 1.5%-5%, or more preferably from 1.5% to 4%, or even more preferably from 1.5% to 3%; or b) from 2%-5%, or more preferably from 2% to 4%, or even more preferably from 2% to 3%.”

“In combination with the extensible paper, a smaller, lighter weight, and recyclable version of an expander can be employed (such as, e.g., made entirely or substantially entirely with recyclable cardboard in some illustrative embodiments). This expands the market to customers that use a very small amount of wrap as compared to the industrial market. It also provides for a less expensive expansion device to be employed for expanding the slit paper. Additionally, it enhances the ease of use by the packer by providing for less ripping during the wrapping process that occurs when the tension is not properly set. This occurs as the roll, during its continued use, becomes smaller and lighter in weight. As the roll of expanded slit sheet becomes lighter the tension required increases. Thus, there need for a varying tensioning method. With the use of the extensible paper, the tension required is significantly decreased and the strength of the paper is increased. Both benefit the person wrapping by making the tensioning required much less precise to the point at which, a single tension setting can be used with little or no adjustment. If the tension is set higher than necessary, the increase in strength from the extensible paper keeps the product from tearing and therefore makes it easier for the packer to use. Therefore, the packer can make fewer adjustments as the slit sheet roll becomes smaller and smaller.”

“The reduction in the force required to expand the slit paper enables a new product to be created using lighter weight papers. In the past, expanded slit sheet paper is primarily used as a wrapping product whereas its use as a void fill would be in limited circumstances due to void fill being typically the cheapest, that is, the lowest cost of all packaging products. The increased strength of the extensible sheet enables the use of a thinner and lighter weight slit sheet paper as a void fill product. If the expanded slit sheet is not being used as a wrap, then the thicker 0.005″, 50 pounds per 3,000 square feet paper and above is not required and a lighter weight 0.003-0.0045″ thick, 30-40 pounds per 3,000 square feet paper can be used as void fill. It can also be used to provide cushioning that other paper void fill products have not been able to provide. It has now been found that even though the extensible paper has a 10% higher price, the use of a thinner paper provides much more square footage per ton and more than compensates for the increased cost of the extensible paper as compared to Kraft paper.”

Of the various ranges of extensibility that may be employed, in some most preferred embodiments, the ranges of extensibility employed are greater than 4% in the machine direction, or, more preferably, greater than 5% in the machine direction, or, more preferably, greater than 6% in the machine direction. In some embodiments, these ranges of extensibility are up to 20% in the machine direction. In some other embodiments, these ranges of extensibility are up to 15% in the machine direction. In some other embodiments, these ranges of extensibility are up to 10% in the machine direction. In some other embodiments, these ranges of extensibility are up to 9% in the machine direction.

The following pages under this section describe other illustrative extensible slit sheet papers in the art from other publications and patents that can be employed within some embodiments of the present invention. Towards that end, it should be understood and appreciated that some embodiments of the present invention can employ expandable slit sheet paper using any-and-all of extensible papers as described in the following pages, including ranges of extensibility and other aspects.

### Detailed Descriptions of Technologies Employed in the Present Invention Quoted from Disclosures that are Incorporated by Reference

“The Following are Citations from Clupak's Paper Patent (U.S. Pat. No. 9,945,077):”

### “Example 1

Heavy-duty Clupak paper having a basis weight of 84.9 g/m2 was made using a gap-former paper-making machine equipped with a Clupak system, at a paper-making speed of 480 m/min and using, as material, 100% unbleached softwood Kraft pulp that had been beaten at high concentration of 28%. The negative draw on the Clupak was set to −4.5%.”

### “Example 2

Heavy-duty Clupak paper was made in the same manner as in Example 1, except that the paper had a basis weight of 76.1 g/m² and the negative draw on the Clupak was set to −6.0%.”

### “Example 3

Heavy-duty Clupak paper was made in the same manner as in Example 1, except that the paper had a basis weight of 73.4 g/m² and the negative draw on the Clupak was set to −4.0%.”

### “Example 4

Heavy-duty Clupak paper was made in the same manner as in Example 1, except that the paper had a basis weight of 85.0 g/m², the negative draw on the Clupak was set to −4.0%, and the pulp blend consisted of 90% unbleached softwood Kraft pulp and 10% unbleached hardwood Kraft pulp.”

### “Comparative Example 1

Heavy-duty Clupak paper was made in the same manner as in Example 1, except that the paper had a basis weight of 71.9 g/m² and the negative draw on the Clupak was set to −10.0%.”

### “Comparative Example 2

Heavy-duty Clupak paper was made in the same manner as in Example 1, except that the paper had a basis weight of 85.4 g/m² and the negative draw on the Clupak was set to −1.0%.”

### “Comparative Example 3

Heavy-duty Kraft paper was made in the same manner as in Example 1, except that the paper had a basis weight of 76.0 g/m2 and the Clupak process was not performed.”

### “Evaluation Methods

TABLE 1

| | | | | | | | | | | | | | Tensile | | | | | Breaking |
|---|---|---|---|---|---|---|---|---|---|---|---|---|---|---|---|---|---|---|
| | | Clupak | | Paper | | Air | Tensile | | Elongation | | TEA | | stiffness | | Tear | | | after |
| | | negative | Basis | thick- | Den- | resis- | index | | at break | | index | | index | | index | | | processsed |
| | | draw | weight | ness | sity | tance | Nm/g | | % | | J/g | | kNm/g | | mN · m²/g | | Forma- | into heavy- |
| | | % | g/m² | μm | g/cm³ | sec | MD | CD | MD | CD | MD | CD | MD | CD | MD | CD | tion | duty sack |
| Examples | 1 | −4.5 | 84.9 | 121 | 0.70 | 14 | 88.1 | 31.3 | 7.0 | 7.1 | 3.55 | 1.55 | 5.62 | 3.64 | 12.8 | 28.9 | ◯ | ◯ |
| | 2 | −6.0 | 76.1 | 118 | 0.65 | 12 | 69.5 | 33.0 | 8.1 | 5.8 | 3.22 | 1.47 | 4.18 | 3.07 | 19.7 | 25.8 | ◯ | ◯ |
| | 3 | −4.0 | 73.4 | 110 | 0.67 | 13 | 72.5 | 30.1 | 6.0 | 6.0 | 2.60 | 1.17 | 4.95 | 3.43 | 14.9 | 20.3 | ◯ | ◯ |
| | 4 | −4.0 | 85.0 | 129 | 0.66 | 13 | 83.3 | 39.4 | 7.4 | 6.3 | 3.47 | 1.51 | 5.33 | 3.44 | 13.1 | 25.5 | ⊚ | ◯ |
| Compara- | 1 | −10.0 | 71.9 | 112 | 0.64 | 12 | 52.0 | 28.0 | 10.6 | 5.3 | 3.47 | 1.02 | 3.09 | 3.14 | 19.7 | 27.1 | ◯ | X |
| tive | 2 | −1.0 | 85.4 | 130 | 0.66 | 15 | 85.0 | 32.1 | 3.7 | 6.7 | 1.99 | 1.49 | 7.12 | 3.70 | 16.3 | 20.4 | ◯ | X |
| Examples | 3 | Not | 76.0 | 119 | 0.64 | 18 | 92.1 | 35.5 | 3.3 | 5.4 | 1.89 | 1.49 | 8.92 | 3.85 | 19.1 | 24.9 | ◯ | ◯ |
| | | used | | | | | | | | | | | | | | | | |

### (Measurement of Tensile Energy Absorption Index)

Measured by the method specified in JIS P8113: 2006.

### (Measurement of Breaking Elongation)

Measured by the method specified in JIS P8113: 2006.

### (Measurement of Tear Index)

Measured by the method specified in JIS P8116: 2000.

### (Measurement of Burst Index)

Measured by the method specified in JIS P8112: 2008.

### (Measurement of Tensile Stiffness Index)

Measured by the method specified in ISO/DIS 1924-3.
(Measurement of Freeness after Disintegration)
Measured by the method specified in JIS P8220: 1998 and JIS P8121: 1995.”

“Looking at the properties of the Clupak papers in Examples 1 to 4 and Comparative Examples 1 and 2 as well as those of the Kraft paper in Comparative Example 3, as shown in Table 1, the Clupak papers described in Examples 1 to 4 exhibit a good balance of various strengths and elongation and have excellent strength overall; on the other hand, the Clupak papers described in Comparative Examples 1 and 2 and Kraft paper described in Comparative Example 3 exhibit a poor balance of various strengths and elongation and cannot be said to have excellent strength overall.”

“The Following are Citations from “Understanding Sheet Extensibility”, R. S. Seth, (Pulp and Paper Research Institute of Canada 3800 Wesbrook Mall Vancouver, BC, Canada V6S 2L9) Pulp & Paper Canada T31, 106:2 (2005) III, Pages 33-40 (T31-T38):

Tensile strength and extensibility or stretch are two important failure properties of paper. They are defined by the end-point of the sheet's load-elongation curve (FIG. 1). Individually and together, they are important for many product performance properties. For example, TEA, the tensile energy absorbed by the sheet before failure is proportional to the area under the load-elongation curve. Thus, it depends on both the tensile strength and extensibility of the sheet. A high TEA is desired in sack papers [1]. The bursting strength of paper has been shown to be proportional to the product of tensile strength and the square-root of stretch [2]. The fracture toughness of paper has been found to depend strongly on the sheet's tensile strength and stretch [3, 4]. Sheet stretch has also been regarded as important for paper runnability both at the paper machine's dry-end and in the pressroom [5-8]. Papers with high stretch also seem to have a somewhat higher tearing resistance [9], and folding endurance; they are found to be more dimensionally unstable as well [10]. The factors that control sheet tensile strength are fairly well understood [4]. The tensile strength is high if fibres are strong, long, fine and thin-walled. The fibres should be conformable and have a high fibre-fibre bond strength. The sheet tensile strength is also high if fibres are straight, free from deformations and the sheets are well formed. Otherwise, the stress is unevenly distributed when the sheet is strained, leading to premature failure.”

“This report deals with the factors that control sheet stretch.”

“Factors that Control Sheet Stretch:

A specimen under tensile load extends more, the longer it is. Therefore, extensibility or stretch or strain at failure as a material property, is expressed as a percentage of the original specimen length (FIG. 1).”

### “Role of Bonding:

Regardless of how bonding between the fibres is increased—by wet pressing, beating or refining, or additives, the sheet stretch of a furnish generally increases with increased fibre-fibre bonding. This is observed for almost all papermaking fibres—chemical, mechanical, wood, non-wood, or recycled. The reasons are as follows. Fibres have a certain “stretch-potential”. However, this potential is realized in paper only when fibres form a bonded network. If the bonding is weak, the network fails before the stretch-potential is realized; the sheet stretch is low. As bonding in the network is increased, the stretch-potential of fibres is increasingly realized, the sheet stretch increases. Since increased inter-fibre bonding also increases sheet tensile strength, an increase in stretch with tensile strength is often observed for handsheets (FIG. 2). The stronger the sheet, the more the fibres' stretch-potential is utilized. Because of this relationship between tensile strength and stretch, factors such as sheet grammage or formation that tend to affect tensile strength also affect sheet stretch [11]. A comparison of handsheet stretch values at similar tensile strengths provides a meaningful comparison of the stretch-potential of various furnishes.”

“The Following are Citations from Trani et al.'s Extensible Paper Patent (U.S. Pat. No. 7,918,966)[Also, Published as U.S. Application No. 2007/0240841]:”

“Extensible paper is a known paper which, because of special treatment during its production, presents considerable extensibility both in the longitudinal direction (i.e. in the direction of its advancement along the production line) and in the transverse direction (i.e. in the direction perpendicular to the preceding). This treatment consists essentially of passing the paper web not yet formed and presenting a moisture content of about 35%/45% between two rollers rotating at different speeds. One of these rollers, generally the lower roller, is made of rubber and is rotated at lower speed, while the upper roller is made of steel and comprises in its cylindrical surface a continuous spiral-shaped groove. The different material nature and the different speed of the two rollers results in a sort of longitudinal accumulation of the paper forming material and prepares it for longitudinal extensibility, by an amount which can reach 15-20%. At the same time, the spiral groove performs a double function: on the one hand it causes a sort of transverse accumulation of the material forming the paper to prepare it for transverse extensibility. By an amount which can reach 10-15%. On the other band the spiral groove contributes to maintaining longitudinal advancement of the processed paper web along the machine.”

“The Following are Citations from Cabell et al.'s Extensible Paper Web Patent (U.S. Pat. No. 6,458,447):”

### “Tensile and Percent Stretch Test:

The tensile test is used for measuring force versus percent elongation properties. The tests are performed on a Thwing Albert Intellect II-STD Model No. 1451-24PGB, available from the Thwing-Albert Co. of Philadelphia, Pa.”

“The samples used for this test are 1″ wide×6″ long with the long axis of the sample cut parallel to the direction of maximum extensibility of the sample. The sample should be cut With a sharp Exacto knife or some suitably sharp cutting device design to cut a precise 1″ wide sample. (If there is more than one direction of extensibility of the material, samples should be taken parallel to representative direction of elongation). The sample should be cut so that an area representative of the symmetry of the overall pattern of the deformed region is represented. There will be cases (due to variations in either the size of the deformed portion or the relative geometries of regions 1 and 2) in which it will be necessary to cut either larger or smaller samples than is suggested herein. In this case, it is very important to note (along with any data reported) the size of the sample, which area of the deformed region it was taken from and preferably include a schematic of the representative area used for the sample. Three samples of a given material are tested.”

“The Following are Citations from Cramer et al.'s Extensible Paper Patent (U.S. Pat. No. 3,266,972):”

### “Test and Characterization Procedures:

The test and characterization procedures employed in measuring various properties reported herein are listed in Table I below. Unless otherwise indicated the code letter numerals indicate standard TAPPI tests.”

### “Elongation T457:

By the expression “extensible papers” is meant a paper having an increased elongation (generally a minimum of about 6%) in the machine direction.

In runs IA and IB of this example, rosin size (0.3% by weight based on the weight of pl up) is added at the beater and the pH is adjusted to 4.5 with alum. The stock, having a consistency of 3.6% is dropped to the beater chest and is then pumped to a second chest, passed through a Jordan and continuously diluted with “white water” at the Fourdrinier headbox to a consistency of 0.3%. Properties measured on the various papers is reported in Table III. Each paper has a basis weight of from 49.4 to 50.3 pounds per ream.”

TABLE III

| Property | | 1A | 1B | 1C | 1D |
|---|---|---|---|---|---|
| Tensile (lbs./in.) | MD | 15.6 | 16.0 | 18.2 | 22.4 |
| | CD | 12.6 | 13.0 | 14.3 | 15.4 |
| Elongation (percent) | MD | 10.1 | 11.2 | 9.9 | 9.7 |
| | CD | 3.7 | 4.3 | 4.4 | 4.6 |
| Work-to-break | MD | 1.01 | 1.05 | 1.14 | 1.34 |
| (in.-lbs./in.²) | CD | 0.34 | 0.41 | 0.47 | 0.50 |
| MIT Fold | MD | 380 | 398 | 496 | 1,021 |
| | CD | 106 | 94 | 132 | 167 |
| CSI Abrasion (cycles) | MD | 14 | | 20 | 25 |
| | CD | 7 | | 37 | 64 |

“The Following are Citations from Trani et al.'s Multilayer Paper Material Patent (U.S. Pat. No. 8,518,522):”

“These and other objects which will be apparent from the ensuing description are attained according to the invention by a multilayer papery material comprising at least one first three dimensional structure sheet exhibiting reliefs having maximum sizes which are lower than the width of the original sheet, said reliefs being obtained through localized stretching of said first sheet which has an original degree of extensibility of not less than 5% in all the directions, and at least one second sheet made of papery material coupled to said first structure sheet and defining empty spaces with the reliefs thereof.”

“As it can be seen from the figures, in the embodiment shown in FIG. 1 the multilayer material of the invention consists of two layers 2, 4 of paper presenting extensibility characteristics of not less than 5% both in a longitudinal and in a transverse direction, and preferably not less than 15%.”

U.S. Pat. No. 10,669,086:

Further details related to extensible papers that can be employed in some preferred embodiments are also quoted in the '086 patent as follows.

“The following is a direct quote of the paragraph on column 1, lines 4-19, of U.S. Pat. No. 3,908,071 incorporated by reference in the preceding paragraph: “Extensible (compacted) paper produced, for example, in accordance with the apparatus and process disclosed in U.S. Pat. No. 2,624,245 has certain well recognized advantages and commercial uses. Such paper is subjected, while in a partially moistened condition, to compressive compaction in the direction of web movement (machine direction or MD) between a pressure nip, thus compacting and forcing the fibers together to produce an inherent stretchability without creping. Compacted paper has improved tensile energy absorption (TEA) burst and tear characteristics which are highly desirable for such end uses as the manufacture of paper sacks.” In addition, the following is a direct quote of the Abstract of U.S. Pat. No. 6,024,832 incorporated by reference in the preceding paragraph: “A method for producing extensible paper, comprising the following stages: feeding a mix of vegetable fibres to a kneader member, mixing the mix with water in the kneader, beating the fibres to obtain a pulp, transferring the beaten pulp into a flow chest, feeding the beaten pulp from the flow chest onto a paper web formation cloth with consequent reduction of the water percentage by gravity and vacuum, pressing the web, with consequent further reduction of its water content, initial drying of the paper web to a substantially constant moisture content of between 15% and 65%, compacting, final drying to a moisture content of between 15% and 4%, preferably 10%-8%, glazing, wherein: the beating stage is carried out by rubbing the fibres in a multistage unit to obtain a pulp having a degree of beating of at least 30.degree. SR, the compacting stage is carried out between at least a pair of rollers of which one is of hard material comprising circumferential surface ribs and driven at greater speed, and the other is of soft material with a smooth surface and driven at lesser speed.” In addition, the following is a direct quote of the 2^{nd} paragraph of the Background section of U.S. Pat. No. 9,945,077 incorporated by reference in the preceding paragraph: “On the other hand, Clupak refers to equipment that inserts a paper web between a roll and an endless rubber blanket to compress the paper web with a nip bar and the rubber blanket, while at the same time the pre-stretched blanket shrinks to cause the paper web to also shrink and thereby increase its breaking elongation, and this equipment is used to provide increased breaking elongation to kraft paper used in heavy packaging applications as mentioned above.” In addition, the following is a direct quote of the paragraph on column 2, lines 41-56 of U.S. Pat. No. 3,104,197 incorporated by reference in the preceding paragraph: “The use of rubber or rubberous material in conjunction with a hard surface in the manner described is known in the treatment of paper as well as fabrics but only in a general way and the present invention includes the use of rubber considerably softer and more elastic than previously used. Also of great importance in the production of an extensible paper by creping it in this manner is the differential in speeds at which the rolls are driven. If the proper combination of hard and soft surfaces is provided, a semi-dry paper web passing through the nip of the rolls will be carried by the contracting rubber against the direction of web travel toward the nip and over the surface of the hard roll. This creates a uniformly compressed crepe in the paper web giving toughness, pliability and extensibility.”

“The following are direct quotes of paragraphs [0003] and [0028] of U.S. Patent Publication No. 2016/0355985 incorporated by reference in the preceding paragraph: (1) “[0003] On the other hand, Clupak refers to equipment that inserts a paper web between a roll and an endless rubber blanket to compress the paper web with a nip bar and the rubber blanket, while at the same time the pre-stretched blanket shrinks to cause the paper web to also shrink and thereby increase its breaking elongation, and this equipment is used to provide increased breaking elongation to kraft paper used in heavy packaging applications as mentioned above;” and “[0028] The manufacturing method using this Clupak system is such that a paper web is inserted between a roll and an endless rubber blanket to compress the paper web with a nip bar and the rubber blanket, while at the same time the pre-stretched blanket shrinks to cause the paper web to also shrink and thereby increase its breaking elongation. The Clupak system allows for adjustment of the breaking elongation of kraft paper in the longitudinal direction according to the ratio of the manufacturing speed on the inlet side of the Clupak system and manufacturing speed on the outlet side of the Clupak system, and also according to the pressurization force applied by the nip bar.”

In some embodiments, extensible paper employed can involve one or more of the following Example features, as set forth in the '086 patent.

Example 1: An extensible slit sheet paper cushioning product, comprising: a roll of slit sheet paper having a slit pattern including a plurality of slits extending in a cross direction that forms a plurality of open cells upon expansion in a machine direction, said roll resisting pulling of a length of slit sheet paper along the machine direction to enable expansion of the length of slit sheet paper in the machine direction, said slit sheet paper being formed from a paper that is extensible in the machine direction and the cross direction prior to providing said slit pattern, said extensible paper having an extensible range of 3 to 20% in the machine direction prior to providing said slit pattern.

Example 2: The extensible slit sheet paper cushioning product of example 1, wherein said extensible range is not less than 5% in both the machine direction and cross direction.

Example 3: The extensible slit sheet paper cushioning product of example 1, wherein said extensible range is 3-15% in the machine direction; or, in some embodiments, wherein said extensible range is 3-9% in the machine direction.

Example 4: The extensible slit sheet paper cushioning product of example 1, wherein said slit sheet paper is configured such that expansion is performed by applying an expansion force of 0.15 to 0.22 pounds per inch to form said open cells.

Example 5: The extensible slit sheet paper cushioning product of example 2, wherein said slit sheet paper is configured such that expansion is performed by applying an expansion force of 0.15 to 0.22 pounds per inch to form said open cells.

Example 6: The extensible slit sheet paper cushioning product of example 5, wherein said slit sheet paper has a weight, prior to expansion, from about 30 to 50 pounds per 3,000 sq. ft.

Example 7: The extensible slit sheet paper cushioning product of example 1, wherein said slit sheet paper has a weight, prior to expansion, from about 30 to 50 pounds per 3,000 sq. ft.

Example 8: A shipping package comprising: a wrapped object, said wrapped object being wrapped in at least two layers of an expanded slit sheet paper wrap having interlocking hexagonal cells, said slit sheet paper having a slit pattern including a plurality of slits extending in a cross direction that forms a plurality of hexagonal cells upon expansion in a machine direction and being expanded by applying an expansion force and wrapped to form said at least two layers of expanded slit sheet paper wrap having interlocking hexagonal cells, said slit sheet paper being formed from a paper that is extensible in the machine direction and the cross direction prior to providing said slit pattern, said extensible paper having an extensible range of 3 to 20% in the machine direction prior to providing said slit pattern.

Example 9: The shipping package of example 8, wherein said extensible range is not less than 5% in both the machine direction and cross direction.

Example 10: The shipping package of claim 8, wherein said extensible range is

3-15% in the machine direction.

Example 11: The shipping package of example 8, wherein said slit sheet paper is configured such that expansion is performed by applying an expansion force of 0.15 to 0.22 pounds per inch to form said hexagonal cells.

Example 12: The shipping package of example 11, wherein said slit sheet paper has a weight, prior to expansion, from about 30 to 50 pounds per 3,000 sq. ft.

Example 13: The shipping package of example 8, wherein said slit sheet paper has a weight, prior to expansion, from about 30 to 50 pounds per 3,000 sq. ft.

Example 14: A method of expanding and wrapping a slit sheet paper that upon expansion and wrapping forms two or more layers of interlocking hexagonal cells, comprising the steps of: providing said slit sheet paper having a slit pattern including a plurality of slits extending in a cross direction that forms a plurality of hexagonal cells upon expansion in a machine direction, wherein said slit sheet paper being formed from a paper that is extensible in the machine direction and the cross direction prior to providing said slit pattern, said extensible paper having an extensible range of 3 to 20% in the machine direction prior to providing said slit pattern, expanding said slit sheet paper, and wrapping said expanded slit sheet paper to form adjacent layers, said adjacent layers being in interlocking contact, whereby expanded layers resist contraction and tearing.

Example 15: The method of example 14, wherein said extensible range is not less than 5% in both the machine direction and cross direction.

Example 16: The method of example 14, wherein said extensible range is 3-15% in the machine direction.

Example 17: The method of example 14, wherein said step of expanding comprises applying an expansion force of 0.15 to 0.22 pounds per inch to form said hexagonal cells.

Example 18: The method of example 17, wherein said slit sheet paper has a weight, prior to expansion, from about 30 to 50 pounds per 3,000 sq. ft.

Example 19: The method of example 14, wherein said slit sheet paper has a weight, prior to expansion, from about 30 to 50 pounds per 3,000 sq. ft.

Example 20: The method of example 14, wherein the step of wrapping said slit sheet paper to form said adjacent layers, comprises: wrapping the expanded slit sheet paper around an object and forming said two or more layers of overlying interlocking hexagonal cells around said object, said overlying interlocking hexagonal cells being in direct contact substantially across the width of the layers.

Example 21: The method of example 20, wherein said extensible range is 3-15% in the machine direction and not less than 5% in the cross direction.

Example 22: The method of example 20, wherein said extensible range is 3-9% in the machine direction and not less than 5% in the cross direction.

Example 23: The method of example 20, wherein said step of expanding comprises applying an expansion force of 0.15 to 0.22 pounds per inch to form said hexagonal cells.

Example 24: The method of example 21, wherein said step of expanding comprises applying an expansion force of 0.15 to 0.22 pounds per inch to form said hexagonal cells.

Example 26: The method of above examples, wherein said extensible range is 3-15% in the machine direction and not less than 5% in the cross direction.

Example 27: The method of above examples, wherein said extensible range is 3-9% in the machine direction and not less than 5% in the cross direction.

Example 28: The method of above examples, wherein said step of expanding a length of said expandable sheet material comprises applying an expansion force of 0.15 to 0.22 pounds per inch.

Example 29: The method of example 26, wherein said step of expanding a length of said expandable sheet material comprises applying an expansion force of 0.15 to 0.22 pounds per inch.

Example 30: The method of above examples, wherein the slit extensible paper has a weight, prior to expansion, from about 30 to 50 pounds per 3,000 sq. ft.

Example 31: The method of example 28, wherein the slit extensible paper has a weight, prior to expansion, from about 30 to 50 pounds per 3,000 sq. ft.

Example 32: The extensible slit sheet paper cushioning product of example 1, wherein said extensible range is 3-11.1% in the machine direction.

Example 33: The shipping package of example 8, wherein said extensible range is 3-11.1% in the machine direction.

Example 34: The method of example 14, wherein said extensible range is 3-11.1% in the machine direction.

Example: 35: The method of above examples, wherein said extensible range is 3-11.1% in the machine direction.

Example 36: The extensible slit sheet paper cushioning product of example 1, wherein said extensible range is 3.3-10.6% in the machine direction.

Example 37: The shipping package of example 8, wherein said extensible range is 3.3-10.6% in the machine direction.

Example 38: The method of example 14, wherein said extensible range is 3.3-10.6% in the machine direction.

Example 39: The method of above examples, wherein said extensible range is 3.3-10.6% in the machine direction.

Example 40: The extensible slit sheet paper cushioning product of example 1, wherein said extensible range is 9.7-11.1% in the machine direction.

Example 41: The shipping package of example 8, wherein said extensible range is 9.7-11.1% in the machine direction.

Example 42: The method of example 14, wherein said extensible range is 9.7-11.1% in the machine direction.

Example 43: The method of above examples, wherein said extensible range is 9.7-11.1% in the machine direction.

Example 44: The extensible slit sheet paper cushioning product of example 1, wherein said extensible paper is formed by imparting a treatment prior to providing the slit pattern comprising inserting said paper between a roll and an endless pre-stretched blanket to compress the paper with a nip bar and the blanket (or otherwise compressing the paper between two different (e.g., differently moving) surfaces, such as between two different rollers).

Example 45: The shipping package of example 8, wherein said extensible paper is formed by imparting a treatment prior to providing the slit pattern comprising inserting said paper between a roll and an endless pre-stretched blanket to compress the paper with a nip bar and the blanket (or otherwise compressing the paper between two different (e.g., differently moving) surfaces, such as between two different rollers).

Example 46: The method of example 14, wherein said extensible paper is formed by imparting a treatment prior to providing the slit pattern comprising inserting said paper between a roll and an endless pre-stretched blanket to compress the paper with a nip bar and the blanket (or otherwise compressing the paper between two different (e.g., differently moving) surfaces, such as between two different rollers).

Example 47: The method of example 25, wherein said extensible paper is formed by imparting a treatment prior to providing the slits comprising inserting said paper between a roll and an endless pre-stretched blanket to compress the paper with a nip bar and the blanket (or otherwise compressing the paper between two different (e.g., differently moving) surfaces, such as between two different rollers).

Example 51: The extensible slit sheet paper cushioning product of example 1, wherein said extensible paper is a nonwoven fibrous material with fibre-to-fibre bonding that resists tearing upon 3-15% expansion in the machine direction as measured prior to providing the slit pattern.

Example 52: The shipping package of example 8, wherein said extensible paper is a nonwoven fibrous material with fibre-to-fibre bonding that resists tearing upon 3-15% expansion in the machine direction as measured prior to providing the slit pattern.

Example 53: The method of example 14, wherein said extensible paper is a nonwoven fibrous material with fibre-to-fibre bonding that resists tearing upon 3-15% expansion in the machine direction as measured prior to providing the slit pattern.

Example 54: The method of above examples, wherein said nonwoven fibrous material comprises fibre-to-fibre bonding that resists tearing upon 3-15% expansion in the machine direction as measured prior to providing the slits.

Example 55: The extensible slit sheet paper cushioning product of example 1, wherein said roll of slit sheet paper is wound on a cylindrical core, and said length of slit sheet paper extends from said roll of slit sheet paper.

Example 56: The extensible slit sheet paper cushioning product of example 1, wherein said extensible range is 5-15% in a cross-direction.

Example 57: The extensible slit sheet paper cushioning product of example 1, wherein said extensible range is 7.1-15% in a cross-direction.

Example 58: An extensible slit sheet paper cushioning product, comprising: a length of slit sheet paper having a slit pattern including a plurality of slits extending in a cross direction that forms a plurality of open cells upon expansion in a machine direction, said slit sheet paper being formed from a paper that is extensible in the machine direction and the cross direction prior to providing the slit pattern, said extensible paper having an extensible range of 3 to 20% in the machine direction prior to providing the slit pattern.

Example 59: The extensible slit sheet paper cushioning product of example 58, further including a resister that resists pulling of the length of slit sheet paper along the machine direction to enable expansion of the length of slit sheet paper in the machine direction.

Example 60: The extensible slit sheet paper cushioning product of example 59, wherein said resister is a roll of slit sheet paper from which said length of slit sheet paper extends.

Example 61: The extensible slit sheet paper cushioning product of example 58, wherein said extensible range is not less than 5% in both the machine direction and cross direction.

Example 62: The extensible slit sheet paper cushioning product of example 58, wherein said extensible range is 3-15% in the machine direction.

Example 63: The extensible slit sheet paper cushioning product of example 58, wherein said slit sheet paper is configured such that expansion is performed by applying an expansion force of 0.15 to 0.22 pounds per inch to form said open cells.

Example 64: The extensible slit sheet paper cushioning product of example 58, wherein said slit sheet paper has a weight, prior to expansion, from about 30 to 50 pounds per 3,000 sq. ft.

Example 69: The extensible slit sheet paper cushioning product of example 1, wherein said a slit pattern is configured to form a plurality of hexagonal cells upon expansion in a machine direction.

Example 70: The extensible slit sheet paper cushioning product of example 69, wherein said hexagonal cells are three-dimensional hexagonal cells with substantially rectangular land portions situated at an inclined angle transverse to an original plane of the slit sheet paper, and leg portions connecting the land portions.

Example 71: The extensible slit sheet paper cushioning product of example 58, wherein said a slit pattern is configured to form a plurality of hexagonal cells upon expansion in a machine direction.

Example 72: The extensible slit sheet paper cushioning product of example 71, wherein said hexagonal cells are three-dimensional hexagonal cells with substantially rectangular land portions situated at an inclined angle transverse to an original plane of the slit sheet paper, and leg portions connecting the land portions.

### BROAD SCOPE OF THE INVENTION

While illustrative embodiments of the invention have been described herein, the present invention is not limited to the various preferred embodiments described herein, but includes any-and-all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure, the following abbreviated terminology may be employed: “e.g.” which means “for example.”

The use of individual numerical values is stated as approximations as though the values were preceded by the word “about”, “substantially”, or “approximately.” Similarly, the numerical values in the various ranges specified in this application, unless expressly indicated otherwise, are stated as approximations as though the minimum and maximum values within the stated ranges were both preceded by the word “about”, “substantially”, or “approximately.” In this manner, variations above and below the stated ranges can be used to achieve substantially the same results as values within the ranges. As used herein, the terms “about”, “substantially”, and “approximately” when referring to a numerical value shall have their plain and ordinary meanings to a person of ordinary skill in the art to which the disclosed subject matter is most closely related or the art relevant to the range or element at issue. The amount of broadening from the strict numerical boundary depends upon many factors. For example, some of the factors which may be considered include the criticality of the element and/or the effect a given amount of variation will have on the performance of the claimed subject matter, as well as other considerations known to those of skill in the art. As used herein, the use of differing amounts of significant digits for different numerical values is not meant to limit how the use of the words “about”, “substantially”, or “approximately” will serve to broaden a particular numerical value or range. Thus, as a general matter, “about”, “substantially”, or “approximately” broaden the numerical value. Also, the disclosure of ranges is intended as a continuous range including every value between the minimum and maximum values plus the broadening of the range afforded by the use of the term “about”, “substantially”, or “approximately”. Thus, recitation of ranges of values herein are merely intended to serve as a shorthand method of referring individually to each separate value falling within the range, unless otherwise indicated herein, and each separate value is incorporated into the specification as if it were individually recited herein. To the extent that determining a given amount of variation of some the factors such as the criticality of the slit patterns, paper width differential pre- and post-expansion, paper weights and type, as well as other considerations known to those of skill in the art to which the disclosed subject matter is most closely related or the art relevant to the range or element at issue will have on the performance of the claimed subject matter, is not considered to be within the ability of one of ordinary skill in the art, or is not explicitly stated in the claims, then the terms “about”, “substantially”, and “approximately” should be understood to mean the numerical value, plus or minus 15%.

It is to be understood that any ranges, ratios and ranges of ratios that can be formed by, or derived from, any of the data disclosed herein represent further embodiments of the present disclosure and are included as part of the disclosure as though they were explicitly set forth. This includes ranges that can be formed that do or do not include a finite upper and/or lower boundary. Accordingly, a person of ordinary skill in the art most closely related to a particular range, ratio or range of ratios will appreciate that such values are unambiguously derivable from the data presented herein.

1. An expandable slit sheet paper product, comprising:
an elongated sheet of expandable slit sheet paper;
said elongated sheet of expandable slit sheet paper having an array of slits, wherein said slits extend in a widthwise direction across said elongated sheet of expandable slit sheet paper;
said elongated sheet of expandable slit sheet paper having a width in said widthwise direction of greater than 20 inches.

2. The expandable slit sheet paper product of claim 1, wherein said elongated sheet of expandable slit sheet paper has a width in said widthwise direction of between 25 inches to 80 inches.

3. The expandable slit sheet paper product of claim 1, wherein said elongated sheet of expandable slit sheet paper is wound into a roll.

4. The expandable slit sheet paper product of claim 1, wherein said elongated sheet of expandable slit sheet paper is a mounted within a dispenser.

5. The expandable slit sheet paper product of claim 4, wherein said dispenser is a manual dispenser.

6. The expandable slit sheet paper product of claim 1, wherein said expandable slit sheet paper is a pallet wrap.

7. The expandable slit sheet paper product of claim 6, wherein said pallet wrap is wrapped around a pallet.

8. The expandable slit sheet paper product of claim 1, wherein said elongated sheet of expandable slit sheet paper is included within a stack of elongated sheets of expandable slit sheet paper.

9. The expandable slit sheet paper product of claim 8, wherein said stack of elongated sheets of expandable slit sheet paper are formed as a pad.

10. The expandable slit sheet paper product of claim 1, wherein said elongated sheet of expandable slit sheet paper is an unfolded sheet unfolded along at least one foldline extending in a lengthwise direction.

11. An expandable slit sheet paper product, comprising:
an elongated sheet of expandable slit sheet paper having multiple layers connected together at at least one foldline.

12. The expandable slit sheet paper product according to claim 11, wherein said multiple layers are substantially parallel to one another.

13. The expandable slit sheet paper product according to claim 11, wherein said elongated sheet of expandable slit sheet paper has two layers connected together at a first fold line.

14. The expandable slit sheet paper product of claim 13, wherein said first fold line separates said elongated sheet of expandable slit sheet paper into substantially symmetrical portions.

15. A method, comprising:
providing an elongated sheet of paper;
folding the elongated sheet of paper along at least one fold line such as to form at least two adjacent layers;
cutting slits into said elongated sheet of paper with a cutting die having blades that penetrate said at least two adjacent layers such that said elongated sheet of paper forms an expandable slit sheet.

16. A method, comprising:
providing a sheet of paper;
folding the sheet of paper at a fold line such as to form two adjacent layers;
cutting slits into said elongated sheet of paper with a cutting die having blades that penetrate each of said two adjacent layers such that said elongated sheet of paper forms an expandable slit sheet.

17. The method of claim 15, wherein said method is a method of making an expandable slit sheet paper.

18. The method of claim 15, further including performing said cutting slits into said elongated sheet of paper while said sheet of paper is in a folded state with said two adjacent layers in side-by-side contact.

19. The method of claim 15, wherein said step of cutting slits forms said elongated sheet of paper into an expandable slit sheet paper.

20. The method of claim 15, further including expanding said elongated sheet of paper by pulling said elongated sheet of paper in a lengthwise direction while said two adjacent layers are in side-by-side contact such as to concurrently form two expanded adjacent layers.

21. The method of claim 15, further including prior to expanding said elongated sheet of paper, unfolding said elongated sheet of paper along said fold line such as to increase the width of said elongated sheet of paper.

22. The method of claim 15, further including prior to expanding said elongated sheet of paper, unfolding said elongated sheet of paper along said fold line such as to increase the width of said elongated sheet of paper and to create a single layer of paper.

23. The method of claim 15, further including winding said elongated sheet of paper into a roll.

24. The method of claim 15, further including winding said elongated sheet of paper into a roll and mounting the roll on a dispenser.

25. The method of claim 15, further including winding said elongated sheet of paper into a roll and mounting the roll on a dispenser, and expanding said elongated sheet of paper by applying a pulling force on the paper in a lengthwise direction such that said slits create expanded cells, and wrapping the elongated sheet of paper around an object.

26. The method of claim 25, wherein said object is an item that is contained within a package for shipping.

27. The method of claim 25, wherein said object is a pallet.

28. The method of claim 25, wherein said pulling force is applied manually.

29. The method of claim 25, wherein said pulling force is applied automatedly.

30. (canceled)

31. (canceled)

32. (canceled)

33. A system for dispensing wide expandable slit sheet paper, comprising:
a roll of expandable slit sheet paper, said roll of expandable slit sheet paper being formed from an elongated sheet of expandable slit sheet paper that is in a folded state in which said expandable slit sheet paper is folded along at least one fold line into at least two adjacent layers;
a support for rotatably supporting said roll of expandable slit sheet paper;
an end region of said expandable slit sheet paper extending from a perimeter of said roll of expandable slit sheet paper, said end region of said expandable slit sheet paper transitioning from said folded state proximate said roll of expandable slit sheet paper to an unfolded state downstream from said roll of expandable slit sheet paper.

34. The system for dispensing wide expandable slit sheet paper of claim 33, wherein a width of said expandable slit sheet paper in said unfolded state prior to expansion of said expandable slit sheet paper is greater than 20 inches.

35. The system for dispensing wide expandable slit sheet paper of claim 34, wherein said width of said expandable slit sheet paper in said unfolded state prior to expansion of said expandable slit sheet paper is less than 120 inches.

36. The system for dispensing wide expandable slit sheet paper of claim 33, wherein a width of said expandable slit sheet paper in said unfolded state prior to expansion of said expandable slit sheet paper is between 25 inches to 80 inches.

37. The system of claim 33, wherein said at least two adjacent layers is two adjacent layers.

38. The system of claim 37, wherein said at least one fold line is one fold line.

39. The system of claim 37, wherein said at least one fold line is two fold lines.

40. The expandable slit sheet product of claim 1, wherein said elongated sheet of expandable slit sheet paper is wound into a roll, and wherein said elongated sheet of expandable slit sheet paper is folded over at least one fold line such as to have at least two layers.

41. The expandable slit sheet product of claim 40, wherein said at least one fold line is two fold lines.

42. The expandable slit sheet product of claim 40, wherein said at least one fold line includes between two to ten fold lines.
